(19) United States
(12) Patent Application Publication
(10) Pub. No.: US 2023/0198681 A1
(43) Pub. Date: Jun. 22, 2023

(54) METHOD AND DEVICE IN NODES USED FOR WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/947,193

(22) Filed: Sep. 19, 2022

Related U.S. Application Data
(63) Continuation of application No. PCT/CN2021/080952, filed on Mar. 16, 2021.

(30) Foreign Application Priority Data
Mar. 20, 2020 (CN) 202010201008.X
Apr. 28, 2020 (CN) 202010351061.8
Apr. 30, 2020 (CN) 202010364509.X

(51) Int. Cl. H04L 1/1829; H04W 72/044; H04W 72/11

(52) U.S. Cl. CPC H04L 1/1854; H04W 72/044; H04W 72/11

(57) ABSTRACT

The present application discloses a method and a device in a node for wireless communications. A first receiver, receives a first signaling, a second signaling and a third signaling; and a first transmitter transmits a first signal in a target time-frequency resource block, the first signal carrying a first information block set; herein, the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index.

### CROSS REFERENCE TO RELATED APPLICATIONS

This application is the continuation of the International patent application No. PCT/CN2021/080952, filed on Mar. 16, 2021, which claims the priority benefit of Chinese Patent Application No. 202010201008.X, filed on Mar. 20, 2020, and claims the priority benefit of Chinese Patent Application No. 202010351061.8, filed on Apr. 28, 2020, and claims the priority benefit of Chinese Patent Application No. 202010364509.X, filed on Apr. 30, 2020; the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In the 5G system, Enhance Mobile Broadband (eMBB) and Ultra Reliable and Low Latency Communication (URLLC) are two typical service types. Targeting the request for a lower target BLER (i.e., 10\hat{ }−5) in URLLC services, the 3rd Generation Partner Project (3GPP) has defined a new Modulation and Coding Scheme (MCS) in New Radio (NR) Release 15. To support more demanding URLLC services, for instance, with higher reliability (e.g., the target BLER is 10\hat{ }−6) or lower latency (e.g., 0.5-1 ms), as specified in 3GPP NR Release 16, a Downlink Control Information (DCI) signaling can indicate whether the services being scheduled are of Low Priority or High Priority, where the Low Priority corresponds to URLLC traffics while High Priority corresponds to eMBB traffics. When a transmission of Low Priority is overlapping with a transmission of High Priority, the High-priority transmission is performed and the Low-priority one is dropped.

A Work Item (WI) of URLLC enhancement in NR Release 17 was approved at the 3GPP RAN #86 Plenary. The WI is proceeded with a focus of study on the Multiplexing of different intra-User-Equipment (Intra-UE) services.

### SUMMARY

When multiple UCIs, especially those with various priorities, are multiplexed on a same PUSCH in a slot, how to interpret the information contained in a Downlink Assignment Index (DAT) Field in an UpLink Grant Signalling rationally to ensure the performance of Uplink Control Information (UCI) carried on a Physical Uplink Shared CHannel (PUSCH) becomes a key issue that should be addressed.

To provide support for multiplexing traffics within a User Equipment (UE), i.e., Intra-UE services of different priorities, how to design a Hybrid Automatic Repeat reQuest (HARQ) Codebook is a key issue that should be addressed.

To address the above problem, the present application provides a solution. The statement above takes the UpLink only for example; the present application also applies to other scenarios of transmissions in the Downlink (DL) and SideLink (SL), where similar technical effects can be achieved. Additionally, the adoption of a unified solution for various scenarios, including but not limited to UL, DL and SL, contributes to the reduction of hardcore complexity and costs. It should be noted that if no conflict is incurred, embodiments in a User Equipment (UE) in the present application and the characteristics of the embodiments are also applicable to a base station, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first signaling, a second signaling and a third signaling; and

transmitting a first signal in a target time-frequency resource block, the first signal carrying a first information block set;

herein, the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one embodiment, the issue to be solved in the present application comprises: how to interpret a value of a DAI field in a scheduling DCI for a PUSCH in the case of multiple Hybrid Automatic Repeat reQuest Acknowledgement (HARQ-ACK) codebooks of the same or different priorities are multiplexed on the same PUSCH in a slot.

In one embodiment, the essence of the above method lies in that when multiple Hybrid Automatic Repeat reQuest Acknowledgement (HARQ-ACK) codebooks of the same or different priorities are multiplexed on a same PUSCH in a slot, a value of a DAI field in a scheduling DCI for the same PUSCH is used to determine a number of bits in one of such HARQ-ACK codebooks.

In one embodiment, the essence of the above method lies in that the interpreting of a value of a DAI field in a scheduling DCI for a PUSCH is related to a number of HARQ-ACK codebooks being multiplexed on the PUSCH.

In one embodiment, the above method is advantageous in enhancing the interpretation of the first field, thus guaranteeing consistency of understanding about HARQ-ACK feedback information between both sides of communications.

In one embodiment, the above method is advantageous in processing HARQ-ACKs of various priorities respectively, thus avoiding the impact of incorrect reception of low-priority DCI over high-priority HARQ-ACK reporting.

According to one aspect of the present application, the above method is characterized in that,

the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

According to one aspect of the present application, the above method is characterized in that,

the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling

According to one aspect of the present application, the above method is characterized in that,

the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

According to one aspect of the present application, the above method is characterized in that,

the first index and the second index are different; a relative magnitude of the first index and the second index is used to determine the target information block subset between the first information block subset and the second information block subset.

According to one aspect of the present application, the above method is characterized in comprising:

the first signaling is used to indicate a Semi-Persistent Scheduling (SPS) release, the HARQ-ACK associated with the first signaling indicating whether the first signaling is correctly received;

or, the first node also receives a first bit block; where the first signaling comprises scheduling information of the first bit block, the HARQ-ACK associated with the first signaling indicating whether the first bit block is correctly received.

According to one aspect of the present application, the above method is characterized in comprising:

the second signaling is used to indicate a Semi-Persistent Scheduling (SPS) release, the HARQ-ACK associated with the second signaling indicating whether the second signaling is correctly received;

or, the first node also receives a second bit block; where the second signaling comprises scheduling information of the second bit block, the HARQ-ACK associated with the second signaling indicating whether the second bit block is correctly received.

The present application provides a method in a second node for wireless communications, comprising:

transmitting a first signaling, a second signaling and a third signaling; and

receiving a first signal in a target time-frequency resource block, the first signal carrying a first information block set;

herein, the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

According to one aspect of the present application, the above method is characterized in that,

the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

According to one aspect of the present application, the above method is characterized in that,

the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

According to one aspect of the present application, the above method is characterized in that,

the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

According to one aspect of the present application, the above method is characterized in that,

the first index and the second index are different; a relative magnitude of the first index and the second index is used to determine the target information block subset between the first information block subset and the second information block subset.

According to one aspect of the present application, the above method is characterized in comprising:

the first signaling is used to indicate a Semi-Persistent Scheduling (SPS) release, the HARQ-ACK associated with the first signaling indicating whether the first signaling is correctly received;

or, the second node also transmits a first bit block; where the first signaling comprises scheduling information of the first bit block, the HARQ-ACK associated with the first signaling indicating whether the first bit block is correctly received.

According to one aspect of the present application, the above method is characterized in comprising:

the second signaling is used to indicate a Semi-Persistent Scheduling (SPS) release, the HARQ-ACK associated with the second signaling indicating whether the second signaling is correctly received;

or, the second node also transmits a second bit block; where the second signaling comprises scheduling information of the second bit block, the HARQ-ACK associated with the second signaling indicating whether the second bit block is correctly received.

The present application provides a first node for wireless communications, comprising:

a first receiver, which receives a first signaling, a second signaling and a third signaling; and

a first transmitter, which transmits a first signal in a target time-frequency resource block, the first signal carrying a first information block set;

herein, the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

The present application provides a second node for wireless communications, comprising:

a second transmitter, which transmits a first signaling, a second signaling and a third signaling; and

a second receiver, which receives a first signal in a target time-frequency resource block, the first signal carrying a first information block set;

herein, the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one embodiment, the method in the present application has the following advantages:
addressing the issue of how the value of a DAI field in a scheduling DCI for the same PUSCH shall be interpreted in the case that multiple HARQ-ACK codebooks are multiplexed on a same PUSCH in a slot;
ensuring consistent understanding of HARQ-ACK feedback information from both sides of communications in any cases;
processing HARQ-ACKs of various priorities respectively, thus avoiding the impact of incorrect reception of low-priority DCI over high-priority HARQ-ACK reporting.

The present application provides a method in a first node for wireless communications, comprising:

receiving a first signaling and a second signaling; and

transmitting a first signal in a first time-frequency resource block, the first signal carrying a first bit block;

herein, the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

In one embodiment, the issue to be solved in the present application comprises: how to interpret a value of a DAI field in a scheduling DCI for a PUSCH in the case of Hybrid Automatic Repeat reQuest Acknowledgement (HARQ-ACK) codebooks of different priorities are multiplexed on the PUSCH.

In one embodiment, the essence of the above method lies in that when HARQ-ACKs of different categories are multiplexed on a same PUSCH, a value of a DAI field in a scheduling DCI for the PUSCH is only used to determine a number of bits in just one category of HARQ-ACK codebook among such HARQ-ACKs.

In one embodiment, the essence of the above method lies in that when HARQ-ACKs of different priorities are multiplexed on a same PUSCH, a value of a DAI field in a scheduling DCI for the PUSCH is only used to determine a number of bits in just one priority of HARQ-ACK codebook among such HARQ-ACKs.

In one embodiment, the essence of the above method lies in that when HARQ-ACKs of different priorities are multiplexed on a high-priority PUSCH, a value of a DAI field in a scheduling DCI for the PUSCH is only used to determine a number of bits in a high-priority HARQ-ACK codebook among such HARQ-ACKs.

In one embodiment, the essence of the above method lies in that when HARQ-ACKs of different Service Types are multiplexed on a PUSCH with URLLC service type, a value of a DAI field in a scheduling DCI for the URLLC-service-type PUSCH is only used to determine a number of bits in a HARQ-ACK codebook with URLLC service type among such HARQ-ACKs.

In one embodiment, the essence of the above method lies in that the first node in the present application performs calculations respectively on different categories of HARQ-ACKs to determine numbers of HARQ-ACK bits of different priorities; a value of the first field in the second signaling is only involved in one of the multiple calculations performed on these HARQ-ACKs.

In one embodiment, the essence of the above method lies in that a value of the first field in the second signaling is only used to determine a number of HARQ-ACK bits in a HARQ-ACK of one priority among HARQ-ACKs of different priorities; when the first bit block does not comprise the HARQ-ACK of the priority, the value of the first field in the second signaling is not used to determine a number of HARQ-ACK bits in any HARQ-ACK of any priority among the HARQ-ACKs of different priorities other than the HARQ-ACK of the priority.

In one embodiment, the above method is advantageous in guaranteeing the reliability of high-priority control information, such as UCI.

In one embodiment, the above method is advantageous in processing HARQ-ACKs of various priorities respectively, thus avoiding the impact of incorrect reception of low-priority DCI over high-priority HARQ-ACK reporting.

According to one aspect of the present application, the above method is characterized in that,

any field in the second signaling other than the first field is not used to determine a number of bits of the second-type HARQ-ACK.

In one embodiment, the essence of the above method lies in that only the first field in the second signaling is used to determine a number of bits comprised in the first bit block.

In one embodiment, the essence of the above method lies in that the first time-frequency resource block comprises one PUSCH, and the first bit block is transmitted in the PUSCH; the first bit block comprises a low-priority HARQ-ACK codebook; scheduling DCI for the PUSCH does not comprise any DAI field used to determine the low-priority HARQ-ACK codebook comprised in the first bit block.

In one subembodiment, the PUSCH is a high-priority PUSCH.

According to one aspect of the present application, the above method is characterized in that,

the first-type HARQ-ACK only includes HARQ-ACK for a Semi-Persistent Scheduling (SPS) release and HARQ-ACK for Transport-Block (TB)-based channel reception; the second-type HARQ-ACK only includes HARQ-ACK for a Semi-Persistent Scheduling (SPS) release and HARQ-ACK for a TB-based channel reception; neither the first-type HARQ-ACK nor the second-type HARQ-ACK includes HARQ-ACK for a Code Block Group-based (CBG-based) channel reception; the first bit block comprises at least one of HARQ-ACK for a Semi-Persistent Scheduling (SPS) release or HARQ-ACK for a TB-based channel reception; the first bit block does not include HARQ-ACK for a CBG-based channel reception.

According to one aspect of the present application, the above method is characterized in that,

when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

According to one aspect of the present application, the above method is characterized in that,

the first signal comprises a first sub-signal and a second sub-signal, the first sub-signal carrying the first bit block, while the second sub-signal carrying a second bit block, the first time-frequency resource block being used to determine a number of bits comprised in the second bit block.

According to one aspect of the present application, the above method is characterized in comprising:

receiving a third signaling;

herein, the third signaling is used to determine a third bit block, the third bit block comprising HARQ-ACK associated with the third signaling; the first signal carries a first bit block set, with the first bit block being any bit block in the first bit block set, the third bit block being a bit block in the first bit block set other than the first bit block.

According to one aspect of the present application, the above method is characterized in that,

the first-type HARQ-ACK corresponds to a first index, while the second-type HARQ-ACK corresponds to a second index, the first index and the second index being different; the first signaling is used to determine a target index, the target index being one of the first index and the second index; when the target index is the first index, the first bit block comprises the first-type HARQ-ACK; when the target index is the second index, the first bit block comprises the second-type HARQ-ACK.

The present application provides a method in a second node for wireless communications, comprising:

transmitting a first signaling and a second signaling; and

receiving a first signal in a first time-frequency resource block, the first signal carrying a first bit block;

herein, the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

According to one aspect of the present application, the above method is characterized in that,

any field in the second signaling other than the first field is not used to determine a number of bits of the second-type HARQ-ACK.

According to one aspect of the present application, the above method is characterized in that,

the first-type HARQ-ACK only includes HARQ-ACK for a Semi-Persistent Scheduling (SPS) release and HARQ-ACK for a Transport-Block (TB)-based channel reception; the second-type HARQ-ACK only includes HARQ-ACK for a Semi-Persistent Scheduling (SPS) release and HARQ-ACK for a TB-based channel reception; neither the first-type HARQ-ACK nor the second-type HARQ-ACK includes HARQ-ACK for a Code Block Group-based (CBG-based) channel reception; the first bit block comprises at least one of HARQ-ACK for a Semi-Persistent Scheduling (SPS) release or HARQ-ACK for a TB-based channel reception; the first bit block does not include HARQ-ACK for a CBG-based channel reception.

According to one aspect of the present application, the above method is characterized in that,

when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

According to one aspect of the present application, the above method is characterized in that,

the first signal comprises a first sub-signal and a second sub-signal, the first sub-signal carrying the first bit block, while the second sub-signal carrying a second bit block, the first time-frequency resource block being used to determine a number of bits comprised in the second bit block.

According to one aspect of the present application, the above method is characterized in comprising:

transmitting a third signaling;

herein, the third signaling is used to determine a third bit block, the third bit block comprising HARQ-ACK associated with the third signaling; the first signal carries a first bit block set, with the first bit block being any bit block in the first bit block set, the third bit block being a bit block in the first bit block set other than the first bit block.

According to one aspect of the present application, the above method is characterized in that,

the first-type HARQ-ACK corresponds to a first index, while the second-type HARQ-ACK corresponds to a second index, the first index and the second index being different; the first signaling is used to determine a target index, the target index being one of the first index and the second index; when the target index is the first index, the first bit block comprises the first-type HARQ-ACK; when the target index is the second index, the first bit block comprises the second-type HARQ-ACK.

The present application provides a first node for wireless communications, comprising:

a first receiver, receiving a first signaling and a second signaling; and

a first transmitter, transmitting a first signal in a first time-frequency resource block, the first signal carrying a first bit block;

herein, the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

The present application provides a second node for wireless communications, comprising:

a second transmitter, transmitting a first signaling and a second signaling; and

a second receiver, receiving a first signal in a first time-frequency resource block, the first signal carrying a first bit block;

herein, the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

In one embodiment, the method in the present application has the following advantages:
having a rational interpretation of the DAI field in a scheduling DCI for a PUSCH, thus ensuring the consistent understanding of the DAI field between both sides of communications in case that HARQ-ACK codebooks of various priorities are multiplexed in a same PUSCH;
ensuring the reliability of reporting of high-priority control information, such as UCI;
processing HARQ-ACKs of various priorities respectively, thus avoiding the impact of missed detection of low-priority DCI over high-priority HARQ-ACK reporting.

The present application provides a method in a first node for wireless communications, comprising:

monitoring first-type signaling(s) and second-type signaling(s) in a first time-frequency resource pool, and receiving a first signaling in the first time-frequency resource pool; and

transmitting a first information block in a first radio resource block;

herein, the first-type signaling(s) and the second-type signaling(s) respectively correspond to different HARQ-ACK codebooks; the first information block comprises HARQ-ACK associated with the first signaling; the first-type signaling(s) comprise a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

In one embodiment, the problem to be solved in the present application is: how to design a HARQ codebook to support multiplexing of Intra-UE services of various priorities.

In one embodiment, the problem to be solved in the present application is that in LTE and NR systems, the cellular transmissions adopt a Downlink Assignment Index (DAI) to determine a HARQ feedback codebook, thus the efficiency of HARQ feedback can be enhanced and misunderstanding of the HARQ feedback codebook between communication sides can be avoided. For a better support to transmissions of services of different priorities, a counter DAI shall be reconsidered.

In one embodiment, the problem to be solved in the present application is that when two types of HARQ codebooks are transmitted on a same channel, for example, a Physical Uplink Control CHannel (PUCCH), a counter DAI needs to be reconsidered for the purpose of increasing the HARQ feedback efficiency and avoiding misunderstanding between both sides of communication over the meaning of HARQ feedback codebook.

In one embodiment, the essence of the above method lies in that the first-type signaling schedules URLLC services while the second-type signaling schedules eMBB services, a first field indicates DAI; a counter DAI in URLLC DCI can count both URLLC and eMBB services, while eMBB DCI only counts eMBB services. An advantage of adopting the method lies in that the eMBB HARQ codebook and the URLLC HARQ codebook can be multiplexed to avoid the impossibility of transmission of eMBB HARQ feedback resulting from low-priority HARQ transmission being dropped.

In one embodiment, the above method is advantageous in that when different types of HARQ codebooks are allowed to be transmitted on a same channel, e.g., a PUCCH, the impact of dropping lower priority DCI on higher priority HARQ information feedback can be reduced.

In one embodiment, the above method is advantageous in that when different types of HARQ codebooks are allowed to be transmitted on a same channel, e.g., a PUCCH, the inconsistency in understanding of HARQ feedback information between communication sides due to DCI missing can be reduced.

According to one aspect of the present application, the above method is characterized in comprising:

receiving a second signaling in the first time-frequency resource pool;

herein, the second signaling is a said second-type signaling; a second time window comprises the first time window, the second signaling being transmitted in time-domain resources in the second time window other than the first time window; the second-type signaling(s) comprise the first field; a value of the first field comprised in the second signaling is only related to the latter of a number of the first-type signaling(s) transmitted in the first time-frequency resource pool and a number of the second-type signaling(s) transmitted in the first time-frequency resource pool; the first information block does not comprise any HARQ-ACK associated with the second signaling.

According to one aspect of the present application, the above method is characterized in comprising:

receiving a third signaling in the first time-frequency resource pool;

herein, the third signaling is a said second-type signaling; the third signaling is transmitted in the first time window, the first information block comprising HARQ-ACK associated with the third signaling.

According to one aspect of the present application, the above method is characterized in that the first signaling is a said first-type signaling; each first-type signaling in a first signaling set is received in the first time-frequency resource pool; herein, the first signaling set comprises a first-type signaling other than the first signaling that is detected in the first time-frequency resource pool, the first signaling being later than a first-type signaling in the first signaling set; the first information block comprises HARQ-ACK associated with a first-type signaling in the first signaling set.

According to one aspect of the present application, the above method is characterized in that the first signaling comprises a second field; a value of the second field comprised in the first signaling is related to a number of the first-type signaling(s) transmitted in the first time-frequency resource pool and a number of the second-type signaling(s) transmitted in the first time-frequency resource pool; a third value and a fourth value are used together to determine a value of the second field comprised in the first signaling, where the third value is equal to a total number of {serving cell, PDCCH monitoring occasion}-pair(s) including the first-type signaling(s) up to the current PDCCH monitoring occasion in the first time window, while the fourth value is equal to a total number of {serving cell, PDCCH monitoring occasion}-pair(s) including the second-type signaling(s) up to the current PDCCH monitoring occasion in the first time window.

According to one aspect of the present application, the above method is characterized in comprising:

receiving a first bit block set;

herein, the first signaling comprises scheduling information of the first bit block set; the HARQ-ACK associated with the first signaling indicates whether each bit block in the first bit block set is correctly received.

According to one aspect of the present application, the above method is characterized in that the first signaling is used to indicate a Semi-Persistent Scheduling (SPS) release, the HARQ-ACK associated with the first signaling indicating whether the first signaling is correctly received.

The present application provides a method in a second node for wireless communications, comprising:

transmitting a first signaling in a first time-frequency resource pool; and

receiving a first information block in a first radio resource block;

herein, first-type signaling(s) and second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

According to one aspect of the present application, the above method is characterized in comprising:

transmitting a second signaling in the first time-frequency resource pool;

herein, the second signaling is a said second-type signaling; a second time window comprises the first time window, the second signaling being transmitted in time-domain resources in the second time window other than the first time window; the second-type signaling comprises the first field; a value of the first field comprised in the second signaling is only related to the latter of a number of the first-type signaling(s) transmitted in the first time-frequency resource pool and a number of the second-type signaling(s) transmitted in the first time-frequency resource pool; the first information block does not comprise any HARQ-ACK associated with the second signaling.

According to one aspect of the present application, the above method is characterized in comprising:

transmitting a third signaling in the first time-frequency resource pool;

herein, the third signaling is a said second-type signaling; the third signaling is transmitted in the first time window, the first information block comprising HARQ-ACK associated with the third signaling.

According to one aspect of the present application, the above method is characterized in that the first signaling is a said first-type signaling; each first-type signaling in a first signaling set is transmitted in the first time-frequency resource pool; herein, the first signaling set comprises a first-type signaling other than the first signaling that is detected in the first time-frequency resource pool, the first signaling being later than a first-type signaling in the first signaling set; the first information block comprises HARQ-ACK associated with a first-type signaling in the first signaling set.

According to one aspect of the present application, the above method is characterized in that the first signaling comprises a second field; a value of the second field comprised in the first signaling is related to a number of the first-type signaling(s) transmitted in the first time-frequency resource pool and a number of the second-type signaling(s) transmitted in the first time-frequency resource pool; a third value and a fourth value are used together to determine a value of the second field comprised in the first signaling, where the third value is equal to a total number of {serving cell, PDCCH monitoring occasion}-pair(s) including the first-type signaling(s) up to the current PDCCH monitoring occasion in the first time window, while the fourth value is equal to a total number of {serving cell, PDCCH monitoring occasion}-pair(s) including the second-type signaling(s) up to the current PDCCH monitoring occasion in the first time window.

According to one aspect of the present application, the above method is characterized in comprising:

transmitting a first bit block set;

herein, the first signaling comprises scheduling information of the first bit block set; the HARQ-ACK associated with the first signaling indicates whether each bit block in the first bit block set is correctly received.

According to one aspect of the present application, the above method is characterized in that the first signaling is used to indicate a Semi-Persistent Scheduling (SPS) release, the HARQ-ACK associated with the first signaling indicating whether the first signaling is correctly received.

The present application provides a first node for wireless communications, comprising:

a first receiver, monitoring first-type signaling(s) and second-type signaling(s) in a first time-frequency resource pool, and receiving a first signaling in the first time-frequency resource pool; and

a first transmitter, transmitting a first information block in a first radio resource block;

herein, the first-type signaling(s) and the second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

The present application provides a second node for wireless communications, comprising:

a second transmitter, transmitting a first signaling in a first time-frequency resource pool; and

a second receiver, receiving a first information block in a first radio resource block;

herein, first-type signaling(s) and second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

In one embodiment, the method in the present application has the following advantages:
the present application proposed a scheme for designing a HARQ codebook that supports multiplexing of Intra-UE traffics of various priorities;
the present application proposed a scheme for designing a counter DAI supporting transmissions of traffics of various priorities;
in the method provided above, the eMBB HARQ codebook and the URLLC HARQ codebook can be multiplexed to avoid the impossibility of transmission of eMBB HARQ feedback resulting from low-priority HARQ transmission being dropped;
when different types of HARQ codebooks are allowed to be multiplexed onto a same channel, i.e., a PUCCH, the method provided in the present application ameliorates the misunderstanding of HARQ feedback information between communication sides due to missed DCI.

### BRIEF DESCRIPTION OF THE DRAWINGS

Other features, objects and advantages of the present application will become more apparent from the detailed description of non-restrictive embodiments taken in conjunction with the following drawings:

FIG. 1A illustrates a flowchart of processing of a first node according to one embodiment of the present application.

FIG. 1B illustrates a flowchart of processing of a first node according to one embodiment of the present application.

FIG. 1C illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5A illustrates a flowchart of signal transmission according to one embodiment of the present application.

FIG. 5B illustrates a flowchart of signal transmission according to one embodiment of the present application.

FIG. 5C illustrates a flowchart of signal transmission according to one embodiment of the present application.

FIG. 6A illustrates a flowchart of determining whether a value of a first field in a third signaling is used to determine a number of information blocks comprised in a target information block subset or a total number of information blocks comprised in a first information block set according to one embodiment of the present application.

FIG. 6B illustrates a flowchart of determining whether a number of HARQ-ACK bits comprised in a first bit block is related to a first field in a second signaling according to one embodiment of the present application.

FIG. 6C illustrates a schematic diagram of relations among a first signaling, a second signaling and a third signaling, a first time window and a second time window according to one embodiment of the present application.

FIG. 7A illustrates a schematic diagram of relations among a first field, a first value and a second value, a number of information blocks comprised in a first information block subset and a number of information blocks comprised in a second information block subset according to one embodiment of the present application.

FIG. 7B illustrates a schematic diagram of relations among a first signal, a first sub-signal and a second sub-signal, a first bit block and a second bit block according to one embodiment of the present application.

FIG. 7C illustrates a schematic diagram of a first time window and a second time window according to one embodiment of the present application.

FIG. 8A illustrates a schematic diagram of how a relative positional relation between a first radio resource block and a second radio resource block in time domain relates to a target information block subset according to one embodiment of the present application.

FIG. 8B illustrates a schematic diagram of relations among a first signal, a first bit block set, a first signaling and a third signaling, a first bit block and a third bit block according to one embodiment of the present application.

FIG. 8C illustrates a schematic diagram of relations among a first signaling, a third signaling, a first signaling set and a second signaling set, a first sub-information-block and a second sub-information-block according to one embodiment of the present application.

FIG. 9A illustrates a schematic diagram of how a relative magnitude of a first index and a second index relates to a target information block subset according to one embodiment of the present application.

FIG. 9B illustrates a schematic diagram of relations among a second signaling, a second bit block and a first time-frequency resource block according to one embodiment of the present application.

FIG. 9C illustrates a schematic diagram of a radio resource occupied by a first information block according to one embodiment of the present application.

FIG. 10A illustrates a schematic diagram of relations among a first signaling, a second signaling, a first signaling group and a second signaling group, a first information block subset and a second information block subset according to one embodiment of the present application.

FIG. 10B illustrates a schematic diagram of relations among a first signaling, a target index and whether a first bit block comprises a first-type HARQ-ACK or a second-type HARQ-ACK according to one embodiment of the present application.

FIG. 10C illustrates a schematic diagram of a radio resource occupied by a first information block according to one embodiment of the present application.

FIG. 11A illustrates a structure block diagram of a processing device in a first node according to one embodiment of the present application.

FIG. 11B illustrates a structure block diagram of a processing device in a first node according to one embodiment of the present application.

FIG. 11C illustrates a schematic diagram of HARQ-ACK associated with a first signaling according to one embodiment of the present application.

FIG. 12A illustrates a structure block diagram of a processing device in a second node according to one embodiment of the present application.

FIG. 12B illustrates a structure block diagram of a processing device in a second node according to one embodiment of the present application.

FIG. 12C illustrates a schematic diagram of HARQ-ACK associated with a first signaling according to one embodiment of the present application.

FIG. 13 illustrates a structure block diagram of a processing device in a first node according to one embodiment of the present application.

FIG. 14 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1A

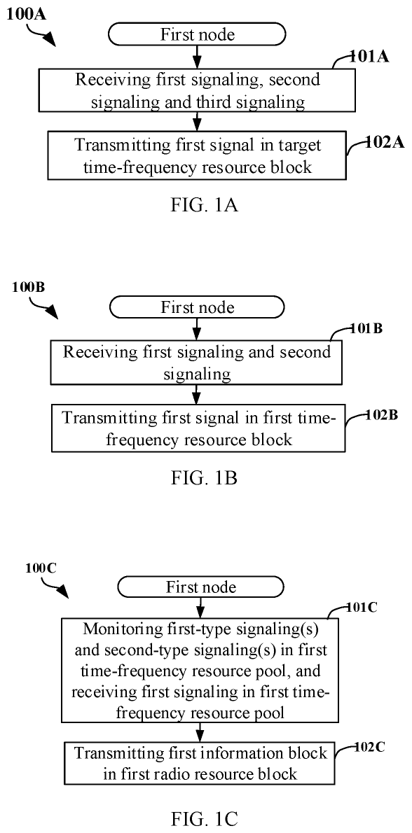

Embodiment 1A illustrates a flowchart of processing of a first node according to one embodiment of the present application, as shown in FIG. 1A.

In Embodiment 1A, the first node in the present application receives a first signaling, a second signaling and a third signaling in step 101A; and transmits a first signal in a target time-frequency resource block in step 102A.

In Embodiment 1A, the first signal carries a first information block set; the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one embodiment, the first signal is a radio signal.

In one embodiment, the first signal is a baseband signal.

In one embodiment, the first signal is a radio frequency signal.

In one embodiment, the first signaling is dynamically configured.

In one embodiment, the first signaling is a Physical Layer signaling.

In one embodiment, the first signaling is a Higher Layer signaling.

In one embodiment, the first signaling is a DownLink Grant Signaling.

In one embodiment, the first signaling is a Downlink Control Information (DCI) signaling.

In one embodiment, the first signaling comprises one or more fields in a DCI.

In one embodiment, the first signaling is transmitted in a downlink physical layer control channel (i.e., a downlink channel only capable of bearing physical layer signaling).

In one embodiment, the first signaling is DCI format 1_0, for the specific definition of the DCI format 1_0, refer to 3GPP TS38.212, Chapter 7.3.1.2.

In one embodiment, the first signaling is DCI format 1_1, for the specific definition of the DCI format 1_1, refer to 3GPP TS38.212, Chapter 7.3.1.2.

In one embodiment, the first signaling is DCI format 1_2, for the specific definition of the DCI format 1_2, refer to 3GPP TS38.212, Chapter 7.3.1.2.

In one embodiment, the first signaling comprises a signaling used for indicating a Semi-Persistent Scheduling (SPS) release.

In one embodiment, the first signaling comprises a signaling used for indicating configuration information of a downlink physical layer data channel.

In one embodiment, the first signaling comprises a signaling used for indicating configuration information of a Physical Downlink Shared Channel (PDSCH).

In one embodiment, the first signaling comprises a signaling used for scheduling a downlink physical layer data channel.

In one embodiment, the first signaling comprises a signaling used for scheduling a PDSCH.

In one embodiment, the downlink physical layer control channel is a Physical Downlink Control CHannel (PDCCH).

In one embodiment, the downlink physical layer control channel is a short PDCCH (sPDCCH).

In one embodiment, the downlink physical layer control channel is a Narrow Band PDCCH (NB-PDCCH).

In one embodiment, the downlink physical layer data channel is a PDSCH.

In one embodiment, the downlink physical layer data channel is a short PDSCH (sPDSCH).

In one embodiment, the downlink physical layer data channel is a Narrow Band PDSCH (NB-PDSCH).

In one embodiment, the second signaling is dynamically configured.

In one embodiment, the second signaling is a physical layer signaling.

In one embodiment, the second signaling is a higher layer signaling.

In one embodiment, the second signaling is a downlink scheduling signaling.

In one embodiment, the second signaling is DCI.

In one embodiment, the second signaling comprises one or more fields in a DCI.

In one embodiment, the second signaling is transmitted in a downlink physical layer control channel (i.e., a downlink channel only capable of bearing physical layer signaling).

In one embodiment, the second signaling is DCI format 1_0, for the specific definition of the DCI format 1_0, refer to 3GPP TS38.212, Chapter 7.3.1.2.

In one embodiment, the second signaling is DCI format 1_1, for the specific definition of the DCI format 1_1, refer to 3GPP TS38.212, Chapter 7.3.1.2.

In one embodiment, the second signaling is DCI format 1_2, for the specific definition of the DCI format 1_2, refer to 3GPP TS38.212, Chapter 7.3.1.2.

In one embodiment, the second signaling comprises a signaling used for indicating a Semi-Persistent Scheduling (SPS) release.

In one embodiment, the second signaling comprises a signaling used for indicating configuration information of a downlink physical layer data channel.

In one embodiment, the second signaling comprises a signaling used for indicating configuration information of a PDSCH.

In one embodiment, the second signaling comprises a signaling used for scheduling a downlink physical layer data channel.

In one embodiment, the second signaling comprises a signaling used for scheduling a PDSCH.

In one embodiment, the third signaling is dynamically configured.

In one embodiment, the third signaling is a physical layer signaling.

In one embodiment, the third signaling is a higher layer signaling.

In one embodiment, the third signaling is an UpLink Grant Signaling.

In one embodiment, the third signaling is DCI.

In one embodiment, the third signaling comprises one or more fields in a DCI.

In one embodiment, the third signaling is transmitted in a downlink physical layer control channel (i.e., a downlink channel only capable of bearing physical layer signaling).

In one embodiment, the third signaling is DCI format 0_0, for the specific definition of the DCI format 0_0, refer to 3GPP TS38.212, Chapter 7.3.1.1.

In one embodiment, the third signaling is DCI format 0_1, for the specific definition of the DCI format 0_1, refer to 3GPP TS38.212, Chapter 7.3.1.1.

In one embodiment, the third signaling is DCI format 0_2, for the specific definition of the DCI format 0_2, refer to 3GPP TS38.212, Chapter 7.3.1.1.

In one embodiment, the third signaling comprises a signaling used for indicating configuration information of a PUSCH.

In one embodiment, the third signaling comprises a signaling used for scheduling an uplink physical layer data channel.

In one embodiment, the third signaling comprises a signaling used for scheduling a PUSCH.

In one embodiment, the uplink physical layer data channel is a PUSCH.

In one embodiment, the uplink physical layer data channel is a short PUSCH (sPUSCH).

In one embodiment, the uplink physical layer data channel is a Narrow Band PUSCH (NB-PUSCH).

In one embodiment, the target time-frequency resource block comprises a positive integer number of Resource Element(s) (RE(s)).

In one embodiment, a said RE occupies a multicarrier symbol in time domain, and a subcarrier in frequency domain.

In one embodiment, the multicarrier symbol is an Orthogonal Frequency Division Multiplexing (OFDM) Symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the target time-frequency resource block comprises a positive integer number of subcarrier(s) in frequency domain.

In one embodiment, the target time-frequency resource block comprises a positive integer number of Physical Resource Block(s) (PRB(s)) in frequency domain.

In one embodiment, the target time-frequency resource block comprises a positive integer number of Resource Block(s) (RB(s)) in frequency domain.

In one embodiment, the target time-frequency resource block comprises a positive integer number of multicarrier symbol(s) in time domain.

In one embodiment, the target time-frequency resource block comprises a positive integer number of slot(s) in time domain.

In one embodiment, the target time-frequency resource block comprises a positive integer number of sub-slot(s) in time domain.

In one embodiment, the target time-frequency resource block comprises a positive integer number of sub-millisecond(s) in time domain.

In one embodiment, the target time-frequency resource block comprises a positive integer number of non-consecutive slots in time domain.

In one embodiment, the target time-frequency resource block comprises a positive integer number of consecutive slots in time domain.

In one embodiment, the target time-frequency resource block comprises a positive integer number of sub-frame(s) in time domain.

In one embodiment, the target time-frequency resource block is configured by a higher layer signaling.

In one embodiment, the target time-frequency resource block is configured by a Radio Resource Control (RRC) signaling.

In one embodiment, the target time-frequency resource block is configured by a Medium Access Control layer Control Element (MAC CE) signaling.

In one embodiment, the first field comprises one field in a DCI.

In one embodiment, the first field is a DAI field.

In one embodiment, the first field is a DAI field in an uplink scheduling signaling.

In one embodiment, the first field comprises a positive integer number of bit(s).

In one embodiment, the target time-frequency resource block comprises a PUSCH.

In one embodiment, the target time-frequency resource block comprises a sPUSCH.

In one embodiment, the target time-frequency resource block comprises an NB-PUSCH.

In one embodiment, the target time-frequency resource block comprises time-frequency resources scheduled in Uplink.

In one embodiment, the target time-frequency resource block comprises time-frequency resources scheduled in Sidelink.

In one embodiment, the HARQ-ACK comprises a HARQ-ACK bit.

In one embodiment, the HARQ-ACK comprises multiple HARQ-ACK bits.

In one embodiment, the HARQ-ACK comprises a HARQ-ACK Codebook.

In one embodiment, the HARQ-ACK comprises a HARQ-ACK Sub-codebook.

In one embodiment, the HARQ-ACK comprises a positive integer number of bit(s).

In one embodiment, the HARQ-ACK comprises a positive integer number of bit(s), where each of the positive integer number of bit(s) indicates an ACK or a NACK.

In one embodiment, the HARQ-ACK is used for indicating whether a bit block is correctly received.

In one embodiment, the first index and the second index are different; the value of the first field in the third signaling is only used to determine a number of information blocks comprised in the target information block subset, the target information block subset being the first information block subset or the second information block subset.

In one embodiment, the third signaling indicates time-domain resources of the target time-frequency resource block.

In one embodiment, the third signaling indicates frequency-domain resources of the target time-frequency resource block.

### Embodiment 1B

Embodiment 1B illustrates a flowchart of processing of a first node according to one embodiment of the present application, as shown in FIG. 1B.

In Embodiment 1B, the first node in the present application receives a first signaling and a second signaling in step 101B; and transmits a first signal in a first time-frequency resource block in step 102B.

In Embodiment 1B, the first signal carries a first bit block; the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

In one embodiment, the first signal is a radio signal.

In one embodiment, the first signal is a baseband signal.

In one embodiment, the first signal is a radio frequency signal.

In one embodiment, all bits in the first bit block are used for generating the first signal.

In one embodiment, partial bits in the first bit block are used for generating the first signal.

In one embodiment, all or partial bits in the first bit block through bundling operation are used for generating the first signal.

In one embodiment, all or partial bits in the first bit block through an operation of logical conjunction (Logic AND) are used for generating the first signal.

In one embodiment, all or partial bits in the first bit block through an operation of logical disjunction (Logical OR) are used for generating the first signal.

In one embodiment, all or partial bits in the first bit block through an operation of logical Exclusive OR (Logical Xor) are used for generating the first signal.

In one embodiment, the first signaling is dynamically configured.

In one embodiment, the first signaling is a Physical Layer signaling.

In one embodiment, the first signaling is a Higher Layer signaling.

In one embodiment, the first signaling is a DownLink Grant Signaling.

In one embodiment, the first signaling is a Downlink Control Information (DCI) signaling.

In one embodiment, the first signaling comprises one or more fields in a DCI.

In one embodiment, the first signaling is transmitted in a downlink physical layer control channel (i.e., a downlink channel only capable of bearing physical layer signaling).

In one embodiment, the first signaling is DCI format 1_0, for the specific definition of the DCI format 1_0, refer to 3GPP TS38.212, Chapter 7.3.1.2.

In one embodiment, the first signaling is DCI format 1_1, for the specific definition of the DCI format 1_1, refer to 3GPP TS38.212, Chapter 7.3.1.2.

In one embodiment, the first signaling is DCI format 1_2, for the specific definition of the DCI format 1_2, refer to 3GPP TS38.212, Chapter 7.3.1.2.

In one embodiment, the first signaling comprises a signaling used for indicating a Semi-Persistent Scheduling (SPS) release.

In one embodiment, the first signaling comprises a signaling used for indicating configuration information of a downlink physical layer data channel.

In one embodiment, the first signaling comprises a signaling used for indicating configuration information of a Physical Downlink Shared Channel (PDSCH).

In one embodiment, the first signaling comprises a signaling used for scheduling a downlink physical layer data channel.

In one embodiment, the first signaling comprises a signaling used for scheduling a PDSCH.

In one embodiment, the downlink physical layer control channel is a Physical Downlink Control CHannel (PDCCH).

In one embodiment, the downlink physical layer control channel is a short PDCCH (sPDCCH).

In one embodiment, the downlink physical layer control channel is a Narrow Band PDCCH (NB-PDCCH).

In one embodiment, the downlink physical layer data channel is a PDSCH.

In one embodiment, the downlink physical layer data channel is a short PDSCH (sPDSCH).

In one embodiment, the downlink physical layer data channel is a Narrow Band PDSCH (NB-PDSCH).

In one embodiment, the second signaling is dynamically configured.

In one embodiment, the second signaling is a physical layer signaling.

In one embodiment, the second signaling is a higher layer signaling.

In one embodiment, the second signaling is an UpLink Grant Signaling.

In one embodiment, the second signaling is DCI.

In one embodiment, the second signaling comprises one or more fields in a DCI.

In one embodiment, the second signaling is transmitted in a downlink physical layer control channel (i.e., a downlink channel only capable of bearing physical layer signaling).

In one embodiment, the second signaling is DCI format 0_0, for the specific definition of the DCI format 0_0, refer to 3GPP TS38.212, Chapter 7.3.1.1.

In one embodiment, the second signaling is DCI format 0_1, for the specific definition of the DCI format 0_1, refer to 3GPP TS38.212, Chapter 7.3.1.1.

In one embodiment, the second signaling is DCI format 0_2, for the specific definition of the DCI format 0_2, refer to 3GPP TS38.212, Chapter 7.3.1.1.

In one embodiment, the second signaling comprises a signaling used for indicating configuration information of a PUSCH.

In one embodiment, the second signaling comprises a signaling used for scheduling an uplink physical layer data channel.

In one embodiment, the second signaling comprises a signaling used for scheduling a PUSCH.

In one embodiment, the uplink physical layer data channel is a PUSCH.

In one embodiment, the uplink physical layer data channel is a short PUSCH (sPUSCH).

In one embodiment, the uplink physical layer data channel is a Narrow Band PUSCH (NB-PUSCH).

In one embodiment, the first time-frequency resource block comprises a positive integer number of Resource Element(s) (RE(s)).

In one embodiment, a said RE occupies a multicarrier symbol in time domain, and a subcarrier in frequency domain.

In one embodiment, the multicarrier symbol is an Orthogonal Frequency Division Multiplexing (OFDM) Symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the first time-frequency resource block comprises a positive integer number of subcarrier(s) in frequency domain.

In one embodiment, the first time-frequency resource block comprises a positive integer number of Physical Resource Block(s) (PRB(s)) in frequency domain.

In one embodiment, the first time-frequency resource block comprises a positive integer number of Resource Block(s) (RB(s)) in frequency domain.

In one embodiment, the first time-frequency resource block comprises a positive integer number of multicarrier symbol(s) in time domain.

In one embodiment, the first time-frequency resource block comprises a positive integer number of slot(s) in time domain.

In one embodiment, the first time-frequency resource block comprises a positive integer number of sub-slot(s) in time domain.

In one embodiment, the first time-frequency resource block comprises a positive integer number of sub-millisecond(s) (ms) in time domain.

In one embodiment, the first time-frequency resource block comprises a positive integer number of non-consecutive slots in time domain.

In one embodiment, the first time-frequency resource block comprises a positive integer number of consecutive slots in time domain.

In one embodiment, the first time-frequency resource block comprises a positive integer number of sub-frame(s) in time domain.

In one embodiment, the first time-frequency resource block is configured by a higher layer signaling.

In one embodiment, the first time-frequency resource block is configured by a Radio Resource Control (RRC) signaling.

In one embodiment, the first time-frequency resource block is configured by a Medium Access Control layer Control Element (MAC CE) signaling.

In one embodiment, the first field comprises one field in a DCI.

In one embodiment, the first field is a DAI field.

In one embodiment, the first field is a DAI field in an uplink scheduling signaling.

In one embodiment, the first field comprises a positive integer number of bit(s).

In one embodiment, the first time-frequency resource block comprises a PUSCH.

In one embodiment, the first time-frequency resource block comprises a sPUSCH.

In one embodiment, the first time-frequency resource block comprises an NB-PUSCH.

In one embodiment, the HARQ-ACK comprises a HARQ-ACK bit.

In one embodiment, the HARQ-ACK comprises multiple HARQ-ACK bits.

In one embodiment, the HARQ-ACK comprises a HARQ-ACK Codebook.

In one embodiment, the HARQ-ACK comprises a HARQ-ACK Sub-codebook.

In one embodiment, the HARQ-ACK comprises a positive integer number of bit(s).

In one embodiment, the HARQ-ACK comprises a positive integer number of bit(s), where each of the positive integer number of bit(s) indicates an ACK or a NACK.

In one embodiment, the first signaling indicates a Semi-Persistent Scheduling (SPS) release, the first bit block comprising a HARQ-ACK bit in response to the first signaling.

In one embodiment, the first node also receives a second signal; herein, the first signaling is used for indicating scheduling information of the second signal, the first bit block comprising a HARQ-ACK bit for the second signal.

In one subembodiment, the second signal is transmitted in a PDSCH.

In one embodiment, the scheduling information comprises one or more of indication information of an occupied time-domain resource, indication information of an occupied frequency-domain resource, a Modulation and Coding Scheme (MCS), configuration information for DeModulation Reference Signals (DMRS), a Hybrid Automatic Repeat reQuest (HARQ) process ID, a Redundancy Version (RV), a New Data Indicator (NDI) or a Priority.

In one embodiment, the first-type HARQ-ACK corresponds to a first priority, while the second HARQ-ACK corresponds to a second priority, the first priority being different from the second priority.

In one embodiment, the first-type HARQ-ACK and the second HARQ-ACK are respectively HARQ-ACKs with different priorities.

In one subembodiment, the priority is a Physical Layer priority.

In one embodiment, DCI corresponding to the first-type HARQ-ACK indicates a first priority, while DCI corresponding to the second-type HARQ-ACK indicates a second priority, the first priority being different from the second priority.

In one embodiment, the first-type HARQ-ACK and the second-type HARQ-ACK are respectively HARQ-ACKs for different service types.

In one embodiment, the first-type HARQ-ACK and the second HARQ-ACK are respectively different types of HARQ-ACKs.

In one subembodiment, the different service types include URLLC service type and eMBB service type.

In one subembodiment, the first-type HARQ-ACK and the second-type HARQ-ACK are respectively HARQ-ACKs for URLLC service type and for eMBB service type.

In one embodiment, the first-type HARQ-ACK corresponds to High Priority, while the second-type HARQ-ACK corresponds to Low Priority.

In one embodiment, the first priority is High Priority, while the second priority is Low Priority.

In one embodiment, the first priority is Low Priority, while the second priority is High Priority.

In one embodiment, a Priority Index corresponding to the first-type HARQ-ACK is equal to 0; the Priority Index corresponding to the second-type HARQ-ACK is equal to 1.

In one embodiment, the first-type HARQ-ACK corresponds to a Larger Priority Index; the second-type HARQ-ACK corresponds to a Smaller Priority Index.

In one embodiment, a Priority Index corresponding to the second-type HARQ-ACK is equal to 0; the Priority Index corresponding to the first-type HARQ-ACK is equal to 1.

In one embodiment, the second-type HARQ-ACK corresponds to a Larger Priority Index; the first-type HARQ-ACK corresponds to a Smaller Priority Index.

In one embodiment, the first-type HARQ-ACK and the second-type HARQ-ACK respectively correspond to different Priority Indexes.

In one embodiment, a Priority Indicator field in DCI indicates the priority index.

In one embodiment, DCI corresponding to the first-type HARQ-ACK and DCI corresponding to the second-type HARQ-ACK respectively indicate different said priority indexes.

In one subembodiment, the first priority and the second priority are both physical layer priorities.

In one embodiment, a first time-frequency resource block and a second radio resource block are respectively radio resource blocks in different time windows; the first-type HARQ-ACK and the second-type HARQ-ACK are respectively HARQ-ACKs respectively corresponding to the first time-frequency resource block and the second radio resource block.

In one subembodiment, the second radio resource block and the first time-frequency resource block are overlapping in time domain.

In one subembodiment, the first time-frequency resource block is reserved for the first-type HARQ-ACK, while the second radio resource block is reserved for the second-type HARQ-ACK.

In one subembodiment, the time window comprises one sub-slot.

In one subembodiment, the first time-frequency resource block comprises a PUCCH, while the second radio resource block comprises a PUCCH.

In one embodiment, the first-type HARQ-ACK corresponds to a first communication mode, while the second-type HARQ-ACK corresponds to a second communication mode, the first communication mode being different from the second communication mode.

In one subembodiment, the first communication mode is either of unicast and groupcast, and the second communication mode is either of unicast and groupcast.

In one embodiment, the first-type HARQ-ACK corresponds to a first link, while the second-type HARQ-ACK corresponds to a second link, the first link being different from the second link.

In one embodiment, the first-type HARQ-ACK corresponds to a first link, while the second-type HARQ-ACK corresponds to a second link, the first link being different from the second link.

In one embodiment, the first-type HARQ-ACK is HARQ-ACK for a first link, while the second-type HARQ-ACK is HARQ-ACK for a second link, the first link being different from the second link.

In one embodiment, the first link is Uplink, and the second link is Sidelink.

In one embodiment, the first signal carries a first bit block set, the first bit block set comprising M bit blocks, with the first bit block being any of the M bit blocks, M being a positive integer greater than 1.

In one embodiment, the first signaling and the second signaling are respectively scheduling signalings in links in different directions.

In one embodiment, the first signaling and the second signaling are respectively a DownLink Grant Signalling and an UpLink Grant Signaling.

In one embodiment, the first bit block comprises the second-type HARQ-ACKs; the first signaling comprises a second field, the second field in the first signaling being used to determine a number of the second-type HARQ-ACK bits comprised in the first bit block.

In one embodiment, the second field is a DAI field.

In one embodiment, the second field is a DAI field in a downlink scheduling signaling.

In one embodiment, the second field in the first signaling is involved in the process in which the first node determines a number of the second-type HARQ-ACK bits comprised in the first bit block.

In one embodiment, the first bit block comprises the first-type HARQ-ACK; the first signaling comprises a second field, the second field in the first signaling being used to determine a number of the first-type HARQ-ACK bits comprised in the first bit block.

In one subembodiment, the second field in the first signaling is involved in the process in which the first node determines a number of the first-type HARQ-ACK bits comprised in the first bit block.

In one subembodiment, both a value of the first field in the second signaling and a value of the second field in the first signaling are involved in the process in which the first node determines a number of the first-type HARQ-ACK bits comprised in the first bit block.

In one subembodiment, the first field and the second field are respectively a DAI field in an uplink scheduling signaling and a DAI field in a downlink scheduling signaling; both a value of the first field in the second signaling and a value of the second field in the first signaling are used by the first node for determining a number of the first-type HARQ-ACK bits comprised in the first bit block according to the process described in TS38.213, Section 9.1.3.

### Embodiment 1C

Embodiment 1C illustrates a flowchart of a first signaling and a first information block according to one embodiment of the present application, as shown in FIG. 1. In FIG. 1C, each step represents a step, it should be particularly noted that the sequence order of each box herein does not imply a chronological order of steps marked respectively by these boxes.

In Embodiment 1C, the first node in the present application monitors first-type signalings and second-type signalings in a first time-frequency resource pool in step 101C; receives a first signaling in the first time-frequency resource pool; and transmits a first information block in a first radio resource block in step 102C.

In Embodiment 1C, first-type signaling(s) and second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

In one embodiment, the first time-frequency resource pool comprises a positive integer number of Resource Element(s) (RE(s)).

In one embodiment, an RE occupies a multicarrier symbol in time domain, and a subcarrier in frequency domain.

In one embodiment, the multicarrier symbol is an Orthogonal Frequency Division Multiplexing (OFDM) Symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the first time-frequency resource pool comprises a positive integer number of subcarrier(s) in frequency domain.

In one embodiment, the first time-frequency resource pool comprises a positive integer number of Physical Resource Block(s) (PRB(s)) in frequency domain.

In one embodiment, the first time-frequency resource pool comprises a positive integer number of Resource Block(s) (RB(s)) in frequency domain.

In one embodiment, the first time-frequency resource pool comprises a positive integer number of multicarrier symbol(s) in time domain.

In one embodiment, the first time-frequency resource pool comprises a positive integer number of slot(s) in time domain.

In one embodiment, the first time-frequency resource pool comprises a positive integer number of sub-slot(s) in time domain.

In one embodiment, the first time-frequency resource pool comprises a positive integer number of sub-millisecond(s) (ms) in time domain.

In one embodiment, the first time-frequency resource pool comprises a positive integer number of non-consecutive slots in time domain.

In one embodiment, the first time-frequency resource pool comprises a positive integer number of consecutive slots in time domain.

In one embodiment, the first time-frequency resource pool comprises a positive integer number of sub-frame(s) in time domain.

In one embodiment, the first time-frequency resource pool is configured by a higher layer signaling.

In one embodiment, the first time-frequency resource pool is configured by a Radio Resource Control (RRC) signaling.

In one embodiment, the first time-frequency resource pool is configured by a Medium Access Control layer Control Element (MAC CE) signaling.

In one embodiment, the first time-frequency resource pool is pre-configured.

In one embodiment, a number of multicarrier symbols comprised in the first time-frequency resource pool in time domain is configured by a higher layer signaling.

In one embodiment, a number of multicarrier symbols comprised in the first time-frequency resource pool in time domain is configured by an RRC signaling.

In one embodiment, a number of multicarrier symbols comprised in the first time-frequency resource pool in time domain is configured by a MAC CE signaling.

In one embodiment, the monitoring refers to receiving based on energy detection, namely, sensing energies of radio signals and averages to acquire a received energy. If the received energy is greater than a second given threshold, it is determined that a signaling is received; otherwise, it is determined that no signaling is received.

In one embodiment, the monitoring refers to coherent reception, namely, performing coherent reception and measuring energy of a signal obtained by the coherent reception. If the energy of the signal obtained by the coherent reception is greater than a first given threshold, it is determined that a signaling is received; otherwise, it is determined that no signaling is received.

In one embodiment, the monitoring refers to blind decoding, that is, receiving a signal and performing decoding operation. If decoding is determined to be correct according to a Cyclic Redundancy Check (CRC) bit, it is determined that a signaling is received; otherwise, it is determined that no signaling is received.

In one embodiment, the phrase of monitoring first-type signaling(s) and second-type signaling(s) in a first time-frequency resource pool comprises: the first node determines according to CRC whether the first-type signaling(s) is(are) transmitted in the first time-frequency resource pool, and the first node determined according to CRC whether the second-type signaling(s) is(are) transmitted in the first time-frequency resource pool.

In one embodiment, the phrase of monitoring first-type signaling(s) and second-type signaling(s) in a first time-frequency resource pool comprises: the first node performs blind decoding in the first time-frequency resource pool to determine whether the first-type signaling(s) is(are) transmitted, and the first node performs blind detection in the first time-frequency resource pool to determine whether the second-type signaling(s) is(are) transmitted.

In one embodiment, the first-type signaling is dynamically configured.

In one embodiment, the first-type signaling is a physical layer signaling.

In one embodiment, the first-type signaling is a Downlink Control Information (DCI) signaling.

In one embodiment, the first-type signaling is transmitted in a downlink physical layer control channel (i.e., a downlink channel only capable of bearing physical layer signaling).

In one embodiment, the first-type signaling is DCI format 1_0, for the specific definition of the DCI format 10, refer to 3GPP TS38.212, Section 7.3.1.2.

In one embodiment, the first-type signaling is DCI format 1_1, for the specific definition of the DCI format 11, refer to 3GPP TS38.212, Section 7.3.1.2.

In one embodiment, the first-type signaling is DCI format 1_2, for the specific definition of the DCI format 12, refer to 3GPP TS38.212, Section 7.3.1.2.

In one embodiment, the first-type signaling comprises a signaling used for indicating a Semi-Persistent Scheduling (SPS) release.

In one embodiment, the first-type signaling comprises a signaling used for indicating configuration information of a downlink physical layer data channel.

In one embodiment, the first-type signaling comprises a signaling used for indicating configuration information of a Physical Downlink Shared Channel (PDSCH).

In one embodiment, the first-type signaling comprises a signaling used for scheduling a downlink physical layer data channel.

In one embodiment, the first-type signaling comprises a signaling used for scheduling a PDSCH.

In one embodiment, the downlink physical layer control channel is a Physical Downlink Control CHannel (PDCCH).

In one embodiment, the downlink physical layer control channel is a short PDCCH (sPDCCH).

In one embodiment, the downlink physical layer control channel is a Narrow Band PDCCH (NB-PDCCH).

In one embodiment, the downlink physical layer data channel is a Physical Downlink Shared CHannel (PDSCH).

In one embodiment, the downlink physical layer data channel is a short PDSCH (sPDSCH).

In one embodiment, the downlink physical layer data channel is a Narrow Band PDSCH (NB-PDSCH).

In one embodiment, the second-type signaling is dynamically configured.

In one embodiment, the second-type signaling is a physical layer signaling.

In one embodiment, the second-type signaling is a DCI signaling.

In one embodiment, the second-type signaling is transmitted in a downlink physical layer control channel (i.e., a downlink channel only capable of bearing physical layer signaling).

In one embodiment, the second-type signaling is DCI format 1_0, for the specific definition of the DCI format 10, refer to 3GPP TS38.212, Section 7.3.1.2.

In one embodiment, the second-type signaling is DCI format 1_1, for the specific definition of the DCI format 11, refer to 3GPP TS38.212, Section 7.3.1.2.

In one embodiment, the second-type signaling is DCI format 1_2, for the specific definition of the DCI format 12, refer to 3GPP TS38.212, Section 7.3.1.2.

In one embodiment, the second-type signaling comprises a signaling used for indicating a Semi-Persistent Scheduling (SPS) release.

In one embodiment, the second-type signaling comprises a signaling used for indicating configuration information of a downlink physical layer data channel.

In one embodiment, the second-type signaling comprises a signaling used for indicating configuration information of a Physical Downlink Shared Channel (PDSCH).

In one embodiment, the second-type signaling comprises a signaling used for scheduling a downlink physical layer data channel.

In one embodiment, the second-type signaling comprises a signaling used for scheduling a PDSCH.

In one embodiment, a format of the second-type signaling is the same as a format of the first-type signaling.

In one embodiment, a format of the second-type signaling is different from a format of the first-type signaling.

In one embodiment, a higher-layer signaling is used to indicate that both the first-type signaling and the second-type signaling comprise the first field.

In one embodiment, an RRC signaling is used to indicate that both the first-type signaling and the second-type signaling comprise the first field.

In one embodiment, the first field comprises a positive integer number of bit(s).

In one embodiment, the first field comprises all or part of a Downlink assignment index field, for the specific definition of the Downlink assignment index field, refer to 3GPP TS38.212, Section 7.3.1.2.

In one embodiment, a value of the first field indicates a counter Downlink Assignment Index (DAI).

In one embodiment, a value of the first field comprised in the first-type signaling indicates a counter Downlink Assignment Index (DAI) based on the first-type signaling and the second-type signaling, while a value of the first field comprised in the second-type signaling indicates a counter DAI based on the second-type signaling.

In one embodiment, the number of the first-type signaling(s) transmitted in the first time-frequency resource pool is a non-negative integer, and the number of the second-type signaling(s) transmitted in the first time-frequency resource pool is a non-negative integer.

In one embodiment, the first information block comprises Uplink Control Information (UCI).

In one embodiment, the first information block only comprises a Hybrid Automatic Repeat reQuest ACKnowledgement (HARQ-ACK).

In one embodiment, the first information block comprises a HARQ-ACK and Channel State Information (CSI).

In one embodiment, the first information block comprises a HARQ-ACK and a Scheduling Request (SR).

In one embodiment, the first information block comprises a HARQ-ACK, CSI and an SR.

In one embodiment, the first information block is transmitted on a PUCCH.

In one embodiment, the HARQ-ACK associated with the first signaling comprises an ACK.

In one embodiment, the HARQ-ACK associated with the first signaling comprises a NACK.

In one embodiment, the HARQ-ACK associated with the first signaling comprises an ACK or a NACK.

In one embodiment, the HARQ-ACK associated with the first signaling indicates whether each bit block in a bit block set scheduled by the first signaling is correctly received.

In one embodiment, the first signaling comprises a signaling used for scheduling a downlink physical layer data channel, the HARQ-ACK associated with the first signaling indicating whether a transmission of a downlink physical layer data channel scheduled by the first signaling is correctly received.

In one embodiment, the first signaling comprises a signaling used for scheduling a PDSCH, the HARQ-ACK associated with the first signaling indicating whether a transmission of a PDSCH scheduled by the first signaling is correctly received.

In one embodiment, the HARQ-ACK associated with the first signaling indicates whether the first signaling is correctly received.

In one embodiment, the first signaling comprises a signaling used to indicate a Semi-Persistent Scheduling (SPS) release, the HARQ-ACK associated with the first signaling indicating whether the first signaling is correctly received.

In one embodiment, the first-type signaling is a physical layer signaling used for Downlink Grant or used for Semi-Persistent Scheduling (SPS) release.

In one embodiment, the second-type signaling is a physical layer signaling used for Downlink Grant or used for Semi-Persistent Scheduling (SPS) release.

In one embodiment, the serving cell index is a positive integer.

In one embodiment, the Physical Downlink Control CHannel monitoring occasion is a PDCCH monitoring occasion.

In one embodiment, the Physical Downlink Control CHannel monitoring occasion is a sPDCCH monitoring occasion.

In one embodiment, the Physical Downlink Control CHannel monitoring occasion is an NB-PDCCH monitoring occasion.

In one embodiment, the first field comprising 2 bits, a value of the first field in the first signaling is equal to a remainder yielded by a sum of the first value and the second value being divided by 4.

In one embodiment, a value of the first field in the first signaling is equal to a sum of the first value and the second value.

In one embodiment, a value of the first field in the first signaling is equal to a weighted sum of the first value and the second value.

In one embodiment, the first field comprising X bit(s), a value of the first field in the first signaling is equal to a remainder yielded by a sum of the first value and the second value being divided by the X-th power of 2, where X is a positive integer.

In one embodiment, the first-type signaling indicates a high-priority HARQ-ACK Codebook (CB), while the second-type signaling indicates a low-priority HARQ-ACK Codebook (CB).

In one embodiment, the first-type signaling indicates a low-priority HARQ-ACK Codebook (CB), while the second-type signaling indicates a high-priority HARQ-ACK Codebook (CB).

In one embodiment, the first-type signaling indicates a Unicast-related HARQ-ACK Codebook (CB), while the second-type signaling indicates a Groupcast-related HARQ-ACK Codebook (CB).

In one embodiment, the first-type signaling indicates a Groupcast-related HARQ-ACK Codebook (CB), while the second-type signaling indicates a Unicast-related HARQ-ACK Codebook (CB).

In one embodiment, the first-type signaling and the second-type signaling are respectively used to determine different categories of HARQ-ACK Codebooks.

In one embodiment, the first-type signaling and the second-type signaling are respectively used to determine a high-priority HARQ-ACK Codebook and a low-priority HARQ-ACK Codebook.

In one embodiment, the first-type signaling and the second-type signaling are respectively used to determine a low-priority HARQ-ACK Codebook and a high-priority HARQ-ACK Codebook.

In one embodiment, the first-type signaling and the second-type signaling are respectively used to determine a unicast HARQ-ACK Codebook and a groupcast HARQ-ACK Codebook.

In one embodiment, the first-type signaling and the second-type signaling are respectively used to determine a groupcast HARQ-ACK Codebook and a unicast HARQ-ACK Codebook.

In one embodiment, the first-type signaling and the second-type signaling are respectively used to determine a Transport Block-based (TB-based) HARQ-ACK Codebook and a Code Block Group-based (CBG-based) HARQ-ACK Codebook.

In one embodiment, the first-type signaling and the second-type signaling are respectively used to determine a CBG-based HARQ-ACK Codebook and a TB-based HARQ-ACK Codebook.

In one embodiment, the first-type signaling and the second-type signaling are respectively used to determine a CBG-based HARQ-ACK Codebook and a non-CBG-based HARQ-ACK Codebook.

In one embodiment, the first-type signaling and the second-type signaling are respectively used to determine a non-CBG-based HARQ-ACK Codebook and a CBG-based HARQ-ACK Codebook.

In one embodiment, the first-type signaling and the second-type signaling are respectively used to determine different categories of CBG-based HARQ-ACK Codebooks.

In one embodiment, a value of the first field in the first signaling is smaller than a sum of the number of the first-type signaling(s) transmitted in the first time-frequency resource pool and the number of the second-type signaling(s) transmitted in the first time-frequency resource pool.

In one embodiment, a value of the first field in the first signaling is equal to a sum of the number of the first-type signaling(s) transmitted in the first time-frequency resource pool and the number of the second-type signaling(s) transmitted in the first time-frequency resource pool.

In one embodiment, a value of the first field in the first signaling is smaller than a weighted sum of the number of the first-type signaling(s) transmitted in the first time-frequency resource pool and the number of the second-type signaling(s) transmitted in the first time-frequency resource pool.

In one embodiment, a value of the first field in the first signaling is smaller than or equal to a sum of the number of the first-type signaling(s) transmitted in the first time-frequency resource pool and the number of the second-type signaling(s) transmitted in the first time-frequency resource pool; the value of the first field in the first signaling is greater than the number of the second-type signaling(s) transmitted in the first time-frequency resource pool.

In one embodiment, a value of the first field in the first signaling is equal to a weighted sum of the number of the first-type signaling(s) transmitted in the first time-frequency resource pool and the number of the second-type signaling(s) transmitted in the first time-frequency resource pool.

In one embodiment, the first time-frequency resource pool comprises multiple component carriers (CCs) in frequency domain.

In one embodiment, the first time-frequency resource pool comprises one CC in frequency domain.

In one embodiment, the first radio resource block comprises a PUCCH.

In one embodiment, the first radio resource block comprises a Physical Uplink Shared Channel (PUSCH).

In one embodiment, the first radio resource block comprises a positive integer number of multicarrier symbol(s) in time domain.

In one embodiment, the first radio resource block comprises a positive integer number of RE(s).

In one embodiment, the first radio resource block comprises a positive integer number of subcarrier(s) in frequency domain.

In one embodiment, the first radio resource block comprises a positive integer number of PRB(s) in frequency domain.

In one embodiment, the first radio resource block comprises a positive integer number of RB(s) in frequency domain.

In one embodiment, the first radio resource block belongs to a slot in time domain.

In one embodiment, the first radio resource block belongs to a sub-slot in time domain.

In one embodiment, the first radio resource block belongs to a sub-frame in time domain.

In one embodiment, the first radio resource block is configured by a higher layer signaling.

In one embodiment, the first radio resource block is configured by an RRC signaling.

In one embodiment, the first radio resource block is configured by a MAC CE signaling.

In one embodiment, the first radio resource block is pre-configured.

In one embodiment, the first-type signaling and the second-type signaling both comprise a third field, where the third field comprised in the first-type signaling indicates a first type, and the third field comprised in the second-type signaling indicates a second type, the first type being different from the second type.

In one subembodiment, the first type is High Priority, and the second type is Low Priority.

In one subembodiment, the first type is Low Priority, and the second type is High Priority.

In one subembodiment, the first type is Groupcast, and the second type is Unicast.

In one subembodiment, the first type is Unicast, and the second type is Groupcast.

In one embodiment, the first-type signaling and the second-type signaling both comprise a third field, where the third field in the first-type signaling indicates a first priority, and the third field in the second-type signaling indicates a second priority.

In one subembodiment, the third field comprises a positive integer number of bit(s).

In one subembodiment, the third field comprises 1 bit.

In one subembodiment, the third field is a Priority indicator Field, for the specific definition of the Priority indicator Field, refer to 3GPP TS38.212, Section 7.3.1.2.

In one subembodiment, the first priority is higher than the second priority.

In one subembodiment, a priority corresponding to the first priority is higher than that corresponding to the second priority.

In one subembodiment, when a value of the third field is equal to 0, the third field indicates the first priority; when a value of the third field is equal to 1, the third field indicates the second priority.

In one subembodiment, when a value of the third field is equal to 1, the third field indicates the first priority; when a value of the third field is equal to 0, the third field indicates the second priority.

In one subembodiment, the third field comprised in the first signaling indicates the first priority; the third field comprised in the third signaling indicates the second priority.

In one subembodiment, the third field comprised in the second signaling indicates the second priority.

### Embodiment 2

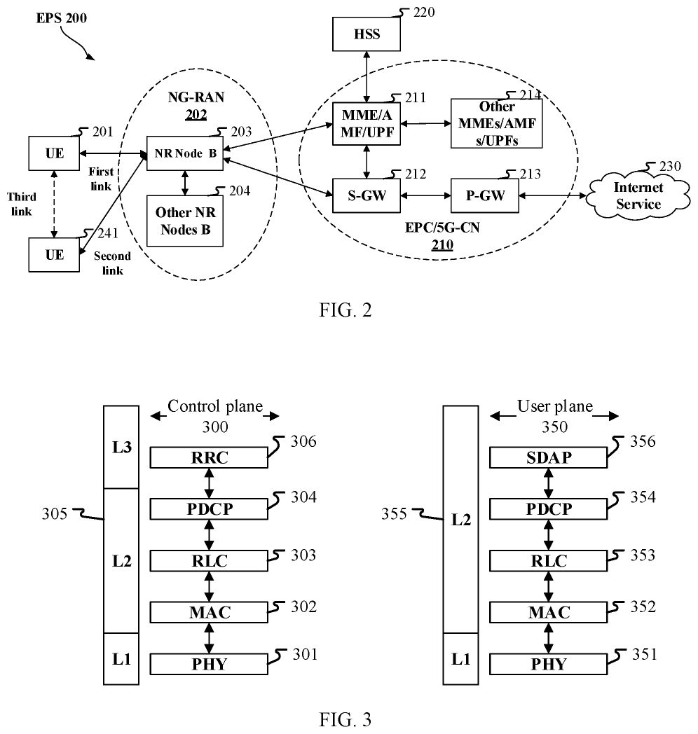

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 241 corresponds to the second node in the present application.

In one embodiment, the gNB 203 corresponds to the second node in the present application.

In one embodiment, the UE 241 corresponds to the first node in the present application.

In one embodiment, the UE 201 corresponds to the second node in the present application.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, i.e., layer 1, layer 2 and layer 3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block set in the present application is generated by the RRC sublayer 306.

In one embodiment, the first information block set in the present application is generated by the MAC sublayer 302.

In one embodiment, the first information block set in the present application is generated by the MAC sublayer 352.

In one embodiment, the first information block set in the present application is generated by the PHY 301.

In one embodiment, the first information block set in the present application is generated by the PHY 351.

In one embodiment, the first information block subset in the present application is generated by the RRC sublayer 306.

In one embodiment, the first information block subset in the present application is generated by the MAC sublayer 302.

In one embodiment, the first information block subset in the present application is generated by the MAC sublayer 352.

In one embodiment, the first information block subset in the present application is generated by the PHY 301.

In one embodiment, the first information block subset in the present application is generated by the PHY 351.

In one embodiment, the second information block subset in the present application is generated by the RRC sublayer 306.

In one embodiment, the second information block subset in the present application is generated by the MAC sublayer 302.

In one embodiment, the second information block subset in the present application is generated by the MAC sublayer 352.

In one embodiment, the second information block subset in the present application is generated by the PHY 301.

In one embodiment, the second information block subset in the present application is generated by the PHY 351.

In one embodiment, the first bit block in the present application is generated by the RRC sublayer 356.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 356.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the first signaling in the present application is generated by the PHY 301.

In one embodiment, the first signaling in the present application is generated by the PHY 351.

In one embodiment, the second signaling in the present application is generated by the PHY 301.

In one embodiment, the second signaling in the present application is generated by the PHY 351.

In one embodiment, the third signaling in the present application is generated by the PHY 301.

In one embodiment, the third signaling in the present application is generated by the PHY 351.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 356.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

In one embodiment, the third bit block in the present application is generated by the RRC sublayer 306.

In one embodiment, the third bit block in the present application is generated by the MAC sublayer 302.

In one embodiment, the third bit block in the present application is generated by the MAC sublayer 352.

In one embodiment, the third bit block in the present application is generated by the PHY 301.

In one embodiment, the third bit block in the present application is generated by the PHY 351.

In one embodiment, the first bit block set in the present application is generated by the RRC sublayer 306.

In one embodiment, the first bit block set in the present application is generated by the MAC sublayer 302.

In one embodiment, the first bit block set in the present application is generated by the MAC sublayer 352.

In one embodiment, the first bit block set in the present application is generated by the PHY 301.

In one embodiment, the first bit block set in the present application is generated by the PHY 351.

In one embodiment, the first signaling in the present application is generated by the PHY 301.

In one embodiment, the first signaling in the present application is generated by the PHY 351.

In one embodiment, the second signaling in the present application is generated by the PHY 301.

In one embodiment, the second signaling in the present application is generated by the PHY 351.

In one embodiment, the third signaling in the present application is generated by the PHY 301.

In one embodiment, the third signaling in the present application is generated by the PHY 351.

In one embodiment, the first bit block set in the present application is generated by the RRC sublayer 306.

In one embodiment, the first bit block set in the present application is generated by the MAC sublayer 302.

In one embodiment, the first bit block set in the present application is generated by the MAC sublayer 352.

In one embodiment, the first bit block set in the present application is generated by the PHY 301.

In one embodiment, the first bit block set in the present application is generated by the PHY 351.

In one embodiment, the first signaling in the present application is generated by the PHY 301.

In one embodiment, the first signaling in the present application is generated by the PHY 351.

In one embodiment, the second signaling in the present application is generated by the PHY 301.

In one embodiment, the second signaling in the present application is generated by the PHY 351.

In one embodiment, the third signaling in the present application is generated by the PHY 301.

In one embodiment, the third signaling in the present application is generated by the PHY 351.

In one embodiment, the first signaling subset in the present application is generated by the PHY 301.

In one embodiment, the first signaling subset in the present application is generated by the PHY 351.

In one embodiment, the monitoring in the present application is generated by the PHY 301.

In one embodiment, the monitoring in the present application is generated by the PHY 351.

In one embodiment, the first information block in the present application is generated by the PHY 301.

In one embodiment, the first information block in the present application is generated by the PHY 351.

### Embodiment 4

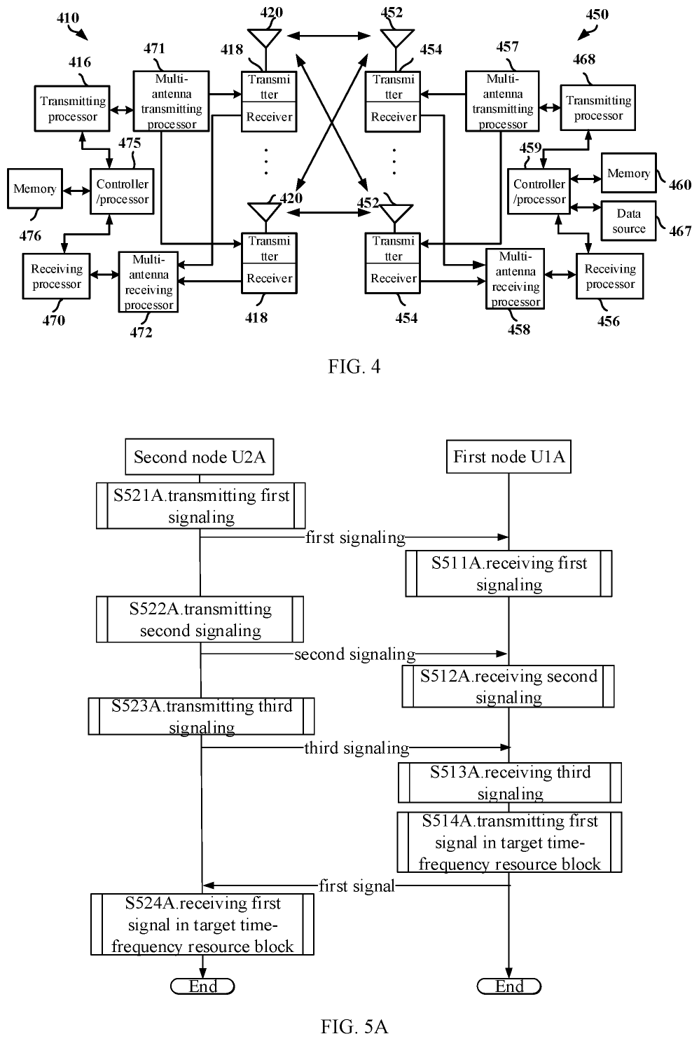

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second communication device 450 comprises: at least one controller/processor; the at least one controller/processor is responsible for HARQ operation.

In one subembodiment, the first communication device 410 comprises: at least one controller/processor; the at least one controller/processor is responsible for HARQ operation.

In one subembodiment, the first communication device 410 comprises: at least one controller/processor; the at least one controller/processor is responsible for using ACK and/or NACK protocols for error checking as a way of supporting HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first signaling, the second signaling and the third signaling in the present application; transmits the first signal in the present application in the target time-frequency resource block in the present application, the first signal carrying the first information block set in the present application; the third signaling is used to indicate the target time-frequency resource block; the first information block set comprises the first information block subset in the present application and the second information block subset in the present application, the first information block subset comprising HARQ-ACK associated with the first signaling and the second information block subset comprising HARQ-ACK associated with the second signaling; the third signaling comprises the first field in the present application, the first information block subset corresponds to the first index in the present application, while the second information block subset corresponds to the second index in the present application, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment, the second communication device 450 corresponds to the first node in the present application.

In one embodiment, the second communication device 450 comprises a memory that stores computer readable instruction program, the computer readable instruction program generates an action when executed by at least one processor, which includes: receiving the first signaling, the second signaling and the third signaling in the present application; and transmitting the first signal in the present application in the target time-frequency resource block in the present application, the first signal carrying the first information block set in the present application; the third signaling is used to indicate the target time-frequency resource block; the first information block set comprises the first information block subset in the present application and the second information block subset in the present application, the first information block subset comprising HARQ-ACK associated with the first signaling and the second information block subset comprising HARQ-ACK associated with the second signaling; the third signaling comprises the first field in the present application, the first information block subset corresponds to the first index in the present application, while the second information block subset corresponds to the second index in the present application, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first signaling, the second signaling and the third signaling in the present application; and receives the first signal in the present application in the target time-frequency resource block in the present application, the first signal carrying the first information block set in the present application; the third signaling is used to indicate the target time-frequency resource block; the first information block set comprises the first information block subset in the present application and the second information block subset in the present application, the first information block subset comprising HARQ-ACK associated with the first signaling and the second information block subset comprising HARQ-ACK associated with the second signaling; the third signaling comprises the first field in the present application, the first information block subset corresponds to the first index in the present application, while the second information block subset corresponds to the second index in the present application, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment, the first communication device 410 corresponds to the second node in the present application.

In one embodiment, the first communication device 410 comprises a memory that stores computer readable instruction program, the computer readable instruction program generates an action when executed by at least one processor, which includes: transmitting the first signaling, the second signaling and the third signaling in the present application; and receiving the first signal in the present application in the target time-frequency resource block in the present application, the first signal carrying the first information block set in the present application; the third signaling is used to indicate the target time-frequency resource block; the first information block set comprises the first information block subset in the present application and the second information block subset in the present application, the first information block subset comprising HARQ-ACK associated with the first signaling and the second information block subset comprising HARQ-ACK associated with the second signaling; the third signaling comprises the first field in the present application, the first information block subset corresponds to the first index in the present application, while the second information block subset corresponds to the second index in the present application, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the receiver 454, the multi-antenna receiving processor 458, the receiving processor 456, the controller/processor 459, the memory 460, or the data source 467 is used for receiving the second signaling in the present application.

In one embodiment, at least one of the antenna 420, the transmitter 418, the multi-antenna transmitting processor 471, the transmitting processor 416, the controller/processor 475 or the memory 476 is used for transmitting the second signaling in the present application.

In one embodiment, at least one of the antenna 452, the receiver 454, the multi-antenna receiving processor 458, the receiving processor 456, the controller/processor 459, the memory 460, or the data source 467 is used for receiving the third signaling in the present application.

In one embodiment, at least one of the antenna 420, the transmitter 418, the multi-antenna transmitting processor 471, the transmitting processor 416, the controller/processor 475 or the memory 476 is used for transmitting the third signaling in the present application.

In one embodiment, at least one of the antenna 452, the receiver 454, the multi-antenna receiving processor 458, the receiving processor 456, the controller/processor 459, the memory 460, or the data source 467 is used for receiving the first bit block in the present application.

In one embodiment, at least one of the antenna 420, the transmitter 418, the multi-antenna transmitting processor 471, the transmitting processor 416, the controller/processor 475 or the memory 476 is used for transmitting the first bit block in the present application.

In one embodiment, at least one of the antenna 452, the receiver 454, the multi-antenna receiving processor 458, the receiving processor 456, the controller/processor 459, the memory 460, or the data source 467 is used for receiving the second bit block in the present application.

In one embodiment, at least one of the antenna 420, the transmitter 418, the multi-antenna transmitting processor 471, the transmitting processor 416, the controller/processor 475 or the memory 476 is used for transmitting the second bit block in the present application.

In one embodiment, at least one of the antenna 452, the transmitter 454, the multi-antenna transmitting processor 458, the transmitting processor 468, the controller/processor 459, the memory 460, or the data source 467 is used for transmitting the first signal in the present application in the target time-frequency resource block in the present application.

In one embodiment, at least one of the antenna 420, the receiver 418, the multi-antenna receiving processor 472, the receiving processor 470, the controller/processor 475 or the memory 476 is used for receiving the first signal in the present application in the target time-frequency resource block in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives the first signaling and the second signaling in the present application, and transmits the first signal in the present application in the first time-frequency resource block in the present application, the first signal carrying the first bit block in the present application. Herein, the second signaling is used to indicate the first time-frequency resource block; the first signaling is used to determine the first bit block, the first bit block comprising HARQ-ACK associated with the first signaling; the first bit block only comprises the first-type HARQ-ACK or the second-type HARQ-ACK in the present application; the second signaling comprises the first field in the present application, whether the first bit block comprises the first-type HARQ-ACK is used to determine whether a number of HARQ-ACK bits comprised in the first bit block is related to the first field in the second signaling.

In one subembodiment, the second communication device 450 corresponds to the first node in the present application.

In one embodiment, the second communication device 450 comprises a memory that stores computer readable instruction program, the computer readable instruction program generates an action when executed by at least one processor, which includes: receiving the first signaling and the second signaling in the present application; and transmitting the first signal in the present application in the first time-frequency resource block in the present application, the first signal carrying the first bit block in the present application. Herein, the second signaling is used to indicate the first time-frequency resource block; the first signaling is used to determine the first bit block, the first bit block comprising HARQ-ACK associated with the first signaling; the first bit block only comprises the first-type HARQ-ACK or the second-type HARQ-ACK in the present application; the second signaling comprises the first field in the present application, whether the first bit block comprises the first-type HARQ-ACK is used to determine whether a number of HARQ-ACK bits comprised in the first bit block is related to the first field in the second signaling.

In one subembodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first signaling and the second signaling in the present application, and receives the first signal in the present application in the first time-frequency resource block in the present application, the first signal carrying the first bit block in the present application. Herein, the second signaling is used to indicate the first time-frequency resource block; the first signaling is used to determine the first bit block, the first bit block comprising HARQ-ACK associated with the first signaling; the first bit block only comprises the first-type HARQ-ACK or the second-type HARQ-ACK in the present application; the second signaling comprises the first field in the present application, whether the first bit block comprises the first-type HARQ-ACK is used to determine whether a number of HARQ-ACK bits comprised in the first bit block is related to the first field in the second signaling.

In one subembodiment, the first communication device 410 corresponds to the second node in the present application.

In one embodiment, the first communication device 410 comprises a memory that stores computer readable instruction program, the computer readable instruction program generates an action when executed by at least one processor, which includes: transmitting the first signaling and the second signaling in the present application; and receiving the first signal in the present application in the first time-frequency resource block in the present application, the first signal carrying the first bit block in the present application. Herein, the second signaling is used to indicate the first time-frequency resource block; the first signaling is used to determine the first bit block, the first bit block comprising HARQ-ACK associated with the first signaling; the first bit block only comprises the first-type HARQ-ACK or the second-type HARQ-ACK in the present application; the second signaling comprises the first field in the present application, whether the first bit block comprises the first-type HARQ-ACK is used to determine whether a number of HARQ-ACK bits comprised in the first bit block is related to the first field in the second signaling.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the receiver 454, the multi-antenna receiving processor 458, the receiving processor 456, the controller/processor 459, the memory 460, or the data source 467 is used for receiving the second signaling in the present application.

In one embodiment, at least one of the antenna 420, the transmitter 418, the multi-antenna transmitting processor 471, the transmitting processor 416, the controller/processor 475 or the memory 476 is used for transmitting the second signaling in the present application.

In one embodiment, at least one of the antenna 452, the receiver 454, the multi-antenna receiving processor 458, the receiving processor 456, the controller/processor 459, the memory 460, or the data source 467 is used for receiving the third signaling in the present application.

In one embodiment, at least one of the antenna 420, the transmitter 418, the multi-antenna transmitting processor 471, the transmitting processor 416, the controller/processor 475 or the memory 476 is used for transmitting the third signaling in the present application.

In one embodiment, at least one of the antenna 452, the transmitter 454, the multi-antenna transmitting processor 458, the transmitting processor 468, the controller/processor 459, the memory 460, or the data source 467 is used for transmitting the first signal in the present application in the first time-frequency resource block in the present application.

In one embodiment, at least one of the antenna 420, the receiver 418, the multi-antenna receiving processor 472, the receiving processor 470, the controller/processor 475 or the memory 476 is used for receiving the first signal in the present application in the first time-frequency resource block in the present application.

In one embodiment, the second communication device 450 comprises at least one processor and at least one memory. The at least one memory comprises computer program codes; the at least one memory and the computer program codes are configured to be used in collaboration with the at least one processor. The second communication device 450 at least monitors the first-type signalings and the second-type signalings in the present application in the first time-frequency resource pool in the present application; receives the first signaling in the present application in the first time-frequency resource pool; and transmits the first information block in the present application in the first radio resource block in the present application; herein, first-type signaling(s) and second-type signaling(s) respectively correspond to different HARQ-ACK codebooks; the first information block comprises HARQ-ACK associated with the first signaling; the first-type signaling comprises the first field in the present application; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; the first value and the second value in the present application are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in the first time window in the present application, while the second value being a total number of {serving cell, PDCCH monitoring occasion}-pair(s) including the second-type signaling(s) up to the current PDCCH monitoring occasion in the first time window.

In one subembodiment, the second communication device 450 corresponds to the first node in the present application.

In one embodiment, the second communication device 450 comprises a memory that stores computer readable instruction program, the computer readable instruction program generates an action when executed by at least one processor, which includes: monitoring the first-type signalings and the second-type signalings in the present application in the first time-frequency resource pool in the present application; receiving the first signaling in the present application in the first time-frequency resource pool; and transmitting the first information block in the present application in the first radio resource block in the present application; herein, the first-type signaling(s) and the second-type signaling(s) respectively correspond to different HARQ-ACK codebooks; the first information block comprises HARQ-ACK associated with the first signaling; the first-type signaling comprises the first field in the present application; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; the first value and the second value in the present application are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in the first time window in the present application, while the second value being a total number of {serving cell, PDCCH monitoring occasion}-pair(s) including the second-type signaling(s) up to the current PDCCH monitoring occasion in the first time window.

In one subembodiment, the second communication device 450 corresponds to the first node in the present application.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits the first signaling in the present application in the first time-frequency resource pool in the present application; and receives the first information block in the present application in the first radio resource block in the present application; herein, the first-type signaling(s) in the present application and the second-type signaling(s) in the present application respectively correspond to different HARQ-ACK codebooks; the first information block comprises HARQ-ACK associated with the first signaling; the first-type signaling comprises the first field in the present application; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; the first value and the second value in the present application are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in the first time window in the present application, while the second value being a total number of {serving cell, PDCCH monitoring occasion}-pair(s) including the second-type signaling(s) up to the current PDCCH monitoring occasion in the first time window.

In one subembodiment, the first communication device 410 corresponds to the second node in the present application.

In one embodiment, the first communication device 410 comprises a memory that stores computer readable instruction program, the computer readable instruction program generates an action when executed by at least one processor, which includes: transmitting the first signaling in the present application in the first time-frequency resource pool in the present application; and receiving the first information block in the present application in the first radio resource block in the present application; herein, the first-type signaling(s) in the present application and the second-type signaling(s) in the present application respectively correspond to different HARQ-ACK codebooks; the first information block comprises HARQ-ACK associated with the first signaling; the first-type signaling comprises the first field in the present application; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; the first value and the second value in the present application are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in the first time window in the present application, while the second value being a total number of {serving cell, PDCCH monitoring occasion}-pair(s) including the second-type signaling(s) up to the current PDCCH monitoring occasion in the first time window.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for monitoring the first-type signaling and the second-type signaling in the present application in the first time-frequency resource pool in the present application, and receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application in the first time-frequency resource pool in the present application.

In one embodiment, at least one of the antenna 452, the receiver 454, the multi-antenna receiving processor 458, the receiving processor 456, the controller/processor 459, the memory 460, or the data source 467 is used for receiving the first bit block set in the present application.

In one embodiment, at least one of the antenna 420, the transmitter 418, the multi-antenna transmitting processor 471, the transmitting processor 416, the controller/processor 475 or the memory 476 is used for transmitting the first bit block set in the present application.

In one embodiment, at least one of the antenna 452, the receiver 454, the multi-antenna receiving processor 458, the receiving processor 456, the controller/processor 459, the memory 460, or the data source 467 is used for receiving the second signaling in the present application in the first time-frequency resource pool in the present application.

In one embodiment, at least one of the antenna 420, the transmitter 418, the multi-antenna transmitting processor 471, the transmitting processor 416, the controller/processor 475 or the memory 476 is used for transmitting the second signaling in the present application in the first time-frequency resource pool in the present application.

In one embodiment, at least one of the antenna 452, the receiver 454, the multi-antenna receiving processor 458, the receiving processor 456, the controller/processor 459, the memory 460, or the data source 467 is used for receiving L1-1 first-type signaling(s) other than the first signaling in the first signaling set in the present application, and L2-1 second-type signaling(s) other than the second signaling in the second signaling set in the present application.

In one embodiment, at least one of the antenna 420, the transmitter 418, the multi-antenna transmitting processor 471, the transmitting processor 416, the controller/processor 475 or the memory 476 is used for transmitting L1-1 first-type signaling(s) other than the first signaling in the first signaling set in the present application, and L2-1 second-type signaling(s) other than the second signaling in the second signaling set in the present application.

In one embodiment, at least one of the antenna 452, the transmitter 454, the multi-antenna transmitting processor 468, the controller/processor 459, the memory 460 or the data source 467 is used for transmitting the first information block in the present application.

In one embodiment, at least one of the antenna 420, the receiver 418, the multi-antenna receiving processor 472, the receiving processor 470, the controller/processor 475, or the memory 476 is used for receiving the first information block in the present application.

### Embodiment 5A

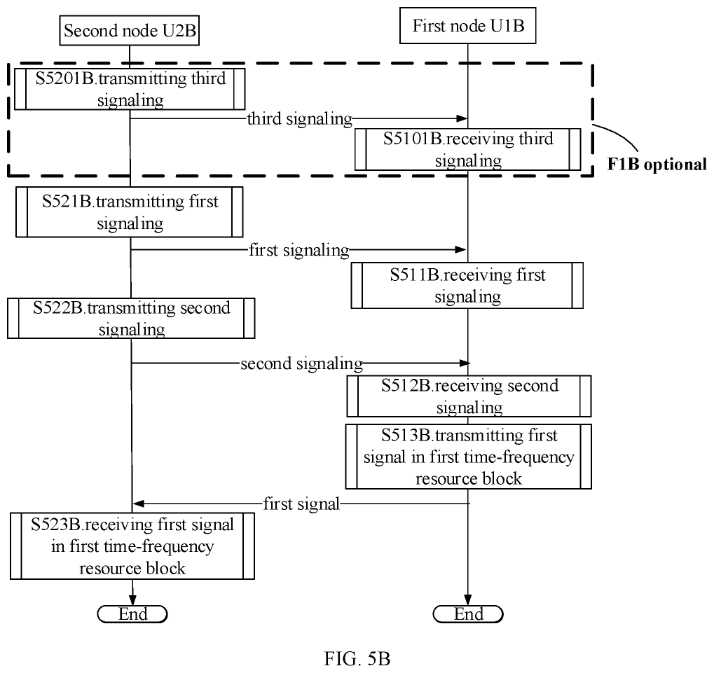

Embodiment 5A illustrates a flowchart of radio signal transmission according to one embodiment of the present application, as shown in FIG. 5A. In FIG. 5A, a first node U1A and a second node U2A are in communications via an air interface. Particularly, the sequential order of transmitting and receiving steps in FIG. 5A does not imply a specific temporal relation.

The first node U1A receives a first signaling in step S511A; receives a second signaling in step S512A; and receives a third signaling in step S513A; and transmits a first signal in a target time-frequency resource block in step S514A.

The second node U2A transmits a first signaling in step S521A; transmits a second signaling in step S522A; and transmits a third signaling in step S523A; and receives a first signal in a target time-frequency resource block in step S524A.

In Embodiment 5A, the first signal carries a first information block set; the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment of Embodiment 5A, the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

In one subembodiment of Embodiment 5A, the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

In one subembodiment of Embodiment 5A, the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

In one subembodiment of Embodiment 5A, the first index and the second index are different; a relative magnitude of the first index and the second index is used to determine the target information block subset between the first information block subset and the second information block subset.

In one subembodiment of Embodiment 5A, the first signaling is used for indicating a Semi-Persistent Scheduling (SPS) release, the HARQ-ACK associated with the first signaling indicating whether the first signaling is correctly received; or, the first receiver also receives a first bit block; where the first signaling comprises scheduling information of the first bit block, the HARQ-ACK associated with the first signaling indicating whether the first bit block is correctly received.

In one subembodiment of Embodiment 5A, the second signaling is used for indicating a Semi-Persistent Scheduling (SPS) release, the HARQ-ACK associated with the second signaling indicating whether the second signaling is correctly received; or, the first receiver also receives a second bit block; where the second signaling comprises scheduling information of the second bit block, the HARQ-ACK associated with the second signaling indicating whether the second bit block is correctly received.

In one embodiment, the first node U1A is the first node in the present application.

In one embodiment, the second node U2A is the second node in the present application.

In one embodiment, the first node U1A is a UE

In one embodiment, the second node U2A is a base station.

In one embodiment, the second node U2A is a UE.

In one embodiment, an air interface between the second node U2A and the first node U1A is a Uu interface.

In one embodiment, an air interface between the second node U2A and the first node U1A includes a cellular link.

In one embodiment, an air interface between the second node U2A and the first node U1A is a PC5 interface.

In one embodiment, an air interface between the second node U2A and the first node U1A includes a sidelink.

In one embodiment, an air interface between the second node U2A and the first node U1A includes a radio interface between a base station and a UE.

In one embodiment, the first bit block is transmitted in a PDSCH.

In one embodiment, the second bit block is transmitted in a PDSCH.

In one embodiment, the first bit block comprises downlink data.

In one embodiment, the first bit block does not comprise a HARQ-ACK.

In one embodiment, the first bit block comprises a Transport Block (TB).

In one embodiment, the first bit block comprises two TBs.

In one embodiment, the first bit block comprises a Code Block Group (CBG).

In one embodiment, the first bit block comprises multiple CBGs.

In one embodiment, the second bit block comprises downlink data.

In one embodiment, the second bit block does not comprise a HARQ-ACK.

In one embodiment, the second bit block comprises a TB.

In one embodiment, the second bit block comprises two TBs.

In one embodiment, the second bit block comprises a CBG.

In one embodiment, the second bit block comprises multiple CBGs.

In one embodiment, the first signaling and the second signaling respectively indicate different priority indexes.

In one embodiment, the first bit block and the second bit block are respectively data with different priorities.

In one embodiment, the first bit block and the second bit block are respectively data with different service types; the service type is URLLC or eMBB.

In one embodiment, when the target information block subset is the first information block subset, the value of the first field in the second signaling is used to determine a number of information blocks comprised in the second information block subset; when the target information block subset is the second information block subset, the value of the first field in the first signaling is used to determine a number of information blocks comprised in the first information block subset.

In one embodiment, the first index and the second index are different; when the target information block subset is the first information block subset, a number of information blocks comprised in the second information block subset is unrelated to any field in the third signaling; when the target information block subset is the second information block subset, a number of information blocks comprised in the first information block subset is unrelated to any field in the third signaling.

In one embodiment, all bits comprised in the first information block set are bits before channel coding.

In one embodiment, all information blocks comprised in the first information block set are information blocks before channel coding.

In one embodiment, the first signaling comprises a Priority Indicator field, the Priority Indicator field indicating a said priority index.

In one embodiment, the second signaling comprises a Priority Indicator field, the Priority Indicator field indicating a said priority index.

In one embodiment, the third signaling comprises a Priority Indicator field, the Priority Indicator field indicating a said priority index.

In one embodiment, the first signaling and the second signaling are DownLink Grant Signalings; the third signaling is an UpLink Grant Signaling.

In one embodiment, the scheduling information comprises one or more of indication information of an occupied time-domain resource, indication information of an occupied frequency-domain resource, a Modulation and Coding Scheme (MC S), configuration information for DeModulation Reference Signals (DMRS), a Hybrid Automatic Repeat reQuest (HARQ) process ID, a Redundancy Version (RV), a New Data Indicator (NDI) or a Priority.

In one embodiment, the first signal comprises a first sub-signal and a second sub-signal; the first sub-signal carries the first information block set, while the second sub-signal carries a third bit block.

In one embodiment, the third signaling comprises scheduling information of the third bit block.

In one embodiment, the third bit block comprises user service data.

In one embodiment, the third bit block comprises a CSI report.

In one embodiment, the third bit block comprises an aperiodic CSI report.

In one embodiment, the third bit block does not comprise a HARQ-ACK.

In one embodiment, the third bit block comprises a TB.

In one embodiment, the third bit block comprises two TBs.

In one embodiment, the third bit block comprises a CBG.

In one embodiment, the third bit block comprises multiple CBGs.

In one embodiment, the first signal comprises a first sub-signal; the first sub-signal is an output by all or part of bits in the first information block set sequentially through some or all of CRC Insertion, Segmentation, Code Block (CB)-level CRC Insertion, Channel Coding, Rate Matching, Concatenation, Scrambling, Modulation, Layer Mapping, Precoding, Mapping to Resource Element, Multicarrier Symbol Generation, and Modulation and Upconversion.

In one embodiment, the first signal comprises a second sub-signal; the second sub-signal is an output by all or partial bits in the third bit block sequentially through some or all of CRC Attachment, Segmentation, Code-block-level CRC Attachment, Channel Coding, Rate Matching, and Concatenation, Scrambling, Modulation, Layer Mapping, Precoding, Mapping to Resource Elements, Multicarrier Symbol Generation, as well as Modulation and Upconversion.

In one embodiment, the target time-frequency resource block is used to determine a number of bits comprised in the third bit block.

In one embodiment, the first node in the present application determines a number of bits comprised in the third bit block based on time-frequency resources comprised in the target time-frequency resource block according to the process described in TS38.214, Section 6.1.4.2.

In one embodiment, an information block in the first information block set comprises HARQ-ACK for a Semi-Persistent Scheduling (SPS) release or for a TB-based channel reception; any information block in the first information block set does not comprise any ARQ-ACK for a CBG-based channel reception.

In one embodiment, an information block in the first information block set only comprises HARQ-ACK for a Semi-Persistent Scheduling (SPS) release or for a TB-based channel reception; any information block in the first information block set does not comprise any ARQ-ACK for a CBG-based channel reception.

In one embodiment, the phrase of HARQ-ACK for a Semi-Persistent Scheduling (SPS) release comprises: the first node receives a signaling; the signaling indicates a Semi-Persistent Scheduling (SPS) PDSCH Release; the HARQ-ACK for an SPS release is used as a response to the signaling.

In one embodiment, the phrase of HARQ-ACK for a TB-based channel reception comprises: the first node receives a signaling; the signaling schedules a Transport block-based (TB-based) PDSCH; the HARQ-ACK for a TB-based channel reception indicates whether a TB in the TB-based PDSCH is correctly received.

In one embodiment, the phrase of HARQ-ACK for a CBG-based channel reception comprises: the first node receives a signaling; the signaling schedules a Code block Group-based (CBG-based) PDSCH; the HARQ-ACK for a CBG-based channel reception indicates whether a CBG in the CBG-based PDSCH is correctly received.

In one embodiment, the channel reception is PDSCH Reception.

In one embodiment, the channel reception is NB-PDSCH Reception.

In one embodiment, the channel reception is sPDSCH Reception.

### Embodiment 5B

Embodiment 5B illustrates a flowchart of radio signal transmission according to one embodiment of the present application, as shown in FIG. 5B. In FIG. 5B, a first node U1B and a second node U2B are in communications via an air interface. In FIG. 5B, the dotted-line box F1B is optional.

The first node U1B receives a third signaling in step S5101B; receives a first signaling in step S511B; and receives a second signaling in step S512B; and transmits a first signal in a first time-frequency resource block in step S513B.

The second node U2B transmits a third signaling in step S5201B; transmits a first signaling in step S521B; and transmits a second signaling in step S522B; and receives a first signal in a first time-frequency resource block in step S523B.

In Embodiment 5B, the first signal carries a first bit block; the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling; any field in the second signaling other than the first field is not used to determine a number of bits of the second-type HARQ-ACK; the first-type HARQ-ACK only includes HARQ-ACK for a Semi-Persistent Scheduling (SPS) release and HARQ-ACK for a TB-based channel reception; the second-type HARQ-ACK only includes HARQ-ACK for a Semi-Persistent Scheduling (SPS) release and HARQ-ACK for a TB-based channel reception; neither the first-type HARQ-ACK nor the second-type HARQ-ACK includes HARQ-ACK for a CBG-based channel reception; the first bit block comprises at least one of HARQ-ACK for an SPS or HARQ-ACK for a TB-based channel reception; the first bit block does not comprise HARQ-ACK for a CBG-based channel reception; when the first bit block comprises the first-type HARQ-ACK, the first field in the second signaling is used to determine a number of HARQ-ACK bits comprised in the first bit block; when the first bit block does not comprise the first-type HARQ-ACK, the number of HARQ-ACK bits comprised in the first bit block is unrelated to the first field in the second signaling; the first signal comprises a first sub-signal and a second sub-signal, the first sub-signal carrying the first bit block, and the second sub-signal carrying a second bit block, the first time-frequency resource block being used to determine a number of bits comprised in the second bit block; the third signaling is used to determine a third bit block, the third bit block comprising HARQ-ACK associated with the third signaling; the first signal carries a first bit block set, with the first bit block being any bit block in the first bit block set, and the third bit block being a bit block in the first bit block set other than the first bit block; the first-type HARQ-ACK corresponds to a first index, while the second-type HARQ-ACK corresponds to a second index, the first index being different from the second index; the first signaling is used to determine a target index, the target index being one of the first index and the second index; when the target index is the first index, the first bit block comprises the first-type HARQ-ACK; when the target index is the second index, the first bit block comprises the second-type HARQ-ACK.

In one embodiment, the first node U1B is the first node in the present application.

In one embodiment, the second node U2B is the second node in the present application.

In one embodiment, the first node U1B is a UE.

In one embodiment, the second node U2B is a base station.

In one embodiment, the second node U2B is a UE.

In one embodiment, an air interface between the second node U2B and the first node U1B is a Uu interface.

In one embodiment, an air interface between the second node U2B and the first node U1B includes a cellular link.

In one embodiment, an air interface between the second node U2B and the first node U1B is a PC5 interface.

In one embodiment, an air interface between the second node U2B and the first node U1B includes a sidelink.

In one embodiment, an air interface between the second node U2B and the first node U1B includes a radio interface between a base station and a UE.

In one embodiment, the second signaling does not comprise any DAI field other than the first field.

In one embodiment, the second signaling does not comprise any field being used to determine a number of the second-type HARQ-ACK bits.

In one subembodiment, the other DAI field comprises a 1st DAI field.

In one subembodiment, the other DAI field comprises a 2nd DAI field.

In one embodiment, a value of any field in the second signaling other than the first field is not involved in the process in which the first node determines a number of the second-type HARQ-ACK bits.

In one embodiment, a value of any field in the second signaling is not involved in the process in which the first node determines a number of the second-type HARQ-ACK bits.

In one embodiment, the first bit block comprises the first-type HARQ-ACK; the first-type HARQ-ACK comprised in the first bit block includes at least one of HARQ-ACK for an SPS release or HARQ-ACK for a TB-based channel reception; the first-type HARQ-ACK comprised in the first bit block does not include any HARQ-ACK for a CBG-based channel reception.

In one embodiment, the first bit block comprises the second-type HARQ-ACK; the second-type HARQ-ACK comprised in the first bit block includes at least one of HARQ-ACK for an SPS release or HARQ-ACK for a TB-based channel reception; the second-type HARQ-ACK comprised in the first bit block does not include any HARQ-ACK for a CBG-based channel reception.

In one embodiment, the phrase of HARQ-ACK for a Semi-Persistent Scheduling (SPS) release comprises: the first node receives a signaling; the signaling indicates a Semi-Persistent Scheduling (SPS) PDSCH Release; the HARQ-ACK for an SPS release is used as a response to the signaling.

In one embodiment, the phrase of HARQ-ACK for a TB-based channel reception comprises: the first node receives a signaling; the signaling schedules a Transport block-based (TB-based) PDSCH; the HARQ-ACK for a TB-based channel reception indicates whether a TB in the TB-based PDSCH is correctly received.

In one embodiment, the phrase of HARQ-ACK for a CBG-based channel reception comprises: the first node receives a signaling; the signaling schedules a Code block Group-based (CBG-based) PDSCH; the HARQ-ACK for a CBG-based channel reception indicates whether a CBG in the CBG-based PDSCH is correctly received.

In one embodiment, the channel reception is PDSCH Reception.

In one embodiment, the channel reception is NB-PDSCH Reception.

In one embodiment, the channel reception is sPDSCH Reception.

In one embodiment, the channel reception includes reception of data transmitted in a physical channel.

In one embodiment, the channel reception includes reception of a downlink physical channel.

In one embodiment, the steps marked by the box F1B in FIG. 5B exist.

In one embodiment, the steps marked by the box F1B in FIG. 5B do not exist

### Embodiment 5C

Embodiment 5C illustrates a flowchart of radio signal transmission according to one embodiment of the present application, as shown in FIG. 5C. In FIG. 5C, a first node U1C and a second node U2C are in communications via an air interface. In FIG. 5C, the dotted-line boxes F1C, F2C and F3C are optional.

The first node U1C monitors first-type signaling(s) and second-type signaling(s) in a first time-frequency resource pool in step S511C; receives a third signaling in a first time-frequency resource pool in step S5101C; and receives a first signaling in a first time-frequency resource pool in step S512C; receives a first bit block set in step S5102C; receives a second signaling in a first time-frequency resource pool in step S5103C; and transmits a first information block in a first radio resource block in step S513C.

The second node U2C transmits a third signaling in a first time-frequency resource pool in step S5201C; and transmits a first signaling in a first time-frequency resource pool in step S521C; transmits a first bit block set in step S5202C; transmits a second signaling in a first time-frequency resource pool in step S5203C; and receives a first information block in a first radio resource block in step S522C.

In Embodiment 5C, the first-type signaling(s) and the second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window; the second signaling is a said second-type signaling; a second time window comprises the first time window, the second signaling being transmitted in time-domain resources in the second time window other than the first time window; the second-type signaling comprises the first field; a value of the first field comprised in the second signaling is only related to the latter of a number of the first-type signaling(s) transmitted in the first time-frequency resource pool and a number of the second-type signaling(s) transmitted in the first time-frequency resource pool; the first information block does not comprise any HARQ-ACK associated with the second signaling; the third signaling is a said second-type signaling; the third signaling is transmitted in the first time window, the first information block comprising HARQ-ACK associated with the third signaling; the first signaling is a said first-type signaling; each first-type signaling in a first signaling set is transmitted in the first time-frequency resource pool; herein, the first signaling set comprises a first-type signaling other than the first signaling that is detected in the first time-frequency resource pool, the first signaling being later than a first-type signaling in the first signaling set; the first information block comprises HARQ-ACK associated with a first-type signaling in the first signaling set; the first signaling comprises a second field; a value of the second field comprised in the first signaling is related to a number of the first-type signaling(s) transmitted in the first time-frequency resource pool and a number of the second-type signaling(s) transmitted in the first time-frequency resource pool; a third value and a fourth value are used together to determine a value of the second field comprised in the first signaling, where the third value is equal to a total number of {serving cell, PDCCH monitoring occasion}-pair(s) including the first-type signaling(s) up to the current PDCCH monitoring occasion in the first time window, while the fourth value is equal to a total number of {serving cell, PDCCH monitoring occasion}-pair(s) including the second-type signaling(s) up to the current PDCCH monitoring occasion in the first time window.

In Embodiment 5C, the first signaling comprises scheduling information of the first bit block set; the HARQ-ACK associated with the first signaling indicates whether each bit block in the first bit block set is correctly received; or, the first signaling is used to indicate a Semi-Persistent Scheduling (SPS) release, the HARQ-ACK associated with the first signaling indicating whether the first signaling is correctly received.

In one embodiment, the first node U1C is the first node in the present application.

In one embodiment, the second node U2C is the second node in the present application.

In one embodiment, the first node U1C is a UE.

In one embodiment, the second node U2C is a base station.

In one embodiment, the second node U2C is a UE.

In one embodiment, an air interface between the second node U2C and the first node U1C is a Uu interface.

In one embodiment, an air interface between the second node U2C and the first node U1C includes a cellular link.

In one embodiment, an air interface between the second node U2C and the first node U1C includes a radio interface between a base station and a UE.

In one embodiment, the first information block comprises a first sub-information-block, the first sub-information-block comprising the HARQ-ACK associated with the first signaling; a second sub-information-block comprises the HARQ-ACK associated with the third signaling; the first signaling indicates the first radio resource block, while the third signaling indicates a second radio resource block, the first radio resource block being reserved for the first sub-information-block, and the second radio resource block being reserved for the second sub-information-block; whether a time unit to which the first radio resource block belongs in time domain overlaps with a time unit to which the second radio resource block belongs in time domain is used to determine whether the first information block comprises the second sub-information-block, or, whether the first radio resource block overlaps with the second radio resource block in time domain is used to determine whether the first information block comprises the second sub-information-block.

In one subembodiment, the time unit to which the first radio resource block belongs in time domain comprises a slot, and the time unit to which the second radio resource block belongs in time domain comprises a slot.

In one subembodiment, the time unit to which the first radio resource block belongs in time domain comprises a sub-frame, and the time unit to which the second radio resource block belongs in time domain comprises a sub-frame.

In one subembodiment, the time unit to which the first radio resource block belongs in time domain and the time unit to which the second radio resource block belongs in time domain comprise equal numbers of slots.

In one subembodiment, the time unit to which the first radio resource block belongs in time domain and the time unit to which the second radio resource block belongs in time domain comprise equal numbers of sub-frames.

In one subembodiment, the time unit to which the first radio resource block belongs in time domain and the time unit to which the second radio resource block belongs in time domain comprise equal numbers of multicarrier symbols.

In one subembodiment, the time unit to which the first radio resource block belongs in time domain and the time unit to which the second radio resource block belongs in time domain are overlapping, the first information block comprising the first sub-information-block and the second sub-information-block.

In one subembodiment, the time unit to which the first radio resource block belongs in time domain and the time unit to which the second radio resource block belongs in time domain are orthogonal (that is, non-overlapping), the first information block comprising only the first sub-information-block between the first sub-information-block and the second sub-information-block.

In one subembodiment, the phrase that the time unit to which the first radio resource block belongs in time domain and the time unit to which the second radio resource block belongs in time domain are overlapping means: the time unit to which the first radio resource block belongs in time domain and the time unit to which the second radio resource block belongs in time domain are the same; the phrase that the time unit to which the first radio resource block belongs in time domain and the time unit to which the second radio resource block belongs in time domain are orthogonal (that is, non-overlapping) means: the time unit to which the first radio resource block belongs in time domain and the time unit to which the second radio resource block belongs in time domain are different.

In one subembodiment, the phrase that the time unit to which the first radio resource block belongs in time domain and the time unit to which the second radio resource block belongs in time domain are overlapping means: the time unit to which the first radio resource block belongs in time domain and the time unit to which the second radio resource block belongs in time domain comprise the same multicarrier symbol; the phrase that the time unit to which the first radio resource block belongs in time domain and the time unit to which the second radio resource block belongs in time domain are orthogonal (that is, non-overlapping) means: any multicarrier symbol in the time unit to which the first radio resource block belongs in time domain does not belong to the time unit to which the second radio resource block belongs in time domain.

In one subembodiment, the first radio resource block and the second radio resource block are overlapping in time domain, the first information block comprising the first sub-information-block and the second sub-information-block.

In one subembodiment, the first radio resource block and the second radio resource block are orthogonal (that is, non-overlapping) in time domain, the first information block comprising only the first sub-information-block between the first sub-information-block and the second sub-information-block.

In one subembodiment, the first radio resource block and the second radio resource block are overlapping in time domain, where the first radio resource block and the second radio resource block comprise a same multicarrier symbol.

In one subembodiment, the first radio resource block and the second radio resource block are orthogonal (that is, non-overlapping) in time domain, any multicarrier symbol in the first radio resource block does not belong to the second radio resource block.

In one subembodiment, the first information block comprises the first sub-information-block and the second sub-information-block.

In one subembodiment, the first information block comprises only the first sub-information-block between the first sub-information-block and the second sub-information-block.

In one subembodiment, the first sub-information-block comprises UCI.

In one subembodiment, the first sub-information-block only comprises a HARQ-ACK.

In one subembodiment, the first sub-information-block comprises a HARQ-ACK and CSI.

In one subembodiment, the first sub-information-block comprises a HARQ-ACK and an SR.

In one subembodiment, the first sub-information-block comprises a HARQ-ACK, CSI and an SR.

In one subembodiment, the second sub-information-block comprises UCI.

In one subembodiment, the second sub-information-block only comprises a HARQ-ACK.

In one subembodiment, the second sub-information-block comprises a HARQ-ACK and CSI.

In one subembodiment, the second sub-information-block comprises a HARQ-ACK and an SR.

In one subembodiment, the second sub-information-block comprises a HARQ-ACK, CSI and an SR.

In one subembodiment, the first radio resource block belongs to a slot in time domain, and the second radio resource block belongs to a slot in time domain.

In one subembodiment, the first radio resource block belongs to a sub-frame in time domain, and the second radio resource block belongs to a sub-frame in time domain.

In one subembodiment, the first radio resource block and the second radio resource block are both configured by a higher layer signaling.

In one subembodiment, the first radio resource block and the second radio resource block are both configured by an RRC signaling.

In one subembodiment, the first radio resource block and the second radio resource block are both configured by a MAC CE signaling.

In one subembodiment, the first radio resource block and the second radio resource block are pre-configured.

In one subembodiment, the first radio resource block comprises a positive integer number of RE(s), and the second radio resource block comprises a positive integer number of RE(s).

In one subembodiment, the first radio resource block comprises a positive integer number of subcarrier(s) in frequency domain, and the second radio resource block comprises a positive integer number of subcarrier(s) in frequency domain.

In one subembodiment, the first radio resource block comprises a positive integer number of PRB(s) in frequency domain, and the second radio resource block comprises a positive integer number of PRB(s) in frequency domain.

In one subembodiment, the first radio resource block comprises a positive integer number of RB(s) in frequency domain, and the second radio resource block comprises a positive integer number of RB(s) in frequency domain.

In one subembodiment, the first radio resource block comprises a positive integer number of multicarrier symbol(s) in time domain, and the second radio resource block comprises a positive integer number of multicarrier symbol(s) in time domain.

In one subembodiment, the method in the first node in the present application further comprises:

transmitting the second sub-information-block in the second radio resource block.

In one subembodiment, the method in the second node in the present application further comprises:

receiving the second sub-information-block in the second radio resource block.

In one subembodiment, the first node in the present application also transmits the second sub-information-block in the second radio resource block, while the second node in the present application also receives the second sub-information-block in the second radio resource block.

In one subembodiment, the method in the first node in the present application further comprises:

dropping transmitting the second sub-information-block in the second radio resource block.

In one subembodiment, the first node in the present application drops transmitting the second sub-information-block in the second radio resource block.

In one subembodiment, the method in the first node in the present application further comprises:

transmitting the second sub-information-block in the second radio resource block, or, dropping transmitting the second sub-information-block in the second radio resource block.

In one subembodiment, the first node in the present application also transmits the second sub-information-block in the second radio resource block, or, the first node in the present application drops transmitting the second sub-information-block in the second radio resource block.

In one subembodiment, whether the first information block comprises the second sub-information-block is used to determine whether the first node in the present application transmits the second sub-information-block in the second radio resource block.

In one subembodiment, the first information block comprises only the first sub-information-block between the first sub-information-block and the second sub-information-block, the first node in the present application transmitting the second sub-information-block in the second radio resource block.

In one subembodiment, the time unit to which the first radio resource block belongs in time domain and the time unit to which the second radio resource block belongs in time domain are orthogonal (that is, non-overlapping), the first node in the present application transmitting the second sub-information-block in the second radio resource block.

In one subembodiment, the first radio resource block and the second radio resource block are orthogonal (that is, non-overlapping) in time domain, the first node in the present application transmitting the second sub-information-block in the second radio resource block.

In one subembodiment, the first information block comprises the first sub-information-block and the second sub-information-block, the first node in the present application dropping transmitting the second sub-information-block in the second radio resource block.

In one subembodiment, the time unit to which the first radio resource block belongs in time domain and the time unit to which the second radio resource block belongs in time domain are overlapping, the first node in the present application dropping transmitting the second sub-information-block in the second radio resource block.

In one subembodiment, the first radio resource block and the second radio resource block are overlapping in time domain, the first node in the present application dropping transmitting the second sub-information-block in the second radio resource block.

In one embodiment, the first information block comprises a first sub-information-block and a second sub-information-block.

In one subembodiment, the first sub-information-block comprises HARQ-ACK information associated with the first-type signaling; the second sub-information-block comprises HARQ-ACK information associated with the second-type signaling.

In one subembodiment, the first sub-information-block comprises M1 piece(s) of CBG-based HARQ-ACK information associated with the first-type signaling; the second sub-information-block comprises M2 piece(s) of CBG-based HARQ-ACK information associated with the second-type signaling; M1 is a positive integer, and M2 is a positive integer, M1 being unequal to M2.

In one subembodiment, the first sub-information-block comprises TB-based HARQ-ACK information associated with the first signaling; the second sub-information-block comprises CBG-based HARQ-ACK information associated with the third signaling.

In one subembodiment, the first sub-information-block comprises CBG-based HARQ-ACK information associated with the first signaling; the second sub-information-block comprises TB-based HARQ-ACK information associated with the third signaling.

In one subembodiment, the first sub-information-block comprises high-priority HARQ-ACK information; the second sub-information-block comprises low-priority HARQ-ACK information.

In one subembodiment, the first sub-information-block comprises low-priority HARQ-ACK information; the second sub-information-block comprises high-priority HARQ-ACK information.

In one subembodiment, the first sub-information-block comprises Groupcast-based HARQ-ACK information; the second sub-information-block comprises Unicast-based HARQ-ACK information.

In one subembodiment, the first sub-information-block comprises Unicast-based HARQ-ACK information; the second sub-information-block comprises Groupcast-based HARQ-ACK information.

In one embodiment, an accumulative number of {serving cell, PDCCH monitoring occasion}-pair(s) including the second-type signaling(s), first in an ascending order of serving cell indexes and then in an ascending order of PDCCH monitoring occasion indexes, up to a current serving cell and a current PDCCH monitoring occasion in the first time window is used to determine the first field in the third signaling.

In one embodiment, the method in the first node in the present application further comprises:

receiving a second bit block set;

herein, the second signaling comprises scheduling information of the second bit block set; the HARQ-ACK associated with the second signaling indicates whether each bit block in the second bit block set is correctly received.

In one embodiment, the method in the second node in the present application further comprises:

transmitting a second bit block set;

herein, the second signaling comprises scheduling information of the second bit block set; the HARQ-ACK associated with the second signaling indicates whether each bit block in the second bit block set is correctly received.

In one embodiment, the first receiver also receives a second bit block set; herein, the second signaling comprises scheduling information of the second bit block; the HARQ-ACK associated with the second signaling indicates whether each bit block in the second bit block set is correctly received.

In one embodiment, the first transmitter also transmits a second bit block set; herein, the second signaling comprises scheduling information of the second bit block; the HARQ-ACK associated with the second signaling indicates whether each bit block in the second bit block set is correctly received.

In one embodiment, the second signaling is used to indicate a Semi-Persistent Scheduling (SPS) release, the HARQ-ACK associated with the second signaling indicating whether the second signaling is correctly received.

In one embodiment, the second bit block set comprises a positive integer number of Transport Block(s) (TB(s)).

In one embodiment, the second bit block set comprises one TB.

In one embodiment, the second bit block set comprises a positive integer number of CBG(s).

In one embodiment, the second bit block set comprises a positive integer number of bit(s).

In one embodiment, the scheduling information of the second bit block set comprises: at least one of time-domain resources occupied, frequency-domain resources occupied, a Modulation and Coding Scheme (MCS), configuration information of DeModulation Reference Signals (DMRS), a Hybrid Automatic Repeat reQuest (HARQ) process number, a Redundancy Version (RV), a New Data Indicator (NDI), a transmission antenna port, or a corresponding Transmission Configuration Indicator (TCI) state.

In one subembodiment, the configuration information of DMRS comprises at least one of a Reference Signal (RS) sequence, a mapping mode, a DMRS type, time-domain resources being occupied, frequency-domain resources being occupied, code-domain resources being occupied, a cyclic shift, or an Orthogonal Cover Code (OCC).

In one embodiment, the HARQ-ACK associated with the second signaling comprises an ACK.

In one embodiment, the HARQ-ACK associated with the second signaling comprises a NACK.

In one embodiment, the HARQ-ACK associated with the second signaling comprises an ACK or a NACK.

In one embodiment, the HARQ-ACK associated with the second signaling indicates whether each bit block in a bit block set scheduled by the second signaling is correctly received.

In one embodiment, the second signaling comprises a signaling used for scheduling a downlink physical layer data channel, the HARQ-ACK associated with the second signaling indicating whether a transmission of a downlink physical layer data channel scheduled by the second signaling is correctly received.

In one embodiment, the second signaling comprises a signaling used for scheduling a PDSCH, the HARQ-ACK associated with the second signaling indicating whether a transmission of a PDSCH scheduled by the second signaling is correctly received.

In one embodiment, the HARQ-ACK associated with the second signaling indicates whether the second signaling is correctly received.

In one embodiment, the second signaling comprises a signaling used for indicating an SPS release, the HARQ-ACK associated with the second signaling indicating whether the second signaling is correctly received.

In one embodiment, the method in the first node in the present application further comprises:

receiving a third bit block set;

herein, the third signaling comprises scheduling information of the third bit block set; the HARQ-ACK associated with the third signaling indicates whether each bit block in the third bit block set is correctly received.

In one embodiment, the method in the second node in the present application further comprises:

transmitting a third bit block set;

herein, the third signaling comprises scheduling information of the third bit block set; the HARQ-ACK associated with the third signaling indicates whether each bit block in the third bit block set is correctly received.

In one embodiment, the first node in the present application also receives a third bit block set;

herein, the third signaling comprises scheduling information of the third bit block; the HARQ-ACK associated with the third signaling indicates whether each bit block in the third bit block set is correctly received.

In one embodiment, the second node in the present application also transmits a third bit block set; herein, the third signaling comprises scheduling information of the third bit block; the HARQ-ACK associated with the third signaling indicates whether each bit block in the third bit block set is correctly received.

In one embodiment, the third signaling is used to indicate a Semi-Persistent Scheduling (SPS) release, the HARQ-ACK associated with the third signaling indicating whether the third signaling is correctly received.

In one embodiment, the third bit block set comprises a positive integer number of TB(s).

In one embodiment, the third bit block set comprises one TB.

In one embodiment, the third bit block set comprises a positive integer number of CBG(s).

In one embodiment, the third bit block set comprises a positive integer number of bit(s).

In one embodiment, the scheduling information of the third bit block set comprises at least one of time-domain resources occupied, frequency-domain resources occupied, an MCS, configuration information of DMRS, a HARQ process number, an RV, an NDI, a transmission antenna port, or a corresponding TCI state

In one subembodiment, the configuration information of DMRS comprises at least one of an RS sequence, a mapping mode, a DMRS type, time-domain resources being occupied, frequency-domain resources being occupied, code-domain resources being occupied, a cyclic shift, or an OCC.

In one embodiment, the HARQ-ACK associated with the third signaling comprises an ACK.

In one embodiment, the HARQ-ACK associated with the third signaling comprises a NACK.

In one embodiment, the HARQ-ACK associated with the third signaling comprises an ACK or a NACK.

In one embodiment, the HARQ-ACK associated with the third signaling indicates whether each bit block in a bit block set scheduled by the third signaling is correctly received.

In one embodiment, the third signaling comprises a signaling used for scheduling a downlink physical layer data channel, the HARQ-ACK associated with the third signaling indicating whether a transmission of a downlink physical layer data channel scheduled by the third signaling is correctly received.

In one embodiment, the third signaling comprises a signaling used for scheduling a PDSCH, the HARQ-ACK associated with the third signaling indicating whether a transmission of a PDSCH scheduled by the third signaling is correctly received.

In one embodiment, the HARQ-ACK associated with the third signaling indicates whether the third signaling is correctly received.

In one embodiment, the third signaling comprises a signaling used for indicating an SPS release, the HARQ-ACK associated with the third signaling indicating whether the third signaling is correctly received.

In one embodiment, the first signaling and the third signaling both comprise a fourth field, where the fourth field comprised in the first signaling indicates the first radio resource block, and the fourth field comprised in the third signaling indicates a second radio resource block.

In one subembodiment, the fourth field is a PUCCH resource indicator field, for the specific definition of the PUCCH resource indicator field, refer to 3GPP TS38.212, Section 7.3.1.2.

In one subembodiment, the fourth field comprises a positive integer number of bit(s).

In one subembodiment, the fourth field comprises 3 bits.

In one embodiment, a second radio resource block is a radio resource block in a second radio resource block set, the second radio resource block set being one of N radio resource block sets; any radio resource block set among the N radio resource block sets comprises a positive integer number of radio resource block(s), N being a positive integer greater than 1; a number of bits comprised in the second sub-information-block is used to determine the second radio resource block set from the N radio resource block sets.

In one subembodiment, the third signaling is used to indicate the second radio resource block in the second radio resource block set.

In one subembodiment, the third signaling indicates an index of the second radio resource block in the second radio resource block set.

In one subembodiment, the third signaling comprises a fourth field, the fourth field comprised in the third signaling indicating an index of the second radio resource block in the second radio resource block set.

In one embodiment, the first radio resource block and the second radio resource block both comprise a PUCCH resource.

In one embodiment, the first radio resource block and the second radio resource block are both reserved for a PUCCH.

In one embodiment, the first radio resource block is reserved for transmission of the first sub-information-block, while the second radio resource block is reserved for transmission of the second sub-information-block.

In one embodiment, the first signaling is a said first-type signaling, while the third signaling is a said second-type signaling; a first sub-information-block comprises the HARQ-ACK associated with the first signaling, the first sub-information-block belonging to the first information block; a second sub-information-block comprises the HARQ-ACK associated with the third signaling; the first signaling indicates the first radio resource block, while the third signaling indicates a second radio resource block, the first radio resource block being reserved for the first sub-information-block, and the second radio resource block being reserved for the second sub-information-block; a time unit to which the first radio resource block belongs in time domain overlaps with a time unit to which the second radio resource block belongs in time domain, the first information block comprising the second sub-information-block and the first sub-information-block.

In one embodiment, the first signaling is a said first-type signaling, while the third signaling is a said second-type signaling; a first sub-information-block comprises the HARQ-ACK associated with the first signaling, the first sub-information-block belonging to the first information block; a second sub-information-block comprises the HARQ-ACK associated with the third signaling; the first signaling indicates the first radio resource block, while the third signaling indicates a second radio resource block, the first radio resource block being reserved for the first sub-information-block, and the second radio resource block being reserved for the second sub-information-block; the first radio resource block overlaps with the second radio resource block in time domain, the first information block comprising the second sub-information-block and the first sub-information-block.

In one embodiment, the first signaling is transmitted in the first time window.

In one embodiment, the second field comprises all or part of a Downlink assignment index field, for the specific definition of the Downlink assignment index field, refer to 3GPP TS38.212, Section 7.3.1.2.

In one embodiment, a value of the second field indicates a total Downlink Assignment Index (DAI).

In one embodiment, a value of the second field in the first signaling is equal to a sum of the number of the first-type signaling(s) transmitted in the first time-frequency resource pool and the number of the second-type signaling(s) transmitted in the first time-frequency resource pool.

In one embodiment, a value of the second field in the first signaling is equal to a remainder yielded by a sum of the number of the first-type signaling(s) transmitted in the first time-frequency resource pool and the number of the second-type signaling(s) transmitted in the first time-frequency resource pool being divided by 4.

In one embodiment, a value of the second field in the first signaling is equal to a remainder yielded by a sum of the number of the first-type signaling(s) transmitted in the first time-frequency resource pool and the number of the second-type signaling(s) transmitted in the first time-frequency resource pool being divided by the X-th power of 2, where X is a positive integer.

In one embodiment, a value of the second field in the first signaling is equal to a weighted sum of the number of the first-type signaling(s) transmitted in the first time-frequency resource pool and the number of the second-type signaling(s) transmitted in the first time-frequency resource pool.

In one embodiment, the number of the first-type signaling(s) transmitted in the first time-frequency resource pool and the number of the second-type signaling(s) transmitted in the first time-frequency resource pool are respectively equal to the third value and the fourth value.

In one embodiment, the second field comprising 2 bits, a value of the second field in the first signaling is equal to a remainder yielded by a sum of the third value and the fourth value being divided by 4.

In one embodiment, a value of the second field in the first signaling is equal to a sum of the third value and the fourth value.

In one embodiment, a value of the second field in the first signaling is equal to a weighted sum of the third value and the fourth value.

In one embodiment, the second field comprising X bit(s), a value of the second field in the first signaling is equal to a remainder yielded by a sum of the third value and the fourth value being divided by the X-th power of 2, where X is a positive integer.

In one embodiment, the second signaling comprises the second field; a value of the second field in the second signaling is related to the number of the first-type signaling(s) transmitted in the first time-frequency resource pool and unrelated to the number of the second-type signaling(s) transmitted in the first time-frequency resource pool.

In one embodiment, the second signaling comprises the second field; a value of the second field in the second signaling is equal to a remainder yielded by the number of the second-type signalings transmitted in the first time-frequency resource pool being divided by 4.

In one embodiment, the second signaling comprises the second field, the second field comprising X bit(s); a value of the second field in the second signaling is equal to a remainder yielded by the number of the second-type signalings transmitted in the first time-frequency resource pool being divided by the X-th power of 2, where X is a positive integer.

In one embodiment, the third signaling comprises the second field; a value of the second field in the third signaling is related to the number of the first-type signaling(s) transmitted in the first time-frequency resource pool and unrelated to the number of the second-type signaling(s) transmitted in the first time-frequency resource pool.

In one embodiment, the third signaling comprises the second field; a value of the second field in the third signaling is equal to a remainder yielded by the number of the second-type signalings transmitted in the first time-frequency resource pool being divided by 4.

In one embodiment, the third signaling comprises the second field, the second field comprising X bit(s); a value of the second field in the third signaling is equal to a remainder yielded by the number of the second-type signalings transmitted in the first time-frequency resource pool being divided by the X-th power of 2, where X is a positive integer.

In one embodiment, the steps marked by the box F1C in FIG. 5C exist.

In one embodiment, the steps marked by the box F1C in FIG. 5C do not exist.

In one embodiment, the steps marked by the box F2C in FIG. 5C exist.

In one embodiment, the steps marked by the box F2C in FIG. 5C do not exist.

In one embodiment, the steps marked by the box F3C in FIG. 5C exist.

In one embodiment, the steps marked by the box F3C in FIG. 5C do not exist.

### Embodiment 6A

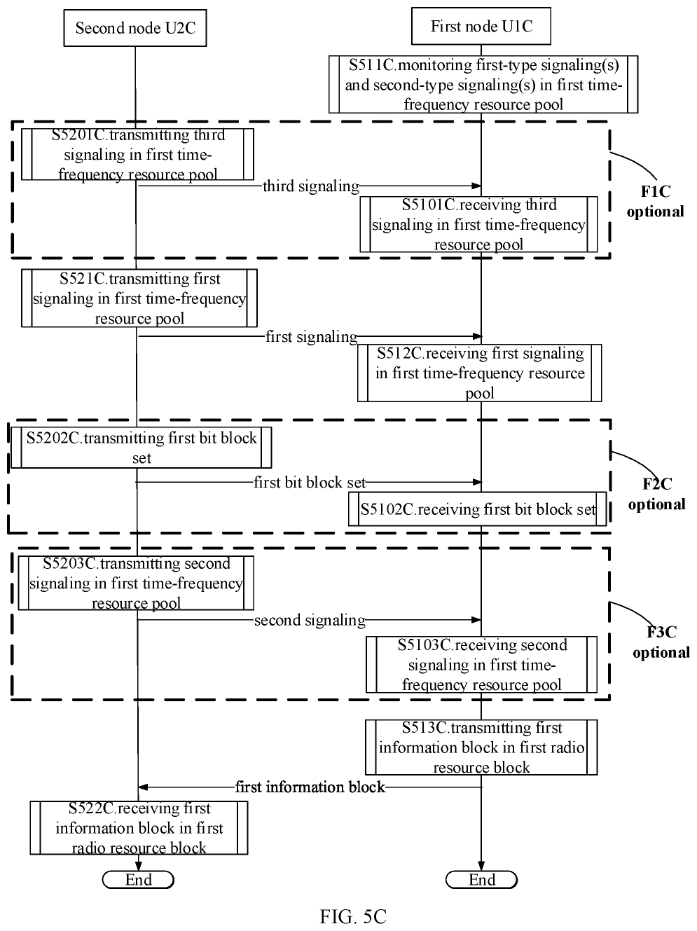

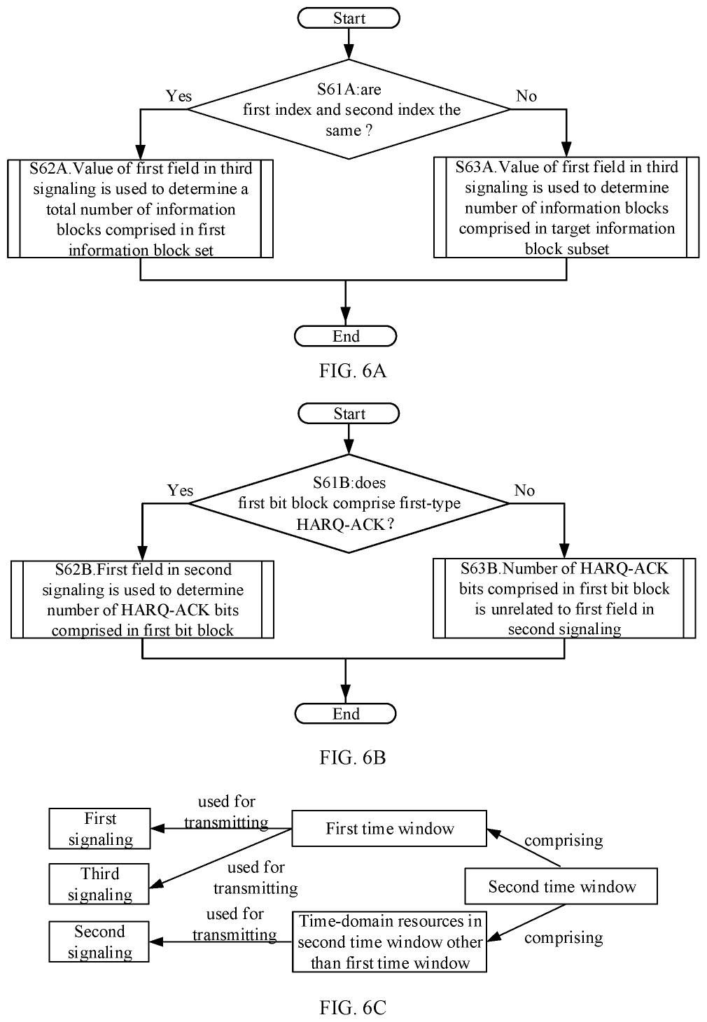

Embodiment 6A illustrates a flowchart of determining whether a value of a first field in a third signaling is used to determine a number of information blocks comprised in a target information block subset or a total number of information blocks comprised in a first information block set according to one embodiment of the present application, as shown in FIG. 6A.

In Embodiment 6A, the first node in the present application determined whether a first index and a second index are the same in step S61A; if so, move to step S62A to determine that a value of the first field in the third signaling is used to determine a total number of information blocks comprised in the first information block set; otherwise, move to step S63A to determine that a value of the first field in the third signaling is used to determine a number of information blocks comprised in the target information block subset.

In Embodiment 6A, the target information block subset is a first information block subset or a second information block subset.

In one embodiment, the first index and the second index are different; the value of the first field in the third signaling is only used to determine a number of information blocks comprised in the target information block subset.

In one embodiment, the first index and the second index are different; any field other than the first field in the third signaling is not used to determine a total number of information blocks comprised in the first information block set.

In one embodiment, the first index and the second index are different; any field other than the first field in the third signaling is not used to determine any number of information blocks other than the target information block subset comprised in the first information block set.

In one embodiment, any field other than the first field in the third signaling is not used to determine a total number of information blocks comprised in the first information block set.

In one embodiment, any field other than the first field in the third signaling is unrelated to a total number of information blocks comprised in the first information block set.

In one embodiment, the first index and the second index are different; any field other than the first field in the third signaling is not used to determine any number of information blocks other than the target information block subset comprised in the first information block set.

In one embodiment, any field other than the first field in the third signaling is not used to determine a number of information blocks comprised in the first information block subset; any field other than the first field in the third signaling is not used to determine a number of information blocks comprised in the second information block subset.

In one embodiment, any field other than the first field in the third signaling is unrelated to a number of HARQ-ACK bits comprised in the first information block set.

In one embodiment, the first signaling is used to determine a first priority, while the second signaling is used to determine a second priority, the first index corresponds to the first priority, while the second index corresponds to the second priority; when the first priority and the second priority are the same, the first index and the second index are the same; when the first priority and the second priority are different, the first index and the second index are different.

In one subembodiment, the first priority is High Priority or Low Priority; the second priority is High Priority or Low Priority.

In one embodiment, each information block in the first information block set comprises a HARQ-ACK.

In one embodiment, each information block in the first information block set comprises a positive integer number of HARQ-ACK bit(s).

In one embodiment, the first signaling indicates the first index.

In one embodiment, the first signaling indicates the second index.

In one embodiment, the first signaling is used to determine a first Service Type, while the second signaling is used to determine a second Service Type, the first index corresponds to the first Service Type, while the second index corresponds to the second Service Type; when the first Service Type and the second Service Type are the same, the first index and the second index are the same; when the first Service Type and the second Service Type are different, the first index and the second index are different.

In one subembodiment, the first Service Type is URLLC or eMBB; the second Service Type is URLLC or eMBB.

In one embodiment, the first index is a CORESETPoolIndex, and the second index is a CORESETPoolIndex.

In one subembodiment, the CORESETPoolIndex is equal to 0 or 1.

In one embodiment, the first index and the second index respectively correspond to different CORESET Pools.

In one embodiment, the first index is used to determine a transmission in the Uplink while the second index is used to determine a transmission in the Sidelink.

In one embodiment, the first signaling indicates a first priority index, while the second signaling indicates a second priority index, the first index being a first priority index, and the second index being a second priority index.

In one embodiment, the first priority index and the second priority index are both Priority Indexes.

In one subembodiment, the priority index is 0 or 1.

In one subembodiment, the priority index indicates a High Priority or a Low Priority.

In one subembodiment, the priority index indicates a URLLC Service Type or an eMBB Service Type.

In one embodiment, the third signaling indicates the third index.

In one embodiment, the first index and the second index are different; the third index is the same as an index corresponding to the target information block subset.

In one embodiment, the third index is equal to the first index or the second index.

In one embodiment, the third index is a priority index.

In one embodiment, the third signaling comprises a Priority Indicator field, the Priority Indicator field indicating a third index.

In one embodiment, the first signaling comprises a Priority Indicator field, the Priority Indicator field indicating the first index.

In one embodiment, the second signaling comprises a Priority Indicator field, the Priority Indicator field indicating the second index.

In one embodiment, the first index and the second index are the same; the value of the first field in the third signaling is involved in a process in which the first node determines a total number of information blocks comprised in the first information block set.

In one embodiment, the first index and the second index are the same; the first node performs calculation according to the value of the first field in the third signaling to determine a total number of information blocks comprised in the first information block set.

In one embodiment, the first index and the second index are the same; a number of HARQ-ACK bits comprised in the first information block set is linear with a total number of information blocks comprised in the first information block set; the value of the first field in the third signaling is used by the first node to determine a total number of information blocks comprised in the first information block set in accordance with a process described in TS38.213, Section 9.1.3.

In one embodiment, the first index and the second index are different; the value of the first field in the third signaling is involved in a process in which the first node determines a number of information blocks comprised in the target information block subset.

In one embodiment, the first index and the second index are different; the first node performs calculation according to the value of the first field in the third signaling to determine a number of information blocks comprised in the target information block subset.

In one embodiment, the first index and the second index are different; a number of HARQ-ACK bits comprised in the target information block subset is linear with a number of information blocks comprised in the target information block subset; the value of the first field in the third signaling is used by the first node to determine a number of information blocks comprised in the target information block subset in accordance with a process described in TS38.213, Section 9.1.3.

In one embodiment, the first index and the second index are the same; the first node performs a first calculation process to determine a number of HARQ-ACK bits comprised in the first information block set; the value of the first field in the third signaling is evaluated to a parameter in the first calculation process to determine a total number of information blocks comprised in the first information block set.

In one embodiment, the first index and the second index are different; the first node performs a first calculation process to determine a number of HARQ-ACK bits comprised in the target information block subset; the value of the first field in the third signaling is evaluated to a parameter in the first calculation process to determine a number of information blocks comprised in the target information block subset.

In one embodiment, the first index and the second index are the same; the first field is a DAI field in an uplink scheduling signaling, where a value of the DAI field in the third signaling is used to determine a total number of information blocks comprised in the first information block set.

In one embodiment, the first index and the second index are different; the first field is a DAI field in an uplink scheduling signaling, where a value of the DAI field in the third signaling is used to determine a number of information blocks comprised in the target information block subset.

### Embodiment 6B

Embodiment 6B illustrates a flowchart of determining whether a number of HARQ-ACK bits comprised in a first bit block is related to a first field in a second signaling according to one embodiment of the present application, as shown in FIG. 6B.

In Embodiment 6B, the first node in the present application determines whether a first bit block comprises a first-type HARQ-ACK in step S61B; if so, move to step S62B to determine that a first field in a second signaling is used to determine a number of HARQ-ACK bits comprised in the first bit block; otherwise, move to step S63B to determine that a number of HARQ-ACK bits comprised in the first bit block is unrelated to the first field in the second signaling.

In one embodiment, when the first bit block does not comprise the first-type HARQ-ACK, the first bit block comprises the second-type HARQ-ACK.

In one embodiment, the first bit block only comprises either of the first-type HARQ-ACK and the second-type HARQ-ACK.

In one embodiment, the phrase that the first field in the second signaling is used to determine a number of HARQ-ACK bits comprised in the first bit block comprises that the first node performs calculation according to the value of the first field in the second signaling to determine a number of HARQ-ACK bits comprised in the first bit block.

In one embodiment, the phrase that the first field in the second signaling is used to determine a number of HARQ-ACK bits comprised in the first bit block comprises that the value of the first field in the second signaling is involved in a process in which the first node determines a number of HARQ-ACK bits comprised in the first bit block.

In one embodiment, the phrase that the first field in the second signaling is used to determine a number of HARQ-ACK bits comprised in the first bit block comprises that the first node generates a Type-1 HARQ-ACK Codebook transmitted in the first time-frequency resource block according to a process described in TS38.213, Section 9.1.3; the first bit block comprises the Type-1 HARQ-ACK Codebook, where each HARQ-ACK bit comprised in the first bit block is a HARQ-ACK bit comprised in the Type-1 HARQ-ACK Codebook; the first field in the second signaling is a DAI field in a scheduling signaling for the first time-frequency resource block.

In one subembodiment, a value of the first field in the second signaling is given in TS38.213, Section 9.1.3.

In one subembodiment, a value of the first field in the second signaling is 0 or 1.

In one subembodiment, the first time-frequency resource block comprises a PUSCH.

In one subembodiment, the first bit block only comprises the first-type HARQ-ACK between the first-type HARQ-ACK and the second-type HARQ-ACK.

In one embodiment, the phrase that the first field in the second signaling is used to determine a number of HARQ-ACK bits comprised in the first bit block comprises: the first node generates a Type-2 HARQ-ACK Codebook transmitted in the first time-frequency resource block according to a process described in TS38.213, Section 9.1.3; the first bit block comprises the Type-2 HARQ-ACK Codebook, where each HARQ-ACK bit comprised in the first bit block is a HARQ-ACK bit comprised in the Type-2 HARQ-ACK Codebook; the first field in the second signaling is a DAI field in a scheduling signaling for the first time-frequency resource block.

In one subembodiment, a value of the first field in the second signaling is given in TS38.213, Section 9.1.3.

In one subembodiment, a value of the first field in the second signaling is one of 1, 2, 3 or 4.

In one subembodiment, the first time-frequency resource block comprises a PUSCH.

In one subembodiment, the first bit block only comprises the first-type HARQ-ACK between the first-type HARQ-ACK and the second-type HARQ-ACK.

In one embodiment, the phrase that the first field in the second signaling is used to determine a number of HARQ-ACK bits comprised in the first bit block comprises: the first node generates a TB-based Type-2 HARQ-ACK Codebook transmitted in the first time-frequency resource block according to a process described in TS38.213, Section 9.1.3; the first bit block comprises the TB-based Type-2 HARQ-ACK sub-Codebook, where each HARQ-ACK bit comprised in the first bit block is a HARQ-ACK bit comprised in the TB-based Type-2 HARQ-ACK sub-Codebook; the first field in the second signaling is a DAI field in a scheduling signaling for the first time-frequency resource block that corresponds to the TB-based Type-2 HARQ-ACK sub-Codebook.

In one subembodiment, a value of the first field in the second signaling is given in TS38.213, Section 9.1.3.

In one subembodiment, a value of the first field in the second signaling is one of 1, 2, 3 or 4.

In one subembodiment, the first time-frequency resource block comprises a PUSCH.

In one subembodiment, the first bit block only comprises the first-type HARQ-ACK between the first-type HARQ-ACK and the second-type HARQ-ACK.

In one embodiment, the phrase that a number of HARQ-ACK bits comprised in the first bit block is unrelated to the first field in the second signaling comprises that when the first bit block does not comprise the first-type HARQ-ACK, no matter how many HARQ-ACK bits are comprised in the first bit block, the first field in the second signaling indicates 0.

In one subembodiment, a value of the first field in the second signaling is equal to 4.

In one subembodiment, a value of the first field in the second signaling is equal to 8.

In one subembodiment, a value of the first field in the second signaling is equal to 16.

In one subembodiment, the first field in the second signaling indicates that the first-type HARQ-ACK is not transmitted.

In one embodiment, the phrase that a number of HARQ-ACK bits comprised in the first bit block is unrelated to the first field in the second signaling comprises that when the first bit block does not comprise the first-type HARQ-ACK, the first bit block only comprises the second-type HARQ-ACK, the first field in the second signaling not being used to determine a number of the second-type HARQ-ACK bits.

In one subembodiment, a value of the first field in the second signaling is not involved in the process in which the first node performs calculation to determine a number of the second-type HARQ-ACK bits.

In one subembodiment, throughout the process in which the first node determines a number of the second-type HARQ-ACK bits, a value of the first field in the second signaling is not used.

In one embodiment, the phrase that a number of HARQ-ACK bits comprised in the first bit block is unrelated to the first field in the second signaling comprises that when the first bit block does not comprise the first-type HARQ-ACK, a value of the first field in the second signaling has no impact on the number of HARQ-ACK bits comprised in the first bit block.

In one embodiment, the phrase that the first field in the second signaling is used to determine a number of HARQ-ACK bits comprised in the first bit block comprises that the first node performs calculation according to the value of the first field in the second signaling to determine a number of the first-type HARQ-ACK bits comprised in the first bit block.

In one embodiment, the phrase that the first field in the second signaling is used to determine a number of HARQ-ACK bits comprised in the first bit block comprises that the value of the first field in the second signaling is involved in a process in which the first node determines a number of the first-type HARQ-ACK bits comprised in the first bit block.

### Embodiment 6C

Embodiment 6C illustrates a schematic diagram of relations among a first signaling, a second signaling and a third signaling, a first time window and a second time window according to one embodiment of the present application, as shown in FIG. 6C.

In Embodiment 6C, a second time window comprises a first time window; a first signaling is transmitted within the first time window, a third signaling is transmitted within the first time window, while a second signaling is transmitted within time-domain resources in the second time window other than the first time window.

In one embodiment, the first time-frequency resource pool comprises the first time window in terms of time domain.

In one embodiment, the first time-frequency resource pool comprises the second time window in terms of time domain.

In one embodiment, the first time-frequency resource pool comprises the first time window but does not comprise time-domain resources in the second time window other than the first time window in terms of time domain.

In one embodiment, a value of the first field comprised in the second signaling is related to a number of the second-type signalings transmitted in the first time window.

In one embodiment, time-domain resources occupied by the first time-frequency resource pool is the second time window in terms of time domain.

In one embodiment, time-domain resources occupied by the first time-frequency resource pool is the first time window in terms of time domain.

In one embodiment, the second time-frequency resource is after the first time-frequency resource in terms of time domain.

In one embodiment, a third value is equal to an accumulative number of {serving cell, PDCCH monitoring occasion}-pair(s) including the second-type signaling(s), first in an ascending order of serving cell indexes and then in an ascending order of PDCCH monitoring occasion indexes, up to a current serving cell and a current PDCCH monitoring occasion in the second time window, the third value being used to determine the first field in the second signaling.

In one subembodiment, the first field in the second signaling is equal to the third value.

In one subembodiment, the first field comprising 2 bits, a value of the first field in the second signaling is equal to a remainder yielded by the third value being divided by 4.

In one subembodiment, the first field comprising X bit(s), a value of the first field in the second signaling is equal to a remainder yielded by the third value being divided by the X-th power of 2, where X is a positive integer.

In one embodiment, a value of the first field comprised in the second signaling is unrelated to a number of the first-type signaling(s) transmitted in the first time-frequency resource pool.

In one embodiment, a value of the first field comprised in the second signaling is smaller than a number of the second-type signalings transmitted in the first time-frequency resource pool.

In one embodiment, a value of the first field comprised in the second signaling is equal to a number of the second-type signalings transmitted in the first time-frequency resource pool.

In one embodiment, the first node in the present application transmits a second information block in a third radio resource block, the second information block comprising HARQ-ACK associated with the second signaling; the third radio resource block and the first radio resource block are non-overlapping in time domain.

In one subembodiment, the third radio resource block comprises a PUCCH.

In one subembodiment, the third radio resource block comprises a PUSCH.

In one embodiment, the first signaling indicates the first radio resource block; the second signaling indicates a third radio resource block; when the third radio resource block and the first radio resource block are non-overlapping in time domain, the first node in the present application transmits a second information block in the third radio resource block, the second information block comprising HARQ-ACK associated with the second signaling; when the third radio resource block and the first radio resource block are overlapping in time domain, the first node in the present application drops transmitting HARQ-ACK information associated with the second signaling.

In one embodiment, the second signaling and the first signaling both indicate a first time-domain resource.

In one subembodiment, the first time-domain resource is a time-domain resource indicated by a PDSCH-to-HARQ_feedback timing indicator field, for the specific definition of the PDSCH-to-HARQ_feedback timing indicator field, refer to 3GPP TS38.212, Section 7.3.1.2.

In one subembodiment, the first time-domain resource comprises a time-domain resource unit.

In one subembodiment, the first time-domain resource comprises a slot.

In one subembodiment, the first time-domain resource comprises a sub-slot.

In one subembodiment, the first time-domain resource is a slot.

In one subembodiment, the first time-domain resource is a sub-slot.

In one embodiment, the third signaling and the first signaling both indicate a first time-domain resource.

In one subembodiment, the first time-domain resource is a time-domain resource indicated by a PDSCH-to-HARQ_feedback timing indicator field, for the specific definition of the PDSCH-to-HARQ_feedback timing indicator field, refer to 3GPP TS38.212, Section 7.3.1.2.

In one subembodiment, the first time-domain resource comprises a time-domain resource unit.

In one subembodiment, the first time-domain resource comprises a slot.

In one subembodiment, the first time-domain resource comprises a sub-slot.

In one subembodiment, the first time-domain resource is a slot.

In one subembodiment, the first time-domain resource is a sub-slot.

### Embodiment 7A

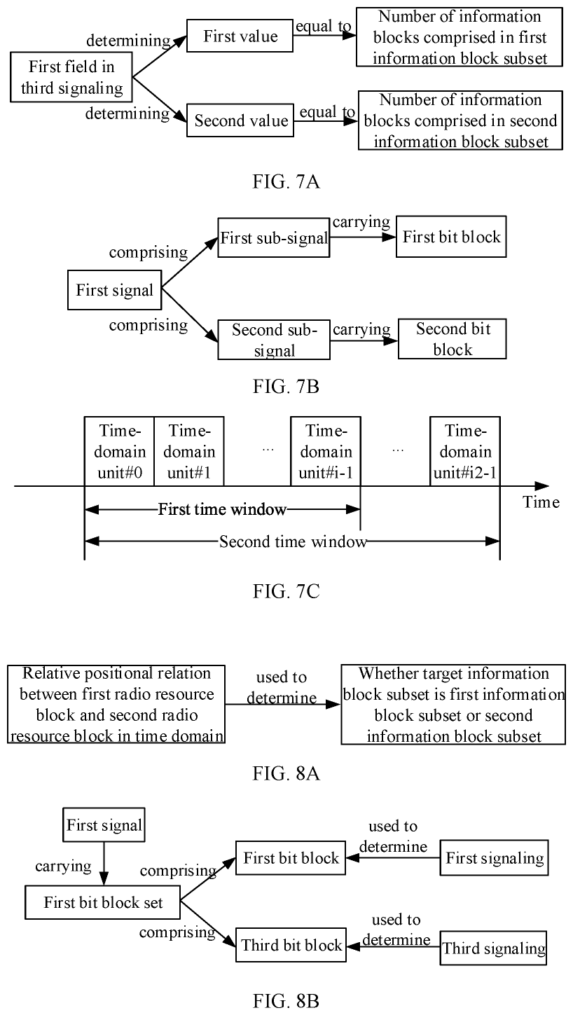

Embodiment 7A illustrates a schematic diagram of relations among a first field, a first value and a second value, a number of information blocks comprised in a first information block subset and a number of information blocks comprised in a second information block subset according to one embodiment of the present application, as shown in FIG. 7A.

In Embodiment 7A, a value of a first field in a third signaling is used to determine a first value and a second value, the first value being equal to a number of information blocks comprised in a first information block subset, and the second value being equal to a number of information blocks comprised in a second information block subset.

In Embodiment 7A, a total number of information blocks comprised in the first information block set in the present application is equal to a sum of the first value and the second value.

In Embodiment 7A, the first index in the present application is different from the second index in the present application.

In one embodiment, the first value is equal to the second value.

In one embodiment, the first value is unequal to the second value.

In one embodiment, the value of the first field in the third signaling is involved in a process in which the first node in the present application determines the first value.

In one embodiment, the first node in the present application performs calculation according to the value of the first field in the third signaling to determine the first value.

In one embodiment, the value of the first field in the third signaling is involved in a process in which the first node in the present application determines the second value.

In one embodiment, the first node in the present application performs calculation according to the value of the first field in the third signaling to determine the second value.

In one embodiment, the first index and the second index are different; the first node in the present application performs a first calculation process to determine a number of HARQ-ACK bits comprised in the first information block subset; the value of the first field in the third signaling is evaluated to a parameter in the first calculation process to determine a number of information blocks comprised in the first information block subset.

In one embodiment, the first index and the second index are different; the first node in the present application performs a first calculation process to determine a number of HARQ-ACK bits comprised in the second information block subset; the value of the first field in the third signaling is evaluated to a parameter in the first calculation process to determine a number of information blocks comprised in the second information block subset.

### Embodiment 7B

Embodiment 7B illustrates a schematic diagram of relations among a first signal, a first sub-signal and a second sub-signal, a first bit block and a second bit block according to one embodiment of the present application, as shown in FIG. 7B.

In Embodiment 7B, the first signal comprises a first sub-signal and a second sub-signal; the first sub-signal carries a first bit block, while the second sub-signal carries a second bit block.

In one embodiment, the second bit block comprises user service data.

In one embodiment, the second bit block comprises a CSI report.

In one embodiment, the second bit block comprises an aperiodic CSI report.

In one embodiment, the second bit block does not comprise a HARQ-ACK.

In one embodiment, the second bit block comprises a Transport Block (TB).

In one embodiment, the second bit block comprises two TBs.

In one embodiment, the second bit block comprises a Code Block Group (CBG).

In one embodiment, the second bit block comprises multiple CBGs.

In one embodiment, the first signal comprises a first sub-signal; the first sub-signal is an output by all or part of bits in the first bit block sequentially through some or all of CRC Insertion, Segmentation, Code Block (CB)-level CRC Insertion, Channel Coding, Rate Matching, Concatenation, Scrambling, Modulation, Layer Mapping, Precoding, Mapping to Resource Element, Multicarrier Symbol Generation, and Modulation and Upconversion.

In one embodiment, the first signal comprises a second sub-signal; the second sub-signal is an output by all or partial bits in the second bit block sequentially through some or all of CRC Attachment, Segmentation, Ce-block-level CRC Attachment, Channel Coding, Rate Matching, and Concatenation, Scrambling, Modulation, Layer Mapping, Precoding, Mapping to Resource Elements, Multicarrier Symbol Generation, as well as Modulation and Upconversion.

In one embodiment, the first node in the present application determines a number of bits comprised in the second bit block based on time-frequency resources comprised in the first time-frequency resource block according to the process described in TS38.214, Section 6.1.4.2.

In one embodiment, the category of the second bit block is used together with whether the first bit block comprises the first-type HARQ-ACK to determine whether a number of HARQ-ACK bits comprised in the first bit block is related to the first field in the second signaling.

In one embodiment, the second bit block is one of a first-type bit block or a second-type bit block; the first-type bit block and the second-type bit block are two types of bit blocks.

In one subembodiment, the first-type bit block is a bit block with a first priority, while the second-type bit block is a bit block with a second priority; the first priority is different from the second priority, and both the first priority and the second priority are physical-layer priorities.

In one subembodiment, the first-type bit block is a bit block with a first priority, while the second-type bit block is a bit block with a second priority; the first priority is different from the second priority, and each of the first priority and the second priority is either of a High Priority and a Low Priority.

In one subembodiment, each of the first-type bit block and the second-type bit block is one of a URLLC Service Type bit block or an eMBB Service Type bit block.

In one subembodiment, each of the first-type bit block and the second-type bit block is one of an Uplink bit block or a Sidelink bit block.

In one subembodiment, the first-type bit block corresponds to a first index, while the second-type bit block corresponds to a second index, the first index being different from the second index.

In one embodiment, the second signaling indicates whether the second bit block is a first-type bit block or a second-type bit block.

In one subembodiment, a Priority Indicator field in the second signaling indicates whether the second bit block is the first-type bit block or the second-type bit block.

In one subembodiment, the first-type bit block and the second-type bit block are respectively bit blocks with different priorities.

In one embodiment, a type of the second bit block is the same as a type of the first-type HARQ-ACK; when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

In one embodiment, the phrase that a type of the second bit block is the same as a type of the first-type HARQ-ACK comprises that the second bit block and the first-type HARQ-ACK have a same priority.

In one embodiment, the phrase that a type of the second bit block is the same as a type of the first-type HARQ-ACK comprises that a Priority Index corresponding to the second bit block and a Priority Index corresponding to the first-type HARQ-ACK are the same.

In one embodiment, the phrase that a type of the second bit block is the same as a type of the first-type HARQ-ACK comprises that the second bit block is a URLLC Service Type bit block, while the first-type HARQ-ACK is a URLLC Service Type HARQ-ACK.

In one embodiment, the phrase that a type of the second bit block is the same as a type of the first-type HARQ-ACK comprises that the second bit block is an eMBB Service Type bit block, while the first-type HARQ-ACK is an eMBB Service Type HARQ-ACK.

In one embodiment, the phrase that a type of the second bit block is the same as a type of the first-type HARQ-ACK comprises that the second bit block is an Uplink bit block, while the first-type HARQ-ACK is an Uplink HARQ-ACK.

In one embodiment, the phrase that a type of the second bit block is the same as a type of the first-type HARQ-ACK comprises that the second bit block is a Sidelink bit block, while the first-type HARQ-ACK is a Sidelink HARQ-ACK.

In one embodiment, a type of the second bit block is different from a type of the first-type HARQ-ACK; when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

In one embodiment, the phrase that a type of the second bit block is different from a type of the first-type HARQ-ACK comprises that the second bit block and the first-type HARQ-ACK have different priorities.

In one embodiment, the phrase that a type of the second bit block is different from a type of the first-type HARQ-ACK comprises that a Priority Index corresponding to the second bit block and a Priority Index corresponding to the first-type HARQ-ACK are different.

In one embodiment, the phrase that a type of the second bit block is different from a type of the first-type HARQ-ACK comprises that the second bit block is a URLLC Service Type bit block, while the first-type HARQ-ACK is an eMBB Service Type HARQ-ACK.

In one embodiment, the phrase that a type of the second bit block is different from a type of the first-type HARQ-ACK comprises that the second bit block is an eMBB Service Type bit block, while the first-type HARQ-ACK is a URLLC Service Type HARQ-ACK.

In one embodiment, the phrase that a type of the second bit block is different from a type of the first-type HARQ-ACK comprises that the second bit block is an Uplink bit block, while the first-type HARQ-ACK is a Sidelink HARQ-ACK.

In one embodiment, the phrase that a type of the second bit block is different from a type of the first-type HARQ-ACK comprises that the second bit block is a Sidelink bit block, while the first-type HARQ-ACK is an Uplink HARQ-ACK.

### Embodiment 7C

Embodiment 7C illustrates a schematic diagram of a first time window and a second time window according to one embodiment of the present application, as shown in FIG. 7C.

In Embodiment 7C, a first time window consists of i1 time-domain units, i1 being a positive integer, and any of the i1 time-domain units comprising a positive integer number of multicarrier symbol(s); a second time window consists of i2 time-domain units, i2 being a positive integer, and any of the i2 time-domain units comprising a positive integer number of multicarrier symbol(s); the second time window comprises the first time window.

In one embodiment, the i2 time-domain units include the i1 time-domain units.

In one embodiment, the time-domain unit is a slot.

In one embodiment, the time-domain unit is a sub-slot.

In one embodiment, i2 is greater than i1.

In one embodiment, i2 is equal to i1.

In one embodiment, the i1 time-domain units include at least one search space.

In one embodiment, the i1 time-domain units include at least one Coreset.

In one embodiment, there are two time-domain units among the i1 time-domain units occupying time-domain resources that are not contiguous.

In one embodiment, there are two time-domain units among the i2 time-domain units occupying time-domain resources that are not contiguous.

In one embodiment, time-domain resources occupied by the i1 time-domain units are contiguous.

In one embodiment, time-domain resources occupied by the i2 time-domain units are contiguous.

### Embodiment 8A

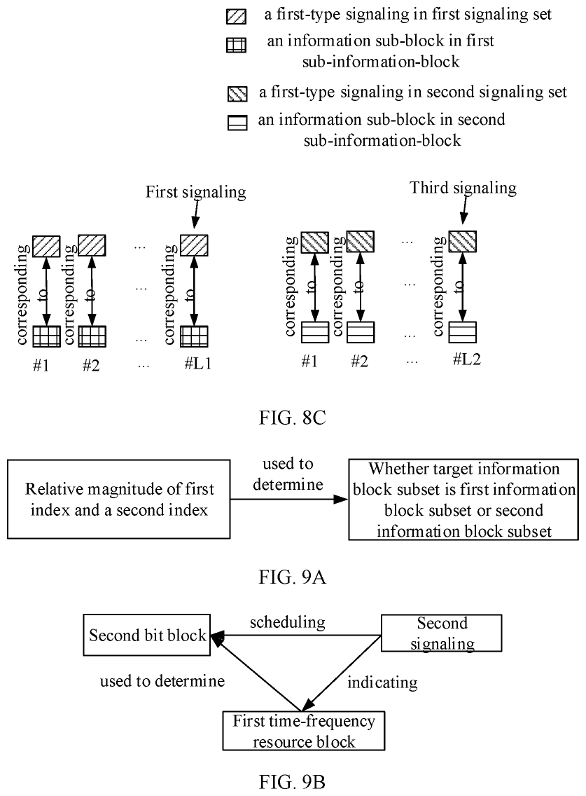

Embodiment 8A illustrates a schematic diagram of how a relative positional relation between a first radio resource block and a second radio resource block in time domain relates to a target information block subset according to one embodiment of the present application, as shown in FIG. 8A.

In Embodiment 8A, a relative positional relation between a first radio resource block and a second radio resource block in time domain is used to determine the target information block subset between a first information block subset and a second information block subset.

In one embodiment, the second radio resource block and the target time-frequency resource block are overlapping in time domain, while the first radio resource block and the target time-frequency resource block are overlapping in time domain.

In one embodiment, the first radio resource block is reserved for the first information block subset.

In one embodiment, the second radio resource block is reserved for the second information block subset.

In one embodiment, the first radio resource block comprises a Physical Uplink Control CHannel (PUCCH).

In one embodiment, the second radio resource block comprises a PUCCH.

In one embodiment, the first radio resource block comprises a slot-based or sub-slot-based PUCCH, and the second radio resource block comprises a slot-based or sub-slot-based PUCCH.

In one embodiment, the first signaling is used to indicate a first radio resource block, while the second signaling is used to indicate a second radio resource block, a first time unit comprising time-domain resources occupied by the first radio resource block, while a second time unit comprising time-domain resources occupied by the second radio resource block, the first index corresponding to the first time unit, while the second index corresponding to the second time unit; when the first time unit and the second time unit are the same, the first index and the second index are the same; when the first time unit and the second time unit are different, the first index and the second index are different.

In one subembodiment, the phrase that the first time unit and the second time unit are different comprises that the first time unit and the second time unit are respectively different sub-slots.

In one subembodiment, the phrase that the first time unit and the second time unit are different comprises that the first time unit is a slot, while the second time unit is a sub-slot.

In one subembodiment, the phrase that the first time unit and the second time unit are different comprises that the first time unit is a sub-slot, while the second time unit is a slot.

In one subembodiment, the phrase that the first time unit and the second time unit are the same comprises that the first time unit and the second time unit are a same sub-slot.

In one subembodiment, the phrase that the first time unit and the second time unit are the same comprises that the first time unit and the second time unit are a same slot.

In one embodiment, the first radio resource block is earlier than the second radio resource block in time domain, the target information block subset being the first information block subset.

In one embodiment, the phrase that the first radio resource block is earlier than the second radio resource block in time domain includes that a start time of the first radio resource block is earlier than a start time of the second radio resource block in time domain.

In one embodiment, the phrase that the first radio resource block is earlier than the second radio resource block in time domain includes that an end time of the first radio resource block is earlier than an end time of the second radio resource block in time domain.

In one embodiment, the phrase that the first radio resource block is earlier than the second radio resource block in time domain includes that an end time of the first radio resource block is earlier than a start time of the second radio resource block in time domain.

In one embodiment, the first radio resource block is no later than the second radio resource block in time domain, the target information block subset being the first information block subset.

In one embodiment, the phrase that the first radio resource block is no later than the second radio resource block in time domain includes that a start time of the first radio resource block is no later than a start time of the second radio resource block in time domain.

In one embodiment, the phrase that the first radio resource block is no later than the second radio resource block in time domain includes that an end time of the first radio resource block is no later than an end time of the second radio resource block in time domain.

In one embodiment, the phrase that the first radio resource block is no later than the second radio resource block in time domain includes that an end time of the first radio resource block is no later than a start time of the second radio resource block in time domain.

In one embodiment, the first radio resource block is later than the second radio resource block in time domain, the target information block subset being the second information block subset.

In one embodiment, the phrase that the first radio resource block is later than the second radio resource block in time domain includes that a start time of the first radio resource block is later than a start time of the second radio resource block in time domain.

In one embodiment, the phrase that the first radio resource block is later than the second radio resource block in time domain includes that an end time of the first radio resource block is later than an end time of the second radio resource block in time domain.

In one embodiment, the phrase that the first radio resource block is later than the second radio resource block in time domain includes that an end time of the second radio resource block is no later than a start time of the first radio resource block in time domain.

In one embodiment, the first radio resource block is no later than the second radio resource block in time domain, the target information block subset being the second information block subset.

In one embodiment, the first radio resource block is later than the second radio resource block in time domain, the target information block subset being the first information block subset.

In one embodiment, the first radio resource block is earlier than the second radio resource block in time domain, the target information block subset being the second information block subset.

In one embodiment, the first radio resource block comprises a positive integer number of RE(s).

In one embodiment, the first radio resource block comprises a positive integer number of subcarrier(s) in frequency domain.

In one embodiment, the first radio resource block comprises a positive integer number of PRB(s) in frequency domain.

In one embodiment, the first radio resource block comprises a positive integer number of RB(s) in frequency domain.

In one embodiment, the first radio resource block comprises a positive integer number of multicarrier symbol(s) in time domain.

In one embodiment, the first radio resource block comprises a positive integer number of slot(s) in time domain.

In one embodiment, the first radio resource block comprises a positive integer number of sub-slot(s) in time domain.

In one embodiment, the first radio resource block comprises a positive integer number of sub-millisecond(s) in time domain.

In one embodiment, the first radio resource block comprises a positive integer number of non-consecutive slots in time domain.

In one embodiment, the first radio resource block comprises a positive integer number of consecutive slots in time domain.

In one embodiment, the first radio resource block comprises a positive integer number of sub-frame(s) in time domain.

In one embodiment, the first radio resource block is configured by a higher layer signaling.

In one embodiment, the first radio resource block is configured by an RRC signaling.

In one embodiment, the first radio resource block is configured by a MAC CE signaling.

In one embodiment, the second radio resource block comprises a positive integer number of RE(s).

In one embodiment, the second radio resource block comprises a positive integer number of subcarrier(s) in frequency domain.

In one embodiment, the second radio resource block comprises a positive integer number of PRB(s) in frequency domain.

In one embodiment, the second radio resource block comprises a positive integer number of RB(s) in frequency domain.

In one embodiment, the second radio resource block comprises a positive integer number of multicarrier symbol(s) in time domain.

In one embodiment, the second radio resource block comprises a positive integer number of slot(s) in time domain.

In one embodiment, the second radio resource block comprises a positive integer number of sub-slot(s) in time domain.

In one embodiment, the second radio resource block comprises a positive integer number of sub-millisecond(s) in time domain.

In one embodiment, the second radio resource block comprises a positive integer number of non-consecutive slots in time domain.

In one embodiment, the second radio resource block comprises a positive integer number of consecutive slots in time domain.

In one embodiment, the second radio resource block comprises a positive integer number of sub-frame(s) in time domain.

In one embodiment, the second radio resource block is configured by a higher layer signaling.

In one embodiment, the second radio resource block is configured by an RRC signaling.

In one embodiment, the second radio resource block is configured by a MAC CE signaling.

### Embodiment 8B

Embodiment 8B illustrates a schematic diagram of relations among a first signal, a first bit block set, a first signaling and a third signaling, a first bit block and a third bit block according to one embodiment of the present application, as shown in FIG. 8B.

In Embodiment 8B, a first signal carries a first bit block set; the first bit block set comprises a first bit block and a third bit block; the first signaling is used to determine the first bit block, and the third signaling is used to determine the third bit block.

In one embodiment, the third signaling is dynamically configured.

In one embodiment, the third signaling is a physical layer signaling.

In one embodiment, the third signaling is a higher layer signaling.

In one embodiment, the third signaling is a downlink scheduling signaling.

In one embodiment, the third signaling is a DCI signaling.

In one embodiment, the third signaling comprises one or more fields in a DCI.

In one embodiment, the third signaling is transmitted in a downlink physical layer control channel (i.e., a downlink channel only capable of bearing physical layer signaling).

In one embodiment, the third signaling is DCI format 1_0, for the specific definition of the DCI format 1_0, refer to 3GPP TS38.212, Chapter 7.3.1.2.

In one embodiment, the third signaling is DCI format 1_1, for the specific definition of the DCI format 1_1, refer to 3GPP TS38.212, Chapter 7.3.1.2.

In one embodiment, the third signaling is DCI format 1_2, for the specific definition of the DCI format 1_2, refer to 3GPP TS38.212, Chapter 7.3.1.2.

In one embodiment, the third signaling comprises a signaling used for indicating a Semi-Persistent Scheduling (SPS) release.

In one embodiment, the third signaling comprises a signaling used for indicating configuration information of a downlink physical layer data channel.

In one embodiment, the third signaling comprises a signaling used for indicating configuration information of a PDSCH.

In one embodiment, the third signaling comprises a signaling used for scheduling a downlink physical layer data channel.

In one embodiment, the third signaling comprises a signaling used for scheduling a PDSCH.

In one embodiment, the first bit block set comprises multiple HARQ-ACK bits.

In one embodiment, the third signaling indicates an SPS release, the third bit block comprising a HARQ-ACK bit in response to the third signaling.

In one embodiment, the first node in the present application also receives a fourth signal; herein, the third signaling is used for indicating scheduling information of the fourth signal, the third bit block comprising a HARQ-ACK bit for the fourth signal.

In one embodiment, the first bit block only comprises the first-type HARQ-ACK between the first-type HARQ-ACK and the second-type HARQ-ACK; the third bit block only comprises the second-type HARQ-ACK between the first-type HARQ-ACK and the second-type HARQ-ACK; the first field in the second signaling is used to determine a number of HARQ-ACK bits comprised in the first bit block.

In one embodiment, the first bit block only comprises the second-type HARQ-ACK between the first-type HARQ-ACK and the second-type HARQ-ACK; the third bit block only comprises the first-type HARQ-ACK between the first-type HARQ-ACK and the second-type HARQ-ACK; a number of HARQ-ACK bits comprised in the first bit block is unrelated to the first field in the second signaling, the first field in the second signaling being used to determine a number of HARQ-ACK bits comprised in the third bit block.

In one subembodiment, the phrase that the first field in the second signaling is used to determine a number of HARQ-ACK bits comprised in the third bit block comprises that the first node in the present application performs calculation according to the value of the first field in the second signaling to determine a number of HARQ-ACK bits comprised in the third bit block.

In one subembodiment, the phrase that the first field in the second signaling is used to determine a number of HARQ-ACK bits comprised in the third bit block comprises that the value of the first field in the second signaling is involved in a process in which the first node in the present application determines a number of HARQ-ACK bits comprised in the third bit block.

In one subembodiment, the first bit block comprises at least one of HARQ-ACK for a Semi-Persistent Scheduling (SPS) release or HARQ-ACK for a TB-based channel reception; the first bit block does not comprise HARQ-ACK for a Code Block Group-based (CBG-based) channel reception; the third bit block comprises at least one of HARQ-ACK for a Semi-Persistent Scheduling (SPS) release or HARQ-ACK for a TB-based channel reception; the third bit block does not comprise HARQ-ACK for a CBG-based channel reception.

### Embodiment 8C

Embodiment 8C illustrates a schematic diagram of relations among a first signaling, a third signaling, a first signaling set and a second signaling set, a first sub-information-block and a second sub-information-block according to one embodiment of the present application, as shown in FIG. 8C.

In Embodiment 8C, a first signaling set consists of L1 first-type signalings detected in the first time-frequency resource pool in the present application, with the first signaling in the present application being a last first-type signaling in the first signaling set, L1 being a positive integer greater than 1; a first sub-information-block comprises L1 information sub-blocks, the L1 first-type signalings respectively corresponding to the L1 information sub-blocks, the L1 information sub-blocks respectively comprising HARQ-ACKs respectively associated with corresponding first-type signalings; a second signaling set consists of L2 second-type signalings detected in the first time-frequency resource pool, with the third signaling in the present application being a last second-type signaling in the second signaling set, L2 being a positive integer greater than 1; a second sub-information-block comprises L2 information sub-blocks, the L2 second-type signalings respectively corresponding to the L2 information sub-blocks, the L2 information sub-blocks respectively comprising HARQ-ACKs respectively associated with corresponding second-type signalings.

In one embodiment, the phrase of the first signaling being later than a first-type signaling in the first signaling set comprises that the first signaling is a last first-type signaling in the first signaling set.

In one embodiment, the phrase of the first signaling being later than a first-type signaling in the first signaling set comprises that a Monitoring Occasion of the first signaling is later than a Monitoring Occasion of a first-type signaling in the first signaling set.

In one embodiment, the phrase of the first signaling being later than a first-type signaling in the first signaling set comprises that a Monitoring Occasion of the first signaling is the same as a Monitoring Occasion of a first-type signaling in the first signaling set, and that a Serving Cell Index of the first signaling is greater than a Serving Cell Index of a first-type signaling in the first signaling set.

In one embodiment, a value of the first field comprised in the first signaling indicates a sum of L1 and L2.

In one embodiment, a value of the first field comprised in the first signaling indicates a positive integer no less than a sum of L1 and L2.

In one embodiment, a value of the first field comprised in the third signaling indicates L2.

In one embodiment, a value of the first field comprised in the third signaling indicates a positive integer no less than L2.

In one embodiment, a given information sub-block is any information sub-block among the L1 information sub-blocks, and a given signaling is a first-type signaling corresponding to the given information sub-block among the L1 first-type signalings, the given information sub-block comprising HARQ-ACK associated with the given signaling.

In one subembodiment, the given information sub-block comprises UCI.

In one subembodiment, the given information sub-block only comprises a HARQ-ACK.

In one subembodiment, the given information sub-block comprises a HARQ-ACK and CSI.

In one subembodiment, the given information sub-block comprises a HARQ-ACK and an SR.

In one subembodiment, the given information sub-block comprises a HARQ-ACK, CSI and an SR.

In one subembodiment, the HARQ-ACK associated with the given signaling comprises an ACK.

In one subembodiment, the HARQ-ACK associated with the given signaling comprises a NACK.

In one subembodiment, the HARQ-ACK associated with the given signaling comprises an ACK or a NACK.

In one subembodiment, the HARQ-ACK associated with the given signaling indicates whether each bit block in a bit block set scheduled by the given signaling is correctly received.

In one subembodiment, the given signaling comprises a signaling used for scheduling a downlink physical layer data channel, the HARQ-ACK associated with the given signaling indicating whether a transmission of a downlink physical layer data channel scheduled by the given signaling is correctly received.

In one subembodiment, the given signaling comprises a signaling used for scheduling a PDSCH, the HARQ-ACK associated with the given signaling indicating whether a transmission of a PDSCH scheduled by the given signaling is correctly received.

In one subembodiment, the HARQ-ACK associated with the given signaling indicates whether the given signaling is correctly received.

In one subembodiment, the given signaling comprises a signaling used to indicate a Semi-Persistent Scheduling (SPS) release, the HARQ-ACK associated with the given signaling indicating whether the given signaling is correctly received.

In one subembodiment, the method in the first node in the present application further comprises:

receiving a given bit block set;

herein, the given signaling comprises scheduling information of the given bit block set; the HARQ-ACK associated with the given signaling indicates whether each bit block in the given bit block set is correctly received.

In one subembodiment, the method in the second node in the present application further comprises:

transmitting a given bit block set;

herein, the given signaling comprises scheduling information of the given bit block set; the HARQ-ACK associated with the given signaling indicates whether each bit block in the given bit block set is correctly received.

In one subembodiment, the first receiver also receives a given bit block set; herein, the given signaling comprises scheduling information of the given bit block set; the HARQ-ACK associated with the given signaling indicates whether each bit block in the given bit block set is correctly received.

In one subembodiment, the second transmitter also transmits a given bit block set; herein, the given signaling comprises scheduling information of the given bit block set; the HARQ-ACK associated with the given signaling indicates whether each bit block in the given bit block set is correctly received.

In one subembodiment, the given signaling is used to indicate a Semi-Persistent Scheduling (SPS) release, the HARQ-ACK associated with the given signaling indicating whether the given signaling is correctly received.

In one embodiment, the statement that the first signaling is a last first-type signaling in the first signaling set means that by arranging L1 first-type signalings in the first signaling set according to a first rule, the first signaling is a first-type signaling that ranks last in the first signaling set; the statement that the third signaling is a last second-type signaling in the second signaling set means that by arranging L2 second-type signalings in the second signaling set according to the first rule, the third signaling is a second-type signaling that ranks last in the second signaling set.

In one subembodiment, the first rule is related to frequency-domain resources being occupied and time-domain resources being occupied.

In one subembodiment, the first rule is related to a carrier it belongs to and monitoring occasions.

In one subembodiment, the first rule is related to serving cells and monitoring occasions.

In one subembodiment, the first rule comprises: arranging firstly in an ascending order of serving cell indexes within a same monitoring occasion and then in an ascending order of monitoring occasion indexes.

In one embodiment, the statement that the first signaling is a last first-type signaling in the first signaling set means that by indexing L1 first-type signalings in the first signaling set according to a second rule, the first signaling is a first-type signaling with a largest index in the first signaling set; the statement that the third signaling is a last second-type signaling in the second signaling set means that by indexing L2 second-type signalings in the second signaling set according to the second rule, the third signaling is a second-type signaling with a largest index in the second signaling set.

In one subembodiment, the second rule is related to frequency-domain resources being occupied and time-domain resources being occupied.

In one subembodiment, the second rule is related to a carrier it belongs to and monitoring occasions.

In one subembodiment, the second rule is related to serving cells and monitoring occasions.

In one subembodiment, the second rule comprises: indexing firstly in an ascending order of serving cell indexes within a same monitoring occasion and then in an ascending order of monitoring occasion indexes.

### Embodiment 9A

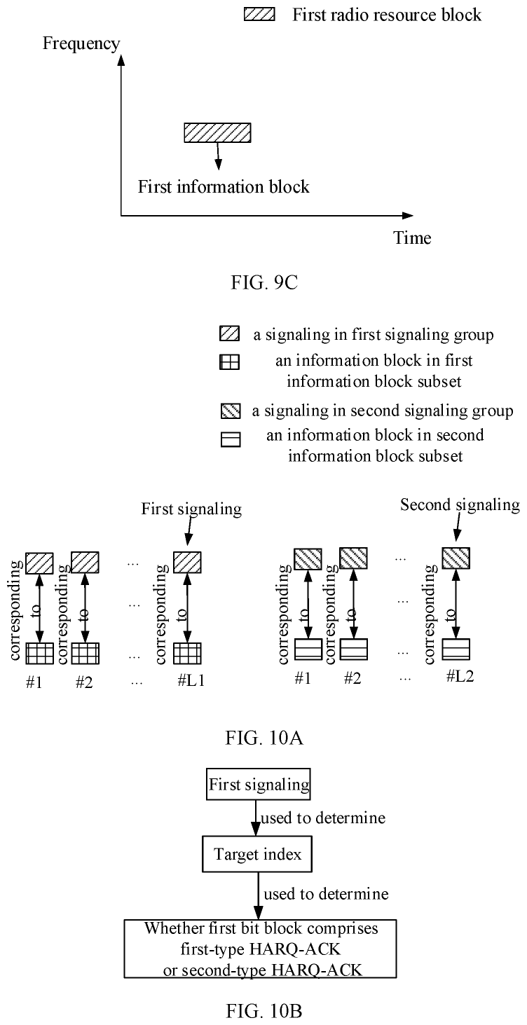

Embodiment 9A illustrates a schematic diagram of how a relative magnitude of a first index and a second index relates to a target information block subset according to one embodiment of the present application, as shown in FIG. 9A.

In Embodiment 9A, a relative magnitude of a first index and a second index is used to determine the target information block subset between a first information block subset and a second information block subset.

In one embodiment, when the first index is greater than the second index, the target information block subset is the first information block subset; when the first index is smaller than the second index, the target information block subset is the second information block subset.

In one embodiment, when the first index is smaller than the second index, the target information block subset is the first information block subset; when the first index is greater than the second index, the target information block subset is the second information block subset.

In one embodiment, the phrase that the first index is greater than the second index comprises that the first index is a Larger Priority Index; the second index is a Smaller Priority Index.

In one embodiment, the phrase that the first index is smaller than the second index comprises that the first index is a Smaller Priority Index; the second index is a Larger Priority Index.

In one embodiment, the phrase that the first index is larger than the second index comprises that the first index is equal to 1 and the second index is equal to 0.

In one embodiment, the phrase that the first index is smaller than the second index comprises that the first index is equal to 0 and the second index is equal to 1.

In one embodiment, the phrase that the first index is larger than the second index comprises that the first index is equal to a value greater than the second index.

In one embodiment, the phrase that the first index is smaller than the second index comprises that the first index is equal to a value smaller than the second index.

### Embodiment 9B

Embodiment 9B illustrates a schematic diagram of relations among a second signaling, a second bit block and a first time-frequency resource block according to one embodiment of the present application, as shown in FIG. 9B.

In Embodiment 9B, a second signaling comprises scheduling information of a second bit block; the second signaling indicates a first time-frequency resource block; the first time-frequency resource block is used to determine a number of bits comprised in the second bit block.

In one embodiment, the first time-frequency resource block is used to determine a total number of REs allocated to a PUSCH, and a number of bits comprised in the second bit block is related to the total number of the REs allocated to the PUSCH.

In one embodiment, a number of bits comprised in the second bit block is equal to a Transport Block Size (TBS) transmitted in the first time-frequency resource block.

In one embodiment, a number of bits comprised in the second bit block is equal to two Transport Block Sizes (TBS) transmitted in the first time-frequency resource block.

In one embodiment, a number of bits comprised in the second bit block is equal to multiple Transport Block Sizes (TBS) transmitted in the first time-frequency resource block.

### Embodiment 9C

Embodiment 9C illustrates a schematic diagram of a radio resource occupied by a first information block according to one embodiment of the present application, as shown in FIG. 9C.

In Embodiment 9C, the first information block is transmitted in the first radio resource block.

In one embodiment, the first radio resource block is a radio resource block in a second radio resource block set, the first radio resource block set being one of N radio resource block sets; any radio resource block set among the N radio resource block sets comprises a positive integer number of radio resource block(s), N being a positive integer greater than 1; a number of bits comprised in the first sub-information-block is used to determine the first radio resource block set from the N radio resource block sets.

In one subembodiment, the first signaling is used to indicate the first radio resource block in the first radio resource block set.

In one subembodiment, the first signaling indicates an index of the first radio resource block in the first radio resource block set.

In one subembodiment, the first signaling comprises a fourth field, the fourth field comprised in the first signaling indicating an index of the first radio resource block in the first radio resource block set.

In one embodiment, the first radio resource block is a radio resource block in a second radio resource block set, the first radio resource block set being one of N radio resource block sets; any radio resource block set among the N radio resource block sets comprises a positive integer number of radio resource block(s), N being a positive integer greater than 1; a number of bits comprised in the first information block is used to determine the first radio resource block set from the N radio resource block sets.

In one subembodiment, the first information block comprises only the first sub-information-block between the first sub-information-block and the second sub-information-block, a number of bits comprised in the first information block being equal to a number of bits comprised in the first sub-information-block.

In one subembodiment, the first information block comprises the first sub-information-block and the second sub-information-block, a number of bits comprised in the first information block being equal to a sum of a number of bits comprised in the first sub-information-block and a number of bits comprised in the second sub-information-block.

In one subembodiment, the first signaling is used to indicate the first radio resource block in the first radio resource block set.

In one subembodiment, the first signaling indicates an index of the first radio resource block in the first radio resource block set.

In one subembodiment, the first signaling comprises a fourth field, the fourth field comprised in the first signaling indicating an index of the first radio resource block in the first radio resource block set.

In one embodiment, the method in the first node in the present application further comprises:

receiving first information;

herein, the first information indicates N radio resource block sets; any radio resource block set among the N radio resource block sets comprises a positive integer number of radio resource block(s), N being a positive integer greater than 1; the first radio resource block is a radio resource block in the N radio resource block sets.

In one subembodiment, the second radio resource block is a radio resource block in the N radio resource block sets.

In one embodiment, the method in the second node in the present application further comprises:

transmitting first information;

herein, the first information indicates N radio resource block sets; any radio resource block set among the N radio resource block sets comprises a positive integer number of radio resource block(s), N being a positive integer greater than 1; the first radio resource block is a radio resource block in the N radio resource block sets.

In one subembodiment, the second radio resource block is a radio resource block in the N radio resource block sets.

In one embodiment, the first receiver also receives first information; herein, the first information indicates N radio resource block sets; any radio resource block set among the N radio resource block sets comprises a positive integer number of radio resource block(s), N being a positive integer greater than 1; the first radio resource block is a radio resource block in the N radio resource block sets.

In one subembodiment, the second radio resource block is a radio resource block in the N radio resource block sets.

In one embodiment, the second transmitter also transmits first information; herein, the first information indicates N radio resource block sets; any radio resource block set among the N radio resource block sets comprises a positive integer number of radio resource block(s), N being a positive integer greater than 1; the first radio resource block is a radio resource block in the N radio resource block sets.

In one subembodiment, the second radio resource block is a radio resource block in the N radio resource block sets.

### Embodiment 10A

Embodiment 10A illustrates a schematic diagram of relations among a first signaling, a second signaling, a first signaling group and a second signaling group, a first information block subset and a second information block subset according to one embodiment of the present application, as shown in FIG. 10A.

In Embodiment 10A, a first signaling group comprises multiple signalings, with a first signaling being a signaling ranking last in the first signaling group; information blocks in a first information block subset respectively correspond to the signalings in the first signaling group; a second signaling group comprises multiple signalings, with a second signaling being a signaling ranking last in the second signaling group; information blocks in a second information block subset respectively correspond to the signalings in the second signaling group.

In Embodiment 10A, the first signaling group comprises L1 signalings, and the first information block subset comprises L1 information blocks; the information blocks in the first information block subset respectively correspond to the signalings in the first signaling group; the second signaling group comprises L2 signalings, and the second information block subset comprises L2 information blocks; the information blocks in the second information block subset respectively correspond to the signalings in the second signaling group.

In one subembodiment of Embodiment 10A, an i-th signaling in the first signaling group is used for indicating an SPS release, and an i-th information block in the first information block subset indicates whether the i-th signaling in the first signaling group is correctly received; or, an i-th signaling in the first signaling group comprises scheduling information of a bit block, and an i-th information block in the first information block subset indicates whether the bit block is correctly received.

In one subembodiment of Embodiment 10A, a j-th signaling in the second signaling group is used for indicating an SPS release, and a j-th information block in the second information block subset indicates whether the j-th signaling in the second signaling group is correctly received; or, a j-th signaling in the second signaling group comprises scheduling information of a bit block, and a j-th information block in the second information block subset indicates whether the bit block is correctly received.

In one subembodiment of Embodiment 10A, each information block in the first information block subset comprises a HARQ-ACK.

In one subembodiment of Embodiment 10A, each information block in the second information block subset comprises a HARQ-ACK.

In one embodiment, the first node in the present application receives the first signaling group, the first information block subset comprising HARQ-ACK associated with the first signaling group.

In one embodiment, each information block in the first information block subset comprises a HARQ-ACK; the information blocks in the first information block subset respectively correspond to signalings in the first signaling group.

In one embodiment, a signaling in the first signaling group is used for indicating an SPS release, and an information block in the first information block subset indicates whether the signaling in the first signaling group is correctly received; or, a signaling in the first signaling group comprises scheduling information of a bit block, and an information block in the first information block subset indicates whether the bit block is correctly received.

In one embodiment, the first signaling is a last one of signalings in the first signaling group.

In one embodiment, the first signaling is a last one of signalings in the first signaling group up to a current Monitoring Occasion arranged firstly according to Serving Cell indexes and then according to PDCCH Monitoring Occasion indexes.

In one embodiment, all signalings in the first signaling group indicate the first index.

In one embodiment, all signalings in the first signaling group indicate a same priority index.

In one embodiment, all signalings in the first signaling group indicate a same priority.

In one embodiment, all signalings in the first signaling group indicate a same time unit.

In one embodiment, the first node in the present application also receives a signaling in the first signaling group other than the first signaling.

In one embodiment, each signaling in the first signaling group is DCI.

In one embodiment, the first node in the present application receives the second signaling group;

the second information block subset comprises HARQ-ACK associated with the second signaling group.

In one embodiment, each information block in the second information block subset comprises a HARQ-ACK; the information blocks in the second information block subset respectively correspond to signalings in the second signaling group.

In one embodiment, a signaling in the second signaling group is used for indicating an SPS release, and an information block in the second information block subset indicates whether the signaling in the second signaling group is correctly received; or, a signaling in the second signaling group comprises scheduling information of a bit block, and an information block in the second information block subset indicates whether the bit block is correctly received.

In one embodiment, the second signaling is a last one of signalings in the second signaling group.

In one embodiment, the second signaling is a last one of signalings in the second signaling group up to a current Monitoring Occasion arranged firstly according to Serving Cell indexes and then according to PDCCH Monitoring Occasion indexes.

In one embodiment, all signalings in the second signaling group indicate the second index.

In one embodiment, all signalings in the second signaling group indicate a same priority index.

In one embodiment, all signalings in the second signaling group indicate a same priority.

In one embodiment, all signalings in the second signaling group indicate a same time unit.

In one embodiment, the first node in the present application also receives a signaling in the second signaling group other than the second signaling.

In one embodiment, each signaling in the second signaling group is DCI.

### Embodiment 10B

Embodiment 10B illustrates a schematic diagram of relations among a first signaling, a target index and whether a first bit block comprises a first-type HARQ-ACK or a second-type HARQ-ACK according to one embodiment of the present application, as shown in FIG. 10B.

In Embodiment 10B, a first-type HARQ-ACK corresponds to a first index, while a second-type HARQ-ACK corresponds to a second index, the first index and the second index being different; a first signaling is used to determine a target index, the target index being either of the first index and the second index; when the target index is the first index, a first bit block comprises the first-type HARQ-ACK; when the target index is the second index, the first bit block comprises the second-type HARQ-ACK.

In one embodiment, the target index is indicated by an RRC signaling.

In one embodiment, the target index is indicated by a physical layer signaling.

In one embodiment, the target index is indicated by a higher layer signaling.

In one embodiment, a Radio Network Temporary Identity (RNTI) of the first signaling is used to determine a target index.

In one embodiment, the first signaling indicates the target index.

In one embodiment, a field comprised in the first signaling indicates the target index.

In one embodiment, the first signaling implicitly indicates the target index.

In one embodiment, the first signaling comprises a third field, and the third field in the first signaling indicates the target index.

In one embodiment, the first index corresponds to a first priority, while the second index corresponds to a second priority.

In one embodiment, the first index and the second index are both Priority Indexes.

In one embodiment, the first index is an index of a first priority, while the second index is an index of a second priority.

In one embodiment, the first index is 1, and the second index is 0.

In one embodiment, the first index is 0, and the second index is 1.

In one embodiment, the first priority is higher than the second priority.

In one embodiment, the first index is a Larger Priority Index; the second index is a Smaller Priority Index.

In one embodiment, the first index is an index with a priority index equal to 0; the second index is an index with a priority index equal to 1.

In one embodiment, the second index is a Larger Priority Index; the first index is a Smaller Priority Index.

In one embodiment, the second index is an index with a priority index equal to 0; the first index is an index with a priority index equal to 1.

In one embodiment, DCI corresponding to the first-type HARQ-ACK and DCI corresponding to the second-type HARQ-ACK respectively indicate different said priority indexes.

In one embodiment, the first-type HARQ-ACK includes HARQ-ACK in response to a first-type signaling; the first-type signaling is a signaling indicating an SPS release; the first-type signaling indicates the first index.

In one subembodiment, the first-type signaling is a DCI signaling.

In one embodiment, the second-type HARQ-ACK includes HARQ-ACK in response to a second-type signaling; the second-type signaling is a signaling indicating an SPS release; the second-type signaling indicates the second index.

In one subembodiment, the second-type signaling is a DCI signaling.

In one embodiment, the first-type HARQ-ACK includes HARQ-ACK indicating whether each bit block comprised in a TB-based channel reception is correctly received; a third-type signaling indicates scheduling information of bit blocks comprised in the TB-based channel reception; the third-type signaling indicates the first index.

In one subembodiment, the third-type signaling is a DCI signaling.

In one embodiment, the second-type HARQ-ACK includes HARQ-ACK indicating whether each bit block comprised in a TB-based channel reception is correctly received; a fourth-type signaling indicates scheduling information of bit blocks comprised in the TB-based channel reception; the fourth-type signaling indicates the second index.

In one subembodiment, the fourth-type signaling is a DCI signaling.

In one embodiment, the first-type HARQ-ACK is a URLLC Service Type HARQ-ACK, the first index indicating URLLC Service Type.

In one embodiment, the second-type HARQ-ACK is an eMBB Service Type HARQ-ACK, the second index indicating eMBB Service Type.

In one embodiment, the first-type HARQ-ACK and the second-type HARQ-ACK are respectively different service types of HARQ-ACKs, the first index and the second index respectively indicating different service types.

### Embodiment 10C

Embodiment 10C illustrates a schematic diagram of a radio resource occupied by a first information block according to one embodiment of the present application, as shown in FIG. 10C.

In Embodiment 10C, the first information block is transmitted in a third radio resource block, a number of bits comprised in the first information block being used to determine the third radio resource block.

In one embodiment, the first radio resource block is a radio resource block in a second radio resource block set, the first radio resource block set being one of N radio resource block sets; a number of bits comprised in the first sub-information-block is used to determine the first radio resource block set out of the N radio resource block sets; the third radio resource block is a radio resource block in a third radio resource block set, the third radio resource block set being one of the N radio resource block sets; a number of bits comprised in the first information block is used to determine the third radio resource block set out of the N radio resource block sets; any of the N radio resource block sets comprises a positive integer number of radio resource block(s), N being a positive integer greater than 1.

In one subembodiment, the first information block comprises only the first sub-information-block between the first sub-information-block and the second sub-information-block, a number of bits comprised in the first information block being equal to a number of bits comprised in the first sub-information-block; the first radio resource block set and the third radio resource block set are the same, and the first radio resource block and the third radio resource block are the same.

In one subembodiment, the first information block comprises the first sub-information-block and the second sub-information-block, a number of bits comprised in the first information block being equal to a sum of a number of bits comprised in the first sub-information-block and a number of bits comprised in the second sub-information-block.

In one subembodiment, the first signaling is used to indicate the first radio resource block in the first radio resource block set.

In one subembodiment, the first signaling indicates an index of the first radio resource block in the first radio resource block set.

In one subembodiment, the first signaling is used to indicate the third radio resource block in the third radio resource block set.

In one subembodiment, the first signaling indicates an index of the third radio resource block in the third radio resource block set.

In one subembodiment, the fourth field comprised in the first signaling indicates a first index, the first index being equal to an index of the first radio resource block in the first radio resource block set, and the first index being equal to an index of the third radio resource block in the third radio resource block set.

In one subembodiment, the first signaling comprises a fourth field and a fifth field, the fourth field comprised in the first signaling indicating an index of the first radio resource block in the first radio resource block set, and the fifth field comprised in the first signaling indicating an index of the third radio resource block in the third radio resource block set.

### Embodiment 11A

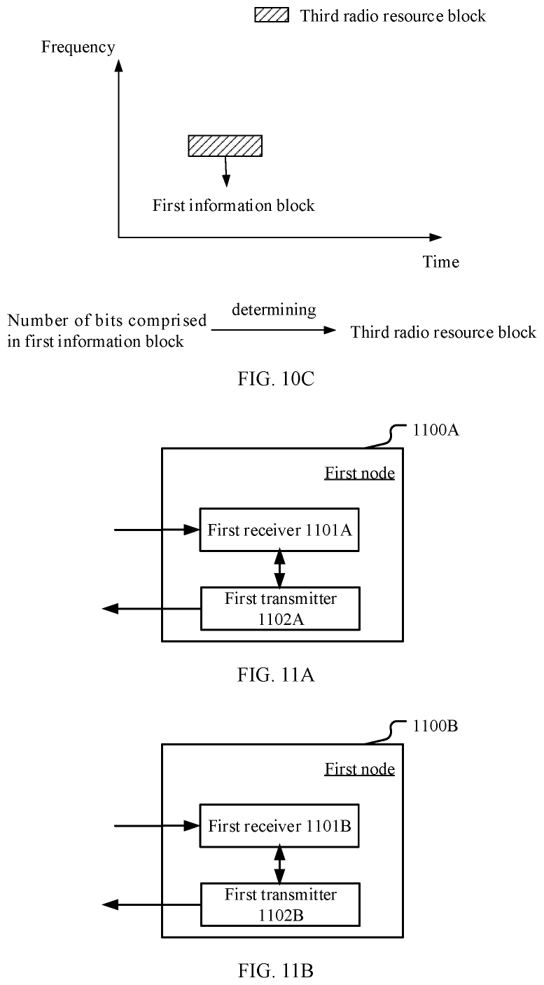

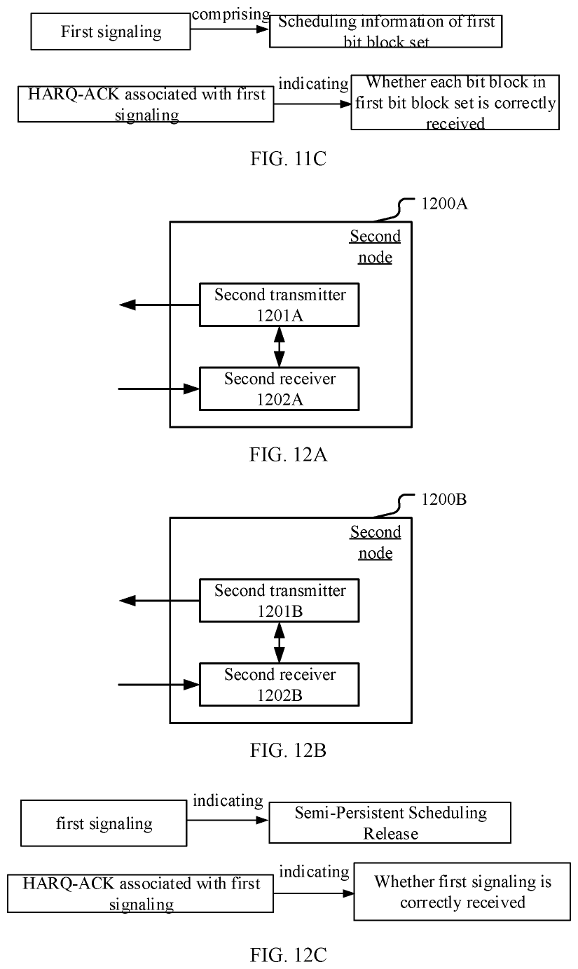

Embodiment 11A illustrates a structure block diagram of a processing device in a first node, as shown in FIG. 11A. In FIG. 11A, a processing device 1100A in the first node is comprised of a first receiver 1101A and a first transmitter 1102A.

In one embodiment, the first node 1100A is a UE.

In one embodiment, the first node 1100A is a relay node.

In one embodiment, the first node 1100A is vehicle-mounted communication equipment.

In one embodiment, the first node 1100A is a UE supporting V2X communications.

In one embodiment, the first node 1100A is a relay node supporting V2X communications.

In one embodiment, the first receiver 1101A comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1101A comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101A comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101A comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101A comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1102A comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1102A comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102A comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102A comprises at least the first three of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102A comprises at least the first two of the antenna 452, the transmitter 454, the multi-antenna transmitting processor 457, the transmitting processor 468, the controller/processor 459, the memory 460 and the data source 467 in FIG. 4 of the present application.

In Embodiment 11A, the first receiver 1101A receives a first signaling, a second signaling and a third signaling; the first transmitter 1102A transmits a first signal in a target time-frequency resource block, the first signal carrying a first information block set; herein, the first signal carries a first information block set; the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one embodiment, the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

In one embodiment, the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

In one embodiment, the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

In one embodiment, the first index and the second index are different; a relative magnitude of the first index and the second index is used to determine the target information block subset between the first information block subset and the second information block subset.

In one embodiment, the first signaling is used for indicating a Semi-Persistent Scheduling (SPS) release, the HARQ-ACK associated with the first signaling indicating whether the first signaling is correctly received; or, the first receiver 1101A also receives a first bit block; where the first signaling comprises scheduling information of the first bit block, the HARQ-ACK associated with the first signaling indicating whether the first bit block is correctly received.

In one embodiment, the second signaling is used for indicating a Semi-Persistent Scheduling (SPS) release, the HARQ-ACK associated with the second signaling indicating whether the second signaling is correctly received; or, the first receiver 1101A also receives a second bit block; where the second signaling comprises scheduling information of the second bit block, the HARQ-ACK associated with the second signaling indicating whether the second bit block is correctly received.

In one embodiment, the first signaling and the second signaling are both DCI used for downlink scheduling, while the third signaling is DCI used for uplink scheduling; the target time-frequency resource block comprises a PUSCH; the first information block set comprises a first information block subset and a second information block subset, the first information block subset comprising HARQ-ACK associated with the first signaling and the second information block subset comprising HARQ-ACK associated with the second signaling; the third signaling comprises the first field, the first field being a DAI field; the first information block subset corresponds to the first index, while the second information block subset corresponds to the second index; both the first index and the second index are Priority Indexes; whether the first index and the second index are the same is used to determine an interpretation of the first field in the third signaling; when the first index and the second index are the same Priority Index, a value of the first field in the third signaling is used to determine a total number of information blocks comprised in the first information block set; when the first index and the second index are different Priority Indexes, the value of the first field in the third signaling is used to determine a number of information blocks comprised in the target information block subset, the target information block subset either being the first information block subset or the second information block subset.

In one subembodiment, each of the first signaling, the second signaling and the third signaling comprises a Priority Indicator field indicating a priority index; the priority index is equal to 0 or 1.

In one subembodiment, when the first index is greater than the second index, the target information block subset is the first information block subset; when the first index is smaller than the second index, the target information block subset is the second information block subset.

In one subembodiment, when the first index is smaller than the second index, the target information block subset is the first information block subset; when the first index is greater than the second index, the target information block subset is the second information block subset.

In one subembodiment, the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

In one subembodiment, the first index and the second index are different; when the target information block subset is the first information block subset, a number of information blocks comprised in the second information block subset is unrelated to any field in the third signaling; when the target information block subset is the second information block subset, a number of information blocks comprised in the first information block subset is unrelated to any field in the third signaling.

In one embodiment, the first signaling and the second signaling are DCI used for downlink scheduling while the third signaling is DCI used for uplink scheduling. The target time-frequency resource block comprises a PUSCH; the first information block set comprises a first information block subset and a second information block subset, the first information block subset comprising HARQ-ACK associated with the first signaling and the second information block subset comprising HARQ-ACK associated with the second signaling; the third signaling comprises the first field, the first field being a DAI field; the first information block subset corresponds to the first index, while the second information block subset corresponds to the second index; the first signaling is used to indicate a first radio resource block, while the second signaling is used to indicate a second radio resource block, a first time unit comprising time-domain resources occupied by the first radio resource block, while a second time unit comprising time-domain resources occupied by the second radio resource block, the first index corresponding to the first time unit, while the second index corresponding to the second time unit; when the first time unit and the second time unit are the same, the first index and the second index are the same; when the first time unit and the second time unit are different, the first index and the second index are different. Whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one subembodiment, the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

In one subembodiment, the first index and the second index are different; when the target information block subset is the first information block subset, a number of information blocks comprised in the second information block subset is unrelated to any field in the third signaling; when the target information block subset is the second information block subset, a number of information blocks comprised in the first information block subset is unrelated to any field in the third signaling.

In one subembodiment, the first radio resource block and the second radio resource block respectively comprise a PUCCH.

In one subembodiment, the first time unit is a slot or a sub-slot; the second time unit is a slot or a sub-slot.

In one subembodiment, the first radio resource block is earlier than the second radio resource block in time domain, the target information block subset being the first information block subset.

In one subembodiment, the second radio resource block is earlier than the first radio resource block in time domain, the target information block subset being the second information block subset.

### Embodiment 11B

Embodiment 11B illustrates a structure block diagram of a processing device in a first node, as shown in FIG. 11B. In FIG. 11B, a processing device 1100B in the first node is comprised of a first receiver 1101B and a first transmitter 1102B.

In one embodiment, the first node 1100B is a UE.

In one embodiment, the first node 1100B is a relay node.

In one embodiment, the first node 1100B is vehicle-mounted communication equipment.

In one embodiment, the first node 1100B is a UE supporting V2X communications.

In one embodiment, the first node 1100B is a relay node supporting V2X communications.

In one embodiment, the first receiver 1101B comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1101B comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101B comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101B comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1101B comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1102B comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1102B comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102B comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102B comprises at least the first three of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1102B comprises at least the first two of the antenna 452, the transmitter 454, the multi-antenna transmitting processor 457, the transmitting processor 468, the controller/processor 459, the memory 460 and the data source 467 in FIG. 4 of the present application.

In Embodiment 11B, the first receiver 1101B receives a first signaling and a second signaling; the first transmitter 1102B transmits a first signal in a first time-frequency resource block; herein, the first signal carries a first bit block; the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

In one embodiment, any field in the second signaling other than the first field is not used to determine a number of bits of the second-type HARQ-ACK.

In one embodiment, the first-type HARQ-ACK only includes HARQ-ACK for a Semi-Persistent Scheduling (SPS) release and HARQ-ACK for Transport-Block (TB)-based channel reception; the second-type HARQ-ACK only includes HARQ-ACK for a Semi-Persistent Scheduling (SPS) release and HARQ-ACK for a TB-based channel reception; neither the first-type HARQ-ACK nor the second-type HARQ-ACK includes HARQ-ACK for a Code Block Group-based (CBG-based) channel reception; the first bit block comprises at least one of HARQ-ACK for a Semi-Persistent Scheduling (SPS) release or HARQ-ACK for a TB-based channel reception; the first bit block does not include HARQ-ACK for a CBG-based channel reception.

In one embodiment, when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

In one embodiment, the first signal comprises a first sub-signal and a second sub-signal, the first sub-signal carrying the first bit block, while the second sub-signal carrying a second bit block, the first time-frequency resource block being used to determine a number of bits comprised in the second bit block.

In one embodiment, the first receiver 1101B also receives a third signaling; herein, the third signaling is used to determine a third bit block, the third bit block comprising HARQ-ACK associated with the third signaling; the first signal carries a first bit block set, with the first bit block being any bit block in the first bit block set, the third bit block being a bit block in the first bit block set other than the first bit block.

In one embodiment, the first-type HARQ-ACK corresponds to a first index, while the second-type HARQ-ACK corresponds to a second index, the first index and the second index being different; the first signaling is used to determine a target index, the target index being one of the first index and the second index; when the target index is the first index, the first bit block comprises the first-type HARQ-ACK; when the target index is the second index, the first bit block comprises the second-type HARQ-ACK.

In one embodiment, the first time-frequency resource block comprises a PUSCH; the first signal carries the first bit block; the second signaling is DCI scheduling the PUSCH; the first field in the second signaling is a DAI field in the second signaling; the first-type HARQ-ACK and the second-type HARQ-ACK respectively correspond to different Priority Indexes; the first bit block comprises at least one of HARQ-ACK for an SPS release or HARQ-ACK for a TB-based channel reception; the first bit block does not comprise HARQ-ACK for a CBG-based channel reception; neither the first-type HARQ-ACK nor the second-type HARQ-ACK comprises HARQ-ACK for a CBG-based channel reception; the first bit block only comprises one of the first-type HARQ-ACK or the second-type HARQ-ACK; when the first bit block comprises the first-type HARQ-ACK, the first field in the second signaling is used to determine a number of the first-type HARQ-ACK bits; when the first bit block does not comprise the first-type HARQ-ACK, the first bit block only comprises the second-type HARQ-ACK, the first field in the second signaling not being used to determine a number of the second-type HARQ-ACK bits.

In one subembodiment, any field in the second signaling is not used to determine a number of the second-type HARQ-ACK bits.

In one subembodiment, the second signaling only comprises one DAI field.

In one subembodiment, the DAI field in the second signaling is a 1st DAI field.

In one subembodiment, the different priority indexes respectively indicate different service types; the different service types include URLLC service type and eMBB service type.

In one subembodiment, the different priority indexes respectively indicate different priorities; the different priorities include High Priority and Low Priority.

In one subembodiment, the priority index is 0 or 1.

In one embodiment, the first time-frequency resource block comprises a PUSCH; the first signal carries the first bit block and the second bit block, the second bit block comprising user service data or an aperiodic CSI report; the second signaling is DCI scheduling the PUSCH; the first field in the second signaling is a DAI field in the second signaling; the first-type HARQ-ACK and the second-type HARQ-ACK respectively correspond to different Priority Indexes; a priority index corresponding to the second bit block is the same as a priority index corresponding to the first-type HARQ-ACK; the second signaling indicates the priority index corresponding to the second bit block; the first bit block comprises at least one of HARQ-ACK for an SPS release or HARQ-ACK for a TB-based channel reception; the first bit block does not comprise HARQ-ACK for a CBG-based channel reception; neither the first-type HARQ-ACK nor the second-type HARQ-ACK comprises HARQ-ACK for a CBG-based channel reception; the first bit block only comprises one of the first-type HARQ-ACK or the second-type HARQ-ACK; when the first bit block comprises the first-type HARQ-ACK, the first field in the second signaling is used to determine a number of the first-type HARQ-ACK bits; when the first bit block does not comprise the first-type HARQ-ACK, the first bit block only comprises the second-type HARQ-ACK, the first field in the second signaling not being used to determine a number of the second-type HARQ-ACK bits.

In one subembodiment, any field in the second signaling is not used to determine a number of the second-type HARQ-ACK bits.

In one subembodiment, the second signaling only comprises one DAI field.

In one subembodiment, the DAI field in the second signaling is a 1st DAI field.

In one subembodiment, different priority indexes respectively indicate different service types; the different service types include URLLC service type and eMBB service type.

In one subembodiment, different priority indexes respectively indicate different priorities; the different priorities include High Priority and Low Priority.

In one subembodiment, the priority index is 0 or 1.

In one embodiment, the first time-frequency resource block comprises a PUSCH; the first signal carries the first bit block and the second bit block, the second bit block comprising user service data or an aperiodic CSI report; the second signaling is DCI scheduling the PUSCH; the first field in the second signaling is a DAI field in the second signaling; the first-type HARQ-ACK and the second-type HARQ-ACK respectively correspond to different Priority Indexes; a priority index corresponding to the second bit block is the same as a priority index corresponding to the second-type HARQ-ACK; the second signaling indicates the priority index corresponding to the second bit block; the first bit block comprises at least one of HARQ-ACK for an SPS release or HARQ-ACK for a TB-based channel reception; the first bit block does not comprise HARQ-ACK for a CBG-based channel reception; neither the first-type HARQ-ACK nor the second-type HARQ-ACK comprises HARQ-ACK for a CBG-based channel reception; the first bit block only comprises one of the first-type HARQ-ACK or the second-type HARQ-ACK; when the first bit block comprises the first-type HARQ-ACK, the first field in the second signaling is used to determine a number of the first-type HARQ-ACK bits; when the first bit block does not comprise the first-type HARQ-ACK, the first bit block only comprises the second-type HARQ-ACK, the first field in the second signaling not being used to determine a number of the second-type HARQ-ACK bits.

In one subembodiment, any field in the second signaling is not used to determine a number of the second-type HARQ-ACK bits.

In one subembodiment, the second signaling only comprises one DAI field.

In one subembodiment, the DAI field in the second signaling is a 1st DAI field.

In one subembodiment, different priority indexes respectively indicate different service types; the different service types include URLLC service type and eMBB service type.

In one subembodiment, different priority indexes respectively indicate different priorities; the different priorities include High Priority and Low Priority.

In one subembodiment, the priority index is 0 or 1.

In one embodiment, the first time-frequency resource block comprises a PUSCH; the first signal carries the first bit block and the third bit block; the second bit block comprising user service data or an aperiodic CSI report; the second signaling is DCI scheduling the PUSCH; the first field in the second signaling is a DAI field in the second signaling; the first-type HARQ-ACK and the second-type HARQ-ACK respectively correspond to different Priority Indexes; the first bit block comprises at least one of HARQ-ACK for an SPS release or HARQ-ACK for a TB-based channel reception; the first bit block does not comprise HARQ-ACK for a CBG-based channel reception; the third bit block comprises at least one of HARQ-ACK for an SPS release or HARQ-ACK for a TB-based channel reception; the third bit block does not comprise HARQ-ACK for a CBG-based channel reception; neither the first-type HARQ-ACK nor the second-type HARQ-ACK comprises HARQ-ACK for a CBG-based channel reception.

In one subembodiment, the first bit block comprises the first-type HARQ-ACK; the third bit block comprises the second-type HARQ-ACK; the first field in the second signaling being used to determine a number of HARQ-ACK bits comprised in the first bit block.

In one subembodiment, the first bit block comprises the second-type HARQ-ACK; the third bit block comprises the first-type HARQ-ACK; a number of the second-type HARQ-ACK bits comprised in the first bit block is unrelated to the first field in the second signaling, the first field in the second signaling being used to determine a number of HARQ-ACK bits comprised in the third bit block.

In one subembodiment, any field in the second signaling is not used to determine a number of the second-type HARQ-ACK bits.

In one subembodiment, the second signaling only comprises one DAI field.

In one subembodiment, the DAI field in the second signaling is a 1st DAI field.

In one subembodiment, different priority indexes respectively indicate different service types; the different service types include URLLC service type and eMBB service type.

In one subembodiment, different priority indexes respectively indicate different priorities; the different priorities include High Priority and Low Priority.

In one subembodiment, the priority index is 0 or 1.

### Embodiment 11C

Embodiment 11C illustrates a schematic diagram of HARQ-ACK associated with a first signaling according to one embodiment of the present application, as shown in FIG. 11C.

In Embodiment 11C, the first signaling comprises scheduling information of the first bit block set in the present application; the HARQ-ACK associated with the first signaling indicates whether each bit block in the first bit block set is correctly received.

In one embodiment, the first bit block set comprises a positive integer number of Transport Block(s) (TB(s)).

In one embodiment, the first bit block set comprises one TB.

In one embodiment, the first bit block set comprises a positive integer number of CBG(s).

In one embodiment, the first bit block set comprises a positive integer number of bit(s).

In one embodiment, the scheduling information of the first bit block set comprises: at least one of time-domain resources occupied, frequency-domain resources occupied, a Modulation and Coding Scheme (MCS), configuration information of DeModulation Reference Signals (DMRS), a Hybrid Automatic Repeat reQuest (HARQ) process number, a Redundancy Version (RV), a New Data Indicator (NDI), a transmission antenna port, or a corresponding Transmission Configuration Indicator (TCI) state.

In one subembodiment, the configuration information of DMRS comprises at least one of a Reference Signal (RS) sequence, a mapping mode, a DMRS type, time-domain resources being occupied, frequency-domain resources being occupied, code-domain resources being occupied, a cyclic shift, or an Orthogonal Cover Code (OCC).

### Embodiment 12A

Embodiment 12A illustrates a structure block diagram of a processing device in a second node, as shown in FIG. 12A. In FIG. 12A, a processing device 1200A in the second node is comprised of a second transmitter 1201A and a second receiver 1202A.

In one embodiment, the second node 1200A is a UE.

In one embodiment, the second node 1200A is a base station.

In one embodiment, the second node 1200A is a relay node.

In one embodiment, the second node 1200A is vehicle-mounted communication equipment.

In one embodiment, the second node 1200A is a UE supporting V2X communications.

In one embodiment, the second transmitter 1201A comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1201A comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1201A comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1201A comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1201A comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1202A comprises at least one of the antenna 420, the receiver 418, the multi-antenna receiving processor 472, the receiving processor 470, the controller/processor 475 or the memory 476 in FIG. 4 of the present application.

In one embodiment, the second receiver 1202A comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1202A comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1202A comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1202A comprises at least the first two of the antenna 420, the receiver 418, the multi-antenna receiving processor 472, the receiving processor 470, the controller/processor 475 and the memory 476 in FIG. 4 of the present application.

In Embodiment 12A, the second transmitter 1201A transmits a first signaling, a second signaling and a third signaling; the second receiver 1202A receives a first signal in a target time-frequency resource block, the first signal carrying a first information block set; herein, the first signal carries a first information block set; the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

In one embodiment, the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

In one embodiment, the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

In one embodiment, the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

In one embodiment, the first index and the second index are different; a relative magnitude of the first index and the second index is used to determine the target information block subset between the first information block subset and the second information block subset.

In one embodiment, the first signaling is used for indicating a Semi-Persistent Scheduling (SPS) release, the HARQ-ACK associated with the first signaling indicating whether the first signaling is correctly received; or, the second transmitter 1201A also transmits a first bit block; where the first signaling comprises scheduling information of the first bit block, the HARQ-ACK associated with the first signaling indicating whether the first bit block is correctly received.

In one embodiment, the second signaling is used for indicating a Semi-Persistent Scheduling (SPS) release, the HARQ-ACK associated with the second signaling indicating whether the second signaling is correctly received; or, the second transmitter 1201A also transmits a second bit block; where the second signaling comprises scheduling information of the second bit block, the HARQ-ACK associated with the second signaling indicating whether the second bit block is correctly received.

### Embodiment 12B

Embodiment 12B illustrates a structure block diagram of a processing device in a second node, as shown in FIG. 12B. In FIG. 12B, a processing device 1200B in the second node is comprised of a second transmitter 1201B and a second receiver 1202B.

In one embodiment, the second node 1200B is a UE.

In one embodiment, the second node 1200B is a base station.

In one embodiment, the second node 1200B is a relay node.

In one embodiment, the second node 1200B is vehicle-mounted communication equipment.

In one embodiment, the second node 1200B is a UE supporting V2X communications.

In one embodiment, the second transmitter 1201B comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1201B comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1201B comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1202B comprises at least one of the antenna 420, the receiver 418, the multi-antenna receiving processor 472, the receiving processor 470, the controller/processor 475 or the memory 476 in FIG. 4 of the present application.

In one embodiment, the second receiver 1202B comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1202B comprises at least the first two of the antenna 420, the receiver 418, the multi-antenna receiving processor 472, the receiving processor 470, the controller/processor 475 and the memory 476 in FIG. 4 of the present application.

In Embodiment 12B, the second transmitter 1201B transmits a first signaling and a second signaling; the second receiver 1202B receives a first signal in a first time-frequency resource block; herein, the first signal carries a first bit block; the second signaling is used to indicate the first time-frequency resource block; the first signaling is used to determine the first bit block, the first bit block comprising HARQ-ACK associated with the first signaling; the first bit block only comprises a first-type HARQ-ACK or a second-type HARQ-ACK; the second signaling comprises a first field, whether the first bit block comprises the first-type HARQ-ACK is used to determine whether a number of HARQ-ACK bits comprised in the first bit block is related to the first field in the second signaling.

In one embodiment, any field in the second signaling other than the first field is not used to determine a number of bits of the second-type HARQ-ACK.

In one embodiment, the first-type HARQ-ACK only includes HARQ-ACK for a Semi-Persistent Scheduling (SPS) release and HARQ-ACK for Transport-Block (TB)-based channel reception; the second-type HARQ-ACK only includes HARQ-ACK for a Semi-Persistent Scheduling (SPS) release and HARQ-ACK for a TB-based channel reception; neither the first-type HARQ-ACK nor the second-type HARQ-ACK includes HARQ-ACK for a Code Block Group-based (CBG-based) channel reception; the first bit block comprises at least one of HARQ-ACK for a Semi-Persistent Scheduling (SPS) release or HARQ-ACK for a TB-based channel reception; the first bit block does not include HARQ-ACK for a CBG-based channel reception.

In one embodiment, when the first bit block comprises the first-type HARQ-ACK, the first field in the second signaling is used to determine a number of HARQ-ACK bits comprised in the first bit block; when the first bit block does not comprise the first-type HARQ-ACK, a number of HARQ-ACK bits comprised in the first bit block is unrelated to the first field in the second signaling.

In one embodiment, the first signal comprises a first sub-signal and a second sub-signal, the first sub-signal carrying the first bit block, while the second sub-signal carrying a second bit block, the first time-frequency resource block being used to determine a number of bits comprised in the second bit block.

In one embodiment, the second transmitter 1201B also transmits a third signaling; herein, the third signaling is used to determine a third bit block, the third bit block comprising HARQ-ACK associated with the third signaling; the first signal carries a first bit block set, with the first bit block being any bit block in the first bit block set, the third bit block being a bit block in the first bit block set other than the first bit block.

In one embodiment, the first-type HARQ-ACK corresponds to a first index, while the second-type HARQ-ACK corresponds to a second index, the first index and the second index being different; the first signaling is used to determine a target index, the target index being one of the first index and the second index; when the target index is the first index, the first bit block comprises the first-type HARQ-ACK; when the target index is the second index, the first bit block comprises the second-type HARQ-ACK.

### Embodiment 12C

Embodiment 12C illustrates a schematic diagram of HARQ-ACK associated with a first signaling according to one embodiment of the present application, as shown in FIG. 12C.

In Embodiment 12C, the first signaling is used to indicate a Semi-Persistent Scheduling (SPS) release, the HARQ-ACK associated with the first signaling indicating whether the first signaling is correctly received.

In one embodiment, a value of a field in the first signaling indicates an SPS release.

In one embodiment, values of multiple fields in the first signaling indicate an SPS release.

In one embodiment, the second signaling is used to indicate a Semi-Persistent Scheduling (SPS) release, the HARQ-ACK associated with the second signaling indicating whether the second signaling is correctly received.

In one embodiment, the third signaling is used to indicate a Semi-Persistent Scheduling (SPS) release, the HARQ-ACK associated with the third signaling indicating whether the third signaling is correctly received.

In one embodiment, a value of a field in the second signaling indicates an SPS release.

In one embodiment, values of multiple fields in the second signaling indicate an SPS release.

In one embodiment, a value of a field in the third signaling indicates an SPS release.

In one embodiment, values of multiple fields in the third signaling indicate an SPS release.

### Embodiment 13

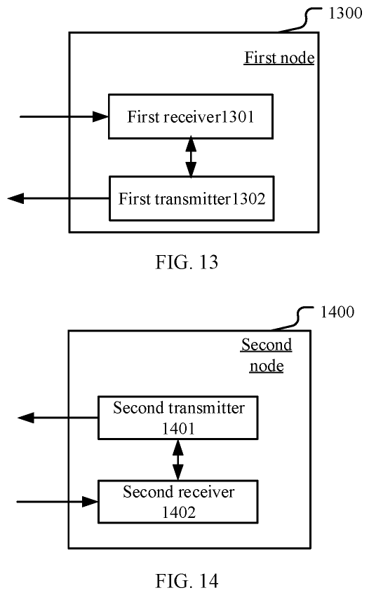

Embodiment 13 illustrates a structure block diagram of a processing device in a first node, as shown in FIG. 13. In FIG. 13, a first node processing device 1300 is comprised of a first receiver 1301 and a first transmitter 1302.

In one embodiment, the first node 1300 is a UE.

In one embodiment, the first node 1300 is a relay node.

In one embodiment, the first node 1300 is vehicle-mounted communication equipment.

In one embodiment, the first node 1300 is a UE supporting V2X communications.

In one embodiment, the first node 1300 is a relay node supporting V2X communications.

In one embodiment, the first receiver 1301 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1301 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1302 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1302 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first three of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first two of the antenna 452, the transmitter 454, the multi-antenna transmitting processor 457, the transmitting processor 468, the controller/processor 459, the memory 460 and the data source 467 in FIG. 4 of the present application.

In Embodiment 13, the first receiver 1301 monitors first-type signalings and second-type signalings in a first time-frequency resource pool, and receives a first signaling in the first time-frequency resource pool; the first transmitter 1302 transmits a first information block in a first radio resource block; herein, first-type signaling(s) and second-type signaling(s) respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

In one embodiment, the first receiver 1301 receives a second signaling in the first time-frequency resource pool; herein, the second signaling is a said second-type signaling; a second time window comprises the first time window, the second signaling being transmitted in time-domain resources in the second time window other than the first time window; the second-type signaling comprises the first field; a value of the first field comprised in the second signaling is only related to the latter of a number of the first-type signaling(s) transmitted in the first time-frequency resource pool and a number of the second-type signaling(s) transmitted in the first time-frequency resource pool; the first information block does not comprise any HARQ-ACK associated with the second signaling.

In one embodiment, the first receiver 1301 receives a third signaling in the first time-frequency resource pool; herein, the third signaling is a said second-type signaling; the third signaling is transmitted in the first time window, the first information block comprising HARQ-ACK associated with the third signaling.

In one embodiment, the first signaling is a said first-type signaling; the first receiver 1301 receives each first-type signaling in a first signaling set in the first time-frequency resource pool; herein, the first signaling set comprises a first-type signaling other than the first signaling that is detected in the first time-frequency resource pool, the first signaling being later than a first-type signaling in the first signaling set; the first information block comprises HARQ-ACK associated with a first-type signaling in the first signaling set.

In one embodiment, the first signaling comprises a second field; a value of the second field comprised in the first signaling is related to a number of the first-type signaling(s) transmitted in the first time-frequency resource pool and a number of the second-type signaling(s) transmitted in the first time-frequency resource pool; a third value and a fourth value are used together to determine a value of the second field comprised in the first signaling, where the third value is equal to a total number of {serving cell, PDCCH monitoring occasion}-pair(s) including the first-type signaling(s) up to the current PDCCH monitoring occasion in the first time window, while the fourth value is equal to a total number of {serving cell, PDCCH monitoring occasion}-pair(s) including the second-type signaling(s) up to the current PDCCH monitoring occasion in the first time window.

In one embodiment, the first receiver 1301 receives a first bit block set; herein, the first signaling comprises scheduling information of the first bit block set; the HARQ-ACK associated with the first signaling indicates whether each bit block in the first bit block set is correctly received.

In one embodiment, the first signaling is used to indicate a Semi-Persistent Scheduling (SPS) release, the HARQ-ACK associated with the first signaling indicating whether the first signaling is correctly received.

### Embodiment 14

Embodiment 14 illustrates a structure block diagram a processing device in a second node according to one embodiment of the present application, as shown in FIG. 14. In FIG. 14, a second node processing device 1400 is comprised of a second transmitter 1401 and a second receiver 1402.

In one embodiment, the second node 1400 is a UE.

In one embodiment, the second node 1400 is a base station.

In one embodiment, the second node 1400 is a relay node.

In one embodiment, the second transmitter 1401 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1401 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1402 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1402 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first two of the antenna 420, the receiver 418, the multi-antenna receiving processor 472, the receiving processor 470, the controller/processor 475 and the memory 476 in FIG. 4 of the present application.

In Embodiment 14, the second transmitter 1401 transmits a first signaling in the first time-frequency resource pool; the second receiver 1402 receives a first information block in a first radio resource block; herein, first-type signaling and second-type signaling respectively correspond to different HARQ-ACK codebooks; the first information block comprises HARQ-ACK associated with the first signaling; the first-type signaling comprises a first field; the first signaling is a said first-type signaling; a value of the first field in the first signaling is both related to a number of the first-type signaling(s) transmitted in the first time-frequency resource pool and a number of the second-type signaling(s) transmitted in the first time-frequency resource pool; a first value and a second value are used together to determine the first field in the first signaling, the first value being equal to an accumulative number of {serving cell, PDCCH monitoring occasion}-pair(s) including the first-type signaling(s), first in an ascending order of serving cell indexes and then in an ascending order of PDCCH monitoring occasion indexes, up to a current serving cell and a current PDCCH monitoring occasion in a first time window, while the second value being a total number of {serving cell, PDCCH monitoring occasion}-pair(s) including the second-type signaling(s) up to the current PDCCH monitoring occasion in the first time window.

In one embodiment, the second transmitter 1401 transmits a second signaling in the first time-frequency resource pool; herein, the second signaling is a said second-type signaling; a second time window comprises the first time window, the second signaling being transmitted in time-domain resources in the second time window other than the first time window; the second-type signaling comprises the first field; a value of the first field comprised in the second signaling is only related to the latter of a number of the first-type signaling(s) transmitted in the first time-frequency resource pool and a number of the second-type signaling(s) transmitted in the first time-frequency resource pool; the first information block does not comprise any HARQ-ACK associated with the second signaling.

In one embodiment, the second transmitter 1401 transmits a third signaling in the first time-frequency resource pool; herein, the third signaling is a said second-type signaling; the third signaling is transmitted in the first time window, the first information block comprising HARQ-ACK associated with the third signaling.

In one embodiment, the first signaling is a said first-type signaling; the second transmitter 1401 transmits each first-type signaling in a first signaling set in the first time-frequency resource pool; herein, the first signaling set comprises a first-type signaling other than the first signaling that is detected in the first time-frequency resource pool, the first signaling being later than a first-type signaling in the first signaling set; the first information block comprises HARQ-ACK associated with a first-type signaling in the first signaling set.

In one embodiment, the first signaling comprises a second field; a value of the second field comprised in the first signaling is related to a number of the first-type signaling(s) transmitted in the first time-frequency resource pool and a number of the second-type signaling(s) transmitted in the first time-frequency resource pool; a third value and a fourth value are used together to determine a value of the second field comprised in the first signaling, where the third value is equal to a total number of {serving cell, PDCCH monitoring occasion}-pair(s) including the first-type signaling(s) up to the current PDCCH monitoring occasion in the first time window, while the fourth value is equal to a total number of {serving cell, PDCCH monitoring occasion}-pair(s) including the second-type signaling(s) up to the current PDCCH monitoring occasion in the first time window.

In one embodiment, the second transmitter 1401 transmits a first bit block set; herein, the first signaling comprises scheduling information of the first bit block set; the HARQ-ACK associated with the first signaling indicates whether each bit block in the first bit block set is correctly received.

In one embodiment, the first signaling is used to indicate a Semi-Persistent Scheduling (SPS) release, the HARQ-ACK associated with the first signaling indicating whether the first signaling is correctly received.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station or network equipment in the present application includes but is not limited to macro-cellular base stations, micro-cellular base stations, home base stations, relay base station, eNB, gNB, Transmitter Receiver Point (TRP), GNSS, relay satellite, satellite base station, airborne base station and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

1. A first node for wireless communications, comprising:
a first receiver, which receives a first signaling, a second signaling and a third signaling; and
a first transmitter, which transmits a first signal in a target time-frequency resource block, the first signal carrying a first information block set;
wherein the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

2. The first node according to claim 1, wherein the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

3. The first node according to claim 1, wherein the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

4. The first node according to claim 1, wherein the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

5. The first node according to claim 1, wherein the first index and the second index are different; a relative magnitude of the first index and the second index is used to determine the target information block subset between the first information block subset and the second information block subset.

6. The first node according to claim 1, wherein the first signaling is used to indicate a Semi-Persistent Scheduling (SPS) release, the HARQ-ACK associated with the first signaling indicating whether the first signaling is correctly received;
or, the first receiver also receives a first bit block; where the first signaling comprises scheduling information of the first bit block, the HARQ-ACK associated with the first signaling indicating whether the first bit block is correctly received.

7. The first node according to claim 1, wherein the second signaling is used to indicate a Semi-Persistent Scheduling (SPS) release, the HARQ-ACK associated with the second signaling indicating whether the second signaling is correctly received;
or, the first receiver also receives a second bit block; where the second signaling comprises scheduling information of the second bit block, the HARQ-ACK associated with the second signaling indicating whether the second bit block is correctly received.

8. A second node for wireless communications, comprising:
a second transmitter, which transmits a first signaling, a second signaling and a third signaling; and
a second receiver, which receives a first signal in a target time-frequency resource block, the first signal carrying a first information block set;
wherein the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

9. The second node according to claim 8, wherein the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

10. The second node according to claim 8, wherein the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

11. The second node according to claim 8, wherein the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

12. The second node according to claim 8, wherein the first index and the second index are different; a relative magnitude of the first index and the second index is used to determine the target information block subset between the first information block subset and the second information block subset.

13. The second node according to claim 8, wherein the first signaling is used to indicate a Semi-Persistent Scheduling (SPS) release, the HARQ-ACK associated with the first signaling indicating whether the first signaling is correctly received;
or, the second transmitter also transmits a first bit block; where the first signaling comprises scheduling information of the first bit block, the HARQ-ACK associated with the first signaling indicating whether the first bit block is correctly received.

14. A method in a first node for wireless communications, comprising:
receiving a first signaling, a second signaling and a third signaling; and
transmitting a first signal in a target time-frequency resource block, the first signal carrying a first information block set;
wherein the third signaling is used to indicate the target time-frequency resource block; the first information block set comprises a first information block subset and a second information block subset, the first information block subset comprising HARQ-ACK associated with the first signaling and the second information block subset comprising HARQ-ACK associated with the second signaling; the third signaling comprises a first field, the first information block subset corresponds to a first index, while the second information block subset corresponds to a second index, whether the first index and the second index are the same is used to determine an interpretation of the first field in the third signaling; when the first index and the second index are the same, a value of the first field in the third signaling is used to determine a total number of information blocks comprised in the first information block set; when the first index and the second index are different, the value of the first field in the third signaling is used to determine a number of information blocks comprised in a target information block subset, the target information block subset either being the first information block subset or the second information block subset.

15. The method in the first node according to claim 14, wherein the first index and the second index are different; the value of the first field in the third signaling is used to determine a first value and a second value, the first value being equal to a number of information blocks comprised in the first information block subset, while the second value being equal to a number of information blocks comprised in the second information block subset, and the total number of information blocks comprised in the first information block set is equal to a sum of the first value and the second value.

16. The method in the first node according to claim 14, wherein the first index and the second index are different; when the target information block subset is the first information block subset, a number of information blocks comprised in the second information block subset is unrelated to the value of the first field in the third signaling; when the target information block subset is the second information block subset, a number of information blocks comprised in the first information block subset is unrelated to the value of the first field in the third signaling.

17. The method in the first node according to claim 14, wherein the first index and the second index are different; the first signaling is used to indicate a first radio resource block, while the second signaling is used to indicate a second radio resource block; a relative positional relation between the first radio resource block and the second radio resource block in time domain is used to determine the target information block subset between the first information block subset and the second information block subset.

18. The method in the first node according to claim 14, wherein the first index and the second index are different; a relative magnitude of the first index and the second index is used to determine the target information block subset between the first information block subset and the second information block subset.

19. The method in the first node according to claim 14, wherein the first signaling is used to indicate a Semi-Persistent Scheduling (SPS) release, the HARQ-ACK associated with the first signaling indicating whether the first signaling is correctly received;
or, a first bit block is also received; where the first signaling comprises scheduling information of the first bit block, the HARQ-ACK associated with the first signaling indicating whether the first bit block is correctly received.

20. The method in the first node according to claim 14, wherein the second signaling is used to indicate a Semi-Persistent Scheduling (SPS) release, the HARQ-ACK associated with the second signaling indicating whether the second signaling is correctly received;
or, a second bit block is also received; where the second signaling comprises scheduling information of the second bit block, the HARQ-ACK associated with the second signaling indicating whether the second bit block is correctly received.
